(19) United States
(12) Patent Application Publication
(10) Pub. No.: US 2012/0233049 A1
(43) Pub. Date: Sep. 13, 2012

(54) SYSTEM AND METHOD FOR MANAGING RISK IN A TRADING ENVIRONMENT

(75) Inventor: Adam Sheldon, Chicago, IL (US)

(73) Assignee: Bionic Trader Systems, LLC

(21) Appl. No.: 13/046,677

(22) Filed: Mar. 11, 2011

(51) Int. Cl. G06Q 40/00

(52) U.S. Cl. 705/37

(57) ABSTRACT

An order entry system for tradable instruments includes a buying power limit constrained order entry mechanism, wherein one or more conditions related to one or more buying power limits are adapted to automatically adjust. A method of controlling risk in an order entry system for tradable instruments includes the steps of: providing one or more conditions related to buying power; and automatically adjusting the one or more conditions related to buying power.

### BACKGROUND OF THE INVENTION

The present subject matter relates generally to a risk management system and method. More specifically, the present invention relates to a risk management system and method for use within a trading environment.

Traders may place orders through trading software. Within trading software, an end user (e.g., trader) is typically given limited buying power. This limited buying power amount can be represented in numerous ways, such as, for example, contracts, shares, currency value, etc.

For example, if represented as a currency value (i.e., dollar value), the buying power limit may be: the maximum value of a tradable instrument that can be held in the account at any one time; the maximum value of tradable instruments that are part of the same exchange that can be held in the account at any one time; the maximum value of all tradable instruments combined in an account that can be held in the account at any one time; or other possibilities. The limited buying power amount expressed as a currency value may typically be used only on the long side, or on both the long and short sides (e.g., if the user has a margin account), depending on the account type and other conditions.

Alternatively, if represented as a number of contracts or shares, this limited buying power amount may be: the maximum number of contracts or shares of a tradable instrument that can be held in the account at any one time; the maximum number of contracts or shares of tradable instruments that are part of the same exchange that can be held in the account at any one time; the maximum number of contracts or shares of all tradable instruments combined in an account that can be held in the account at any one time; or other possibilities. The limited buying power amount expressed as a number of contracts or shares may typically be used only on the long side, or on both the long and short sides (e.g., if the user has a margin account), depending on the account type and other conditions.

The term “tradable instrument” or “tradable instruments” as used herein may refer to stocks, bonds, currencies, commodities, warrants, options, futures, spreads, synthetics, FOREX contracts, as well as any other type of tradable instrument. Further, the term “tradable instrument” extends to other types of tradable instruments not specifically mentioned herein, or developed in the future, as will be recognized by one of ordinary skill in the art.

It is recognized that there may be other levels to which buying power limits may be assigned in addition to the level of the tradable instrument, the exchange level and the account level described above. Further, there may be buying power limits assigned to multiple levels at the same time within a user account.

A trader's buying power or buying power limits are sometimes referred to as risk limits or position limits. These limits may be measured in dollar value, any other currency value, number of contracts or shares or any other value or volume metric. It should also be noted that even if the trader has not hit the buying power limits, the trader might have an order rejected because the size of that order, if added to the existing position, would be over the buying power limits.

It is intended that the use of the terms buying power and buying power limits encompass any and all of the various iterations of risk limits, position limits and/or buying power limits used now and in the future. Further, it should be noted that the terms buying power and buying power limits may be used interchangeably herein as they generally refer to the same concept.

Buying power limits are typically set by the trader's brokerage (often based on the amount of money the trader has in the associated brokerage account) or by the risk manager for the trader's account (often based on the risk manager's assessment of the risk involved in honoring the trader's position) in light of the trader's risk profile. The buying power limits are caps on the ability of the trader to execute orders and the limits are typically fixed and remain static over reasonably long periods of time. In accounts where the buying power limits are represented in dollar terms, the buying power limits are typically reset at the beginning of each trading day. In accounts where the buying power limits are represented in number of contracts, the amount is usually not changed unless the brokerage account manager or risk manager makes a manual adjustment.

The setting of buying power limits can play an important role in a trader's profitability by placing limits on the potential profit as well as the potential loss in their account. For example, when a trader is limited by a 100:1 leverage ratio, a trader may take positions up to $1,000,000 when the trader's account has $10,000 in equity. In this situation it can easily be appreciated that a single losing trade at the trader's buying power limit can be devastating to a trader's account. Conversely, if the buying power limits were to be too constricted, the ability to execute profitable trades would be limited. Accordingly, managing buying power limits and making use of appropriate position sizes can be critical to minimizing losses and getting more from winning positions.

Although leverage guidelines, account status, and other measures employed by brokerages are typically the only factors accounted for when setting buying power limits, there are numerous factors that influence and/or predict a trader's risk profile. For example, additional factors that may affect a trader's performance and/or risk profile include: mental/emotional factors (i.e., a trader suffering mental or emotional stress is likely to perform less well than a trader who is clear headed and focused); historic performance (i.e., a trader who has lost money five days in a row is likely to perform less well than a trader who has made money five days in a row; a trader who has made money today on only 5 of 35 trades is less likely to make money on his 36th trade than a trader who has made money today on 30 of 35 trades); trading style/technique in light of the market conditions (i.e., a trader whose trading strategy is developed to work well in trending market environments will perform less well in a choppy market than a trader whose trading strategy is designed for choppy markets; a trader who makes most of his money in the volatile market environments surrounding economic data releases and FOMC meetings is not likely to trade as well during the slow lunch time hours as a trader who's trading strategies are specifically designed for those times); hours working vs. typical schedule (i.e., a trader who is used to trading between certain hours of the day is likely to perform less well during off-hours, such as evening hours or early morning hours, than a trader who is used to trading during those off-hours); etc. While some of the above-listed factors affecting performance are predictable in advance, and may even be unchanged for days or weeks at a time, others factors are largely dependent on the moment. For example, intraday performance can fluctuate wildly each day. Thus, it can be seen that a trader's risk profile is not a static characteristic and traders may benefit from adapting their buying power to more closely correspond to their dynamic risk profiles. Even though all of the discussed factors may be clear to the reader now, and may be apparent to a third party viewing the trader's activities during the market day, and likely apparent to the trader once he or she stops working for the day, the factors which influence and/or predict a trader's risk profile are often much less apparent to the trader while trading. This is a key point.

Currently traders have few tools available for adjusting the buying power associated with their account. As noted above, the trader's buying power is usually determined either by the amount of money in a brokerage account (possibly multiplied by a factor for intraday margin or other margin calculations) or the value that is assigned by the brokerage/risk manager/firm where the account is held. In cases in which a trader's buying power is calculated based on account equity, then in order to change the amount of buying power available for trading, the trader would have to transfer money out of his brokerage account every time he wants to reduce risk, and transfer money into the account every time he wants to add risk. In the case in which the trader's buying power is dependent on an assigned or mutually agreed upon value (i.e., between brokerage/risk manger/firm and trader), a trader may have to contact his brokerage/risk manger/firm, wait for the contact to assess the situation with respect to risk tolerances and then come back with a decision. It could take five minutes, five hours or five days, depending on the brokerage or risk manager. Aside from this fact, brokerages and risk managers do not want to make constant changes to their traders' buying power limits. Getting emails and phone calls for this type of request is nothing more than a distraction for them. As can be seen, these methods for adapting buying power limits do not address the additional factors influencing and/or predicting a trader's risk profile, nor are they effective methods of managing dynamic intraday adjustments of buying power limits.

Left with essentially static buying power limits, it is up to the trader to personally manage internal limits on buying power to minimize risk and maximize profit. Essentially, a trader is forced to consider and decide how much of their buying power to use at any given moment. However, this is simply too burdensome a task for most traders and, hence, trader profitability suffers. Consider that the eyes of the typical trader are darting around between two and six monitors filled with streaming charts and data, the ears of the typical trader are filled with news releases and squawk boxes and audio alerts and yet the main activity of the trader is to pick points to enter buy and sell orders. The mind of the typical trader may become overworked and overstressed during just the morning hours. Every trader is prone to missing important information and to making mistakes; it is simply unrealistic for traders to be on top of everything at the same time. So what ends up happening is that while traders may excel at certain tasks, other tasks may be left unattended. One of the most common problems, and certainly the most damaging one, is when traders use unwarranted amounts of buying power at the wrong times. In reference to the point above, even if it may be obvious to any calm onlooker, controlling position size is one of the hardest things a trader can do while trading.

Accordingly, there is a need for a system and method whereby the value of trader's buying power may be automatically adjusted to maximize performance (profit) while minimizing risk (loss). Further, there is a need for a system and method whereby the value of buying power limits may be automatically adjusted based on one or more functions. Further, there is a need for a system and method whereby positions that are outside of buying power limits may be automatically exited. Further, there is a need for a system in which conditions, other than the value condition, of buying power limits may be automatically adjusted as well. Further, there is a need for ways in which users may be able to setup, build and organize their methods for managing the conditions of their buying power they wish to control, and what factors should be used to factor into how the conditions of their buying power are controlled, so that users may more appropriately manage their risk, and such that the output of these methods shall be useful for users to apply manually or automatically to adjust conditions of buying power.

### BRIEF SUMMARY OF THE INVENTION

Certain systems and methods provided herein allow conditions related to a trader's buying power limits within an order entry system to be automatically adjustable. The adjustable conditions may include the value of the buying power limits, the state of whether the value is locked or unlocked (i.e., unable or able to be changed), the state of whether the value is able to be raised or lowered or any other condition of or related to buying power limits. The condition may further be a derivative of another condition, such as, for example, the time at which the long side buying power limits are to be locked.

In one example, the conditions related to buying power limits that may be automatically adjusted are the value of one or more automatically adjustable buying power boundaries that are equal to or less than the buying power limits. The term buying power boundaries is intended to represent adjustable limits that may be more flexible than buying power limits, as described further herein. In another example, the condition of buying power that may be automatically adjusted is the value of one or more buying power limits. In another example, the condition of buying power which may be automatically adjusted is the condition of whether the value of the buying power value may be changed. The automatic adjustment may be based on one or more trader performance based factors, one or more temporal based factors, one or more market condition factors, and/or other factors. Further, the automatic adjustment may be supplemented or triggered by one or more user-triggered factors.

As used herein, automatic adjustment of a condition related to buying power (automatically adjustable, automatically adjusted, etc.) refers to a process in which a condition related to buying power is adjusted in a manner that does not rely exclusively on user action, input or other user-triggers. Accordingly, as used herein, automatic adjustment includes instances in which user input is not involved in the adjustment of the condition, as well as instances in which user action is involved in combination with non-user action. As examples, an automatic adjustment may be pre-planned by a human, may be pre-configured by a human, may occur due to changing factors, but the actual changing of factors happens without relying exclusively on human interaction. For example, a condition of buying power that is set to adjust to a specified state at a particular date and time in the future is an example of automatic adjustment if the state of the condition of buying power automatically changes at the future specified time without any action from the user at the time of the scheduled change (the automatic action being the monitoring of the time and date and the changing of the state of the condition of buying power when the time and date conditions are met).

In one example, the value of a user's buying power may be automatically adjusted using the systems and methods provided herein. The value of the user's buying power may be based, for example, on a single variable or multi-variable calculation. The calculated variable buying power may be expressed as buying power boundaries to distinguish the calculated variable buying power boundaries from the user's relatively static buying power limits. As used herein, buying power boundaries are variable limits, which may be adjusted up to or below the established buying power limits (i.e., the trader's buying power is not allowed to be increased above the maximum allowed by the brokerage or risk manager). It should be noted that even if the buying power boundaries were allowed to be adjusted above the established buying power limits, that trader's buying power would be restricted at that point anyway due to the buying power limits themselves; therefore it is not necessary to consider this scenario. Because the buying power boundaries are positioned within the established buying power limits, adjustment of the buying power boundaries does not require approval of or action by a trader's brokerage and/or account risk manager. Accordingly, the adjustment of the buying power boundaries may be made by the user, or a system working under the user's control, to manage the trader's risk, for example, in an order entry system. Moreover, the buying power boundaries may be updated and/or implemented in real-time or near real-time intervals.

In another example, the calculated variable buying power is expressed simply as the trader's buying power limits, rather than boundaries within the prescribed buying power limits. For example, when a given automatic adjustment method is implemented, accepted, endorsed or otherwise authorized by a trader's risk manager, brokerage, or other risk limiting entity, there may be no need for independent buying power limits and buying power boundaries within those buying power limits. The buying power limits themselves may be calculated and implemented in response to the function calculations. The variable buying power (whether expressed as buying power limits or buying power boundaries) may be established based on provided, tracked and/or calculated variables and/or constants.

In one example using buying power boundaries, if statistical analysis shows that a given trader consistently performs poorly on Monday mornings, but does better as the day/week progresses, the trader's buying power boundaries may be provided as 20% of the buying power limits before 10 am on Monday, as 40% of the buying power limits between 10 am and 11 am on Monday, 60% of the buying power limits between 11 am and noon, etc. The appropriate buying power boundaries may be calculated based on any number of factors, whether simple variables and constants or complex algorithms. For example, statistical modeling or other modeling may be used to calculate appropriate buying power boundaries.

Generally, examples of factors to be used in establishing or calculating appropriate buying power boundaries may include: the day and/or time; calendar events (e.g., economic events, contract expiration dates, planned political events, etc.); the trader's trending performance and other activity (e.g., is the trader currently on a winning or losing streak and what is the magnitude of that streak, trade size, risk of the position(s) already held, percentage of recent trades that have been profitable); the market conditions (e.g., is it a trending or a choppy market); one or more user inputs (e.g., the user may provide input describing the amount of time the trader has spent in preparation (research/chart analysis) for the current trading day, the trader's alertness, quality of breakfast, quality of sleep, physical and/or emotional stress, any other categorical, Boolean or scaled variables entered by the users, as well as other physiological/mental/emotional factors which may be monitored automatically using a heart rate monitor or similar biometric device); etc. Further, the factors may be adapted in any combination and may be designated to hold any importance and/or effect on the buying power boundaries as understood to be most beneficial. Moreover, in some situations, all of the factors may play a noticeable role in the variability of the buying power boundaries, whereas in other scenarios, only two or three factors may account for the buying power boundaries' variability.

While not limited thereto, it is understood that the buying power boundaries may be implemented (automatically or in response to a user command) to provide actual limits on the trader's ability to make transactions within the system. Alternatively, the buying power boundaries may be displayed to a trader as suggested limits or for other purposes. When implemented, there may be, for example, a user override command that enables the buying power boundaries to be disabled from limiting the trader's buying power. As will be understood through the disclosure provided herein, the user may be the operator of the order entry system (e.g., trader), an administrator, a risk manager or any other third party. It is understood, for example, that multiple users may make use of the systems and methods herein to influence conditions related to buying power for a trader or group of traders.

It is also understood that the automatic adjustment of one or more conditions related to buying power may be performed continuously, at predetermined intervals or in response to a user command or other event trigger. In some examples of the systems and methods provided herein the automatic adjustment of one or more conditions related to buying power may occur in approximately in real time, such that the one or more conditions related to buying power are more or less continuously adapting in response to changing factors.

Buying power, and conditions related thereto, may be calculated and/or implemented separately on the long and short side of transactions. For example, in market conditions that are steadily trending upward over a statistically significant period of time, the buying power boundaries on the short side may be smaller than the buying power boundaries on the long side.

It is further envisioned that buying power and conditions related thereto may be separately implemented and adjusted for a single transaction versus aggregated transactions. For example, the value condition related to the buying power limits may be calculated such that a single transaction should not exceed five contracts on the long side, and that the trader's account should not exceed twenty total contracts on the long side. Such multi-tiered buying power limits may provide a more flexible and efficient system and method of managing user risk and improving user performance.

In one contemplated example, a system according to the present invention includes a buying power limited order entry mechanism and a mechanism adapted to calculate variable buying power. The calculated variable buying power may be one or more variable buying power boundaries that are equal to or less than the buying power limits. Alternatively, the calculated variable buying power may be one or more variable buying power limits. The mechanism for calculating the variable buying power may be a risk modeling system and, for example, may be based on the time or day of the week, may be related to calendar events, may be based on market conditions, etc. The factors in the function may be adapted to provide more personalized results by being based on one or more performance based factors, though it is certainly understood that the mechanism does not require personalization. Further, the methods described, which may be used to automatically adjust buying power, may be supplemented by user-triggered methods which may add valuable functionality and user involvement to the described processes.

In another contemplated example, a method of limiting a trader's buying power in an order entry system includes the step of providing variable buying power for a trader, wherein the variable buying power is calculated using a buying power calculation mechanism. As described above with respect to the system, the one or more calculated buying power boundaries may be further, though not necessarily, implemented to limit the trader's buying power. The implementation of the buying power boundaries as actual limits on the trader's buying power may be in response to a user command or may be automatically implemented by the order entry system.

In another contemplated example, a method of limiting a trader's buying power within an order entry system, wherein the order entry system includes buying power limits for the trader, the method includes the steps of calculating one or more buying power boundaries equal to or more limiting than a trader's buying power limits and, optionally, restricting the trader from placing orders that exceed the buying power boundaries.

The systems and methods provided herein may be implemented in a number of circumstances to help manage user risk and improve user performance. A few illustrative examples are provided. For example, a trader who has suffered losses in market conditions in which the trader believes he or she should have been profitable may become emotionally charged and/or confused and may take on positions that are self-destructive. A trading system and/or method that automatically calculates and/or implements variable buying power to limit impulsive, self-destructive transactions may prevent the trader from initiating new market positions under these conditions.

In another example, a trader that has made money in the morning in a volatile, opportunity-rich market environment (such as a trending market), may temporarily believe that he or she can not lose rather than relate the strong profits to the trending market, which often slowly recedes in the afternoon into a choppy market. If improper attribution is made, the trader may mistakenly continue to trade heavily and give up most of the gains as the afternoon progresses. A trading system and/or method that automatically adjusts one or more conditions related to buying power corresponding to market conditions may prevent the trader from trading too heavily under the changed conditions.

In a further example, a trader may allocate valuable research and analysis time to evaluating his or her recent trading performance such as, for example, why the trader has had significant losses recently and to consider whether he or she needs to adjust his or her risk. The trader may conclude that he or she didn't perform as well as usual due to stress in home life. Further, he or she may conclude that it would have been easier to pick entry points on the long side of the market instead of the short side of the market, but that foresight would have been difficult given the lack of time for their regular market analysis and stress. With so much self-analysis and time spent on this personal reflection, the trader may once again miss out on their regular schedule of market-analysis. Accordingly, the trader may miss the fact that the market which has been trending upward is reaching key technical resistance points. By missing this fact, the trader may be too aggressive on the long side after the changed market condition, causing the trader to suffer further heavy losses in a falling market. A trading system and/or method that takes some of the job responsibilities off the trader's back, i.e., automatically adjusting one or more conditions related to buying power, may allow a trader to focus more on the market, and less on his or her own condition. Further, a trading system and/or method that automatically adjusting one or more conditions related to buying power may prevent the user from trading too heavily on the long side of a falling market.

In the examples provided herein providing variable buying power (limits or boundaries), the calculated variable buying power may be applied in conjunction with a position adjusting mechanism to adjust positions or open orders held by the trader that fall outside of the presently implemented buying power limits. With existing trading software, a trader would not typically find himself in a situation in which he held positions or open orders in excess of the buying power limits, but due to the variable buying power limits provided herein, there will be frequent occasions in which this situation arises. In some examples, the position adjusting mechanism may automatically adjust one or more open positions or open orders in response to the implemented buying power limits. In other examples, the position adjusting mechanism may adjust one or more open positions or open orders only in response to user input, such as, for example, a user accepting a suggestion to close the open positions in excess of the presently implemented buying power limits. In both examples, the position adjusting mechanism provides automated decision making (whether determinative, optional, suggestive, etc.) related to the adjustment of open positions in a user-directed, risk managed, order entry system.

In one example, an order entry system for tradable instruments includes: a buying power limit constrained order entry mechanism, wherein one or more conditions related to one or more buying power limits are adapted to automatically adjust. The one or more conditions related to buying power may include the value of the buying power limits. The value of buying power limits may further include separate long side and short side values. In an alternate embodiment, the one or more conditions related to buying power may include a suggested value of buying power limits, which may be implemented by a user. The one or more conditions related to the buying power limits may be adapted to automatically adjust in response to one or more factors, including factors related to day and time, factors related to market data, factors related to user performance and/or manually applied user input. The one or more conditions related to the buying power limits adapted to automatically adjust may further include a condition displayed to a user. The buying power limit constrained order entry mechanism may be a user-directed order entry mechanism. The order entry system may further include a risk management application adapted to provide functionality to implement conditions for the automatic adjustment of the one or more conditions related to the buying power limits. The order entry system may also include one or more conditions related to buying power limits adapted to be manually adjusted.

In another example, a method of controlling risk in an order entry system for tradable instruments includes the steps of: providing one or more conditions related to buying power; and automatically adjusting the one or more conditions related to buying power. The one or more conditions related to buying power may include the current buying power limits. The method may further include the step of automatically exiting currently held positions outside of the presently applied buying power limits.

In a further example, computer readable medium includes computer-executable instructions for controlling risk in an order entry system for tradable instruments, the computer-executable instructions causing the system to perform the steps of: providing one or more conditions related to buying power; and automatically adjusting the one or more conditions related to buying power. The one or more conditions related to buying power may include the presently applied buying power limits. The computer-executable instructions may further cause the system to perform the step of automatically exiting currently held positions outside of the presently applied buying power limits.

In another example, an order entry system for tradable instruments includes: a buying power limit constrained order entry mechanism adapted to automatically adjust a condition related to one or more currently open orders or currently held positions in response to a change in the buying power limits. The change in the buying power limit may be an automatic adjustment of the value of the buying power limits. Alternatively, the change in the buying power limit may be a manual adjustment of the value of the buying power limits. In certain embodiments, presently held positions that exceed the changed buying power limits are automatically liquidated, presently open orders that exceed the changed buying power limits are automatically cancelled, and/or the order entry mechanism automatically adjusts the size of presently open orders that, if added to the existing position, would be over the buying power limits. In further embodiments, a change in buying power limits automatically presents the user with the option to liquidate presently held positions that exceed the changed buying power limits, the option to cancel presently open orders that exceed the changed buying power limits and/or the option to adjust the size of presently open orders that, if added to the existing position, would be over the buying power limits.

In another example, a method of adapting risk in a buying power limit constrained order entry system for tradable instruments includes the steps of: changing the value of the buying power limits; and automatically adjusting a condition related to one or more currently open orders or currently held positions in response to the changed value of the buying power limits. The step of changing the value of the buying power limits may include an automatic adjustment of the value of the buying power limits. The step of changing the value of the buying power limits may alternatively include a manual adjustment of the value of the buying power limits. In certain embodiments the presently held positions that exceed the changed buying power limits are automatically liquidated. In other examples, presently open orders that exceed the changed buying power limits are automatically cancelled. The step of automatically adjusting a condition related to one or more currently open orders or currently held positions in response to the changed value of the buying power limits may include adjusting the size of presently open orders that, if added to the existing position, would be over the buying power limits. The automatically adjusted condition may include a presentation to the user of the option to liquidate presently held positions that exceed the changed buying power limits. The automatically adjusted condition may include a presentation to the user of the option to cancel presently open orders that exceed the changed buying power limits. The automatically adjusted condition may include a presentation to the user of the option to adjust the size of presently open orders that exceed the changed buying power limits to not exceed the changed buying power limits.

In another example, computer readable medium includes computer-executable instructions for adapting risk in a buying power limit constrained order entry system for tradable instruments, the computer-executable instructions causing the system to perform the steps of: changing the value of the buying power limits; and automatically adjusting a condition related to one or more currently open orders or currently held positions in response to the changed value of the buying power limits. The step of changing the value of the buying power limits may be the result of an automatic adjustment of the value of the buying power limits.

In an example, an order entry system for tradable instruments includes: a buying power limit constrained order entry mechanism wherein independent buying power limits are provided for short side and long side. The buying power limits may be provided via manual input or automatically. The buying power limits automatically adjust in response to one or more factors including: one or more factors related to day and time; one or more factors related to market data; one or more factors related to user performance; and/or a manually applied user input.

In another example, a method of controlling risk in an order entry system for tradable instruments includes the steps of: providing buying power limits constraining order entry; and establishing independent buying power limits for short side and long side. The buying power limits may be provided via manual input or automatically. The method may further include the step of automatically adjusting the buying power limits in response to one or more factors.

In yet another example, computer readable medium includes computer-executable instructions for controlling risk in an order entry system for tradable instruments, the computer-executable instructions causing the system to perform the steps of: providing buying power limits constraining order entry; and enabling independent buying power limits to be set for short side and long side. The buying power limits may be provided via manual input or automatically. The computer-executable instructions may further cause the system to perform the step of automatically adjusting the buying power limits in response to one or more factors.

In another example, a system for building functions configured to adjust one or more conditions related to buying power includes: a user interface through which a user may identify one or more factors to create one or more functions configured to adjust one or more conditions related to buying power. The user interface may further enable a user to identify one or more relationships by which the factors are related. The one or more relationships by which the factors are related may include one or more mathematical relationships. The one or more functions may be configured to automatically adjust one or more conditions related to buying power. Further, the user interface may be associated with an order entry system for tradable instruments. The one or more conditions related to buying power include the value of the buying power limits. The value of buying power limits may further include separate long side and short side values. The one or more conditions related to buying power may include a suggested value of buying power limits. The output of the one or more functions configured to adjust one or more conditions related to buying power may be applied in an order entry system. The output may be the value of the buying power limits. The one or more factors may include a factor related to day and time, a factor related to market data, a factor related to user performance and/or a manually applied user input. The one or more conditions related to buying power may include a condition displayed to a user and the condition displayed to the user may include a suggested value for the buying power limits.

In another example, a method of building functions configured to adjust one or more conditions related to buying power includes the steps of: identifying one or more factors to be used in a function configured to adjust one or more conditions related to buying power; identifying one or more relationships by which the factors are related; applying the identified one or more relationships to the identified one or more factors; and adjusting the one or more conditions related to buying power in response to the application of the identified one or more relationships to the identified one or more factors. The steps of applying the identified one or more relationships to the identified one or more factors and adjusting the one or more conditions related to buying power in response to the application of the identified one or more relationships to the identified one or more factors may be implemented without human intervention between the two steps. The method may further include the step of applying the adjusted one or more conditions related to buying power in a user-directed order entry system for tradable instruments.

In yet another example, a computer readable medium includes computer-executable instructions for building functions configured to adjust one or more conditions related to buying power, the computer-executable instructions causing the system to perform the steps of: identifying one or more factors to be used in a function configured to adjust one or more conditions related to buying power; identifying one or more relationships by which the factors are related; applying the identified one or more relationships to the identified one or more factors; and adjusting the one or more conditions related to buying power in response to the application of the identified one or more relationships to the identified one or more factors.

As provided herein, the systems and methods described may be designed to improve user performance and optimize user risk. One advantage of the systems and methods provided herein is in the fact that the functions adapted to automatically adjust the one or more conditions related to buying power may be built ahead of time, strength-tested under hypothetical conditions, revised and upgraded before being implemented by the user. Accordingly, the performance of the systems and methods may be less likely to be negatively impacted by “gut reactions,” emotional responses and inadequately informed judgments.

A further advantage of the systems and methods provided herein is that they may be restricted, implemented, overridden, etc. by users in response to trigger actions or events (personal or market based) to assist in improving performance throughout the trading day.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

Due to the size of some of the figures provided herein, some figures have been broken into multiple sub-figures. In some instances functionality has been split across multiple figures, but best efforts have been made to keep related functionality in one figure where possible.

FIG. 1 is a block diagram of a risk management system.

FIG. 2 is a flow chart illustrating the steps of a method of risk management.

FIG. 3 is a flow chart illustrating the steps of another method of risk management.

FIG. 4 is a block diagram illustrating another risk management system.

FIG. 5A is a screen shot illustrating an example of a buying power limits assignment interface.

FIGS. 5B-5D are views of a portion of the buying power limits assignment interface shown in FIG. 5A.

FIG. 6A is a screen shot illustrating another example of a buying power limits assignment interface.

FIGS. 6B-6C are views of a portion of the buying power limits assignment interface shown in FIG. 6A.

FIG. 7A is a screen shot illustrating an example of a risk management application.

FIGS. 7B-7H are views of a portion of the risk management application shown in FIG. 7A.

FIG. 8 is a screen shot illustrating an example of a model building application.

FIG. 9A is a screen shot illustrating examples of data tables.

FIGS. 9B-9C are views of a portion of the data tables shown in FIG. 9A.

FIG. 10A is a screen shot illustrating an example of a multiplicative model adapted to automatically adjust the value condition of buying power limits.

FIGS. 10B-10D are views of a portion of the multiplicative model shown in FIG. 10A.

FIG. 11A is a screen shot illustrating another example of a risk management application.

FIGS. 11B-11G are views of a portion of the risk management application shown in FIG. 11A.

FIG. 12A is a screen shot illustrating an example of a conditional logic building application.

FIGS. 12B-12F are views of a portion of the conditional logic building application shown in FIG. 12A.

FIG. 13 is a screen shot illustrating a group of functions for calculating the value of buying power limits on the long and short sides.

FIG. 14 illustrates an example of a chart that displays buying power limits.

### DETAILED DESCRIPTION OF THE INVENTION

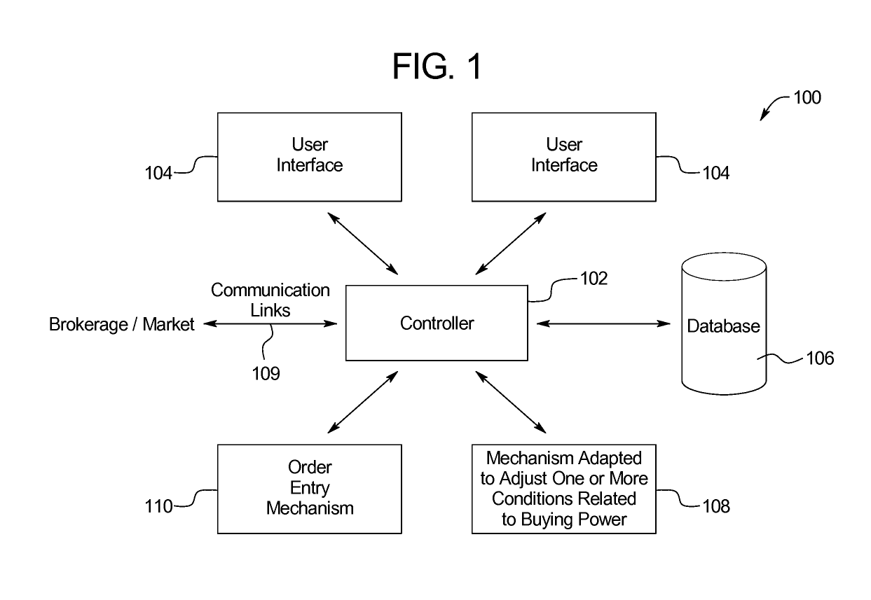

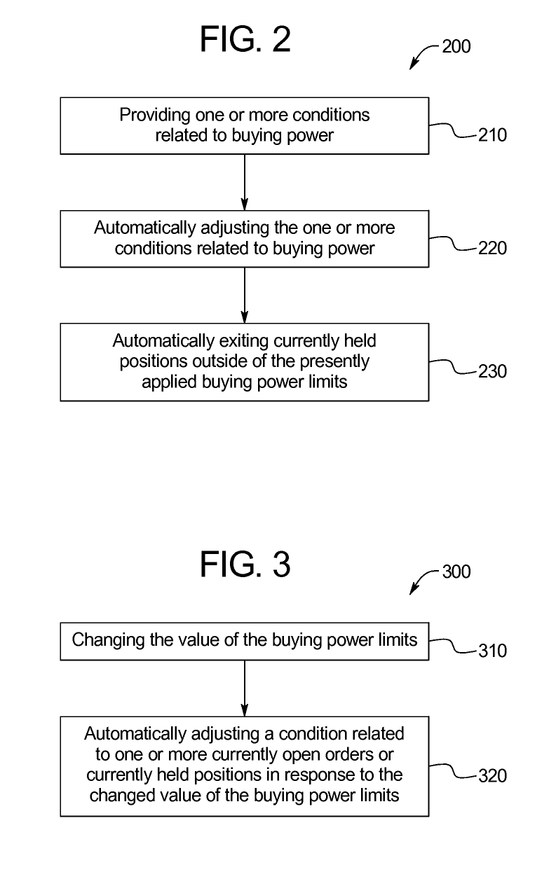

FIG. 1 illustrates a user directed, risk managed, order entry system 100 (the system 100). FIGS. 2 and 3 illustrate methods of risk management (the methods 200 and 300). It is contemplated that the examples provided herein with respect to FIGS. 1-3 are merely illustrative examples of systems 100 and methods 200 and 300 adapted to incorporate the advantages of the inventions described herein and that numerous alternatives to the illustrated examples may be provided to accomplish the advantages of the inventions.

The system 100 shown in FIG. 1 includes a controller 102, two user interfaces 104 and an associated database 106. The controller 102 runs a variety of application programs, accesses and stores data, and enables one or more interactions via the user interfaces 104 as will be described in greater detail herein. While further description of the controller 102 is provided below, it is understood that the controller 102 may be embodied in any one or more electronic systems arranged to control the electronic aspects of the system 100 and the methods 200 and 300 described herein.

A user interacts with the system 100 via a user interface 104. It is understood that the system 100 described herein is scalable and that there may be any number of user interfaces 104 that may be utilized by any number of one or more users. Moreover, it is understood that each given user may access and interact with the system 100 via a plurality of user interfaces 104. For example, a user may access the system 100 a first time via a first user interface 104 and then access the system 100 a second time via a second user interface 104. It is further understood that the term “user” may refer to a trader, an account manager, an account analyst, a risk manager, or other user of the system as will be understood contextually herein. Accordingly, it is understood that a trader may access the system 100 via a first user interface 104 at a first location, while a risk manager may access the system 100 from a second user interface 104 at a second location, either simultaneously or at different times.

As shown in FIG. 1, the system 100 includes one or more databases 106. The one or more databases 106 store information relating to the operation of the system 100 and methods 200 and 300 as described herein. The one or more databases 106 may be integrated with the one or more controllers 102 or may be independent of the one or more controllers 102. The structure and operation of the one or more databases 106 will be understood to one having ordinary skill in the art given the context of the description provided herein. Further, for purposes of this disclosure, the phrase one or more databases 106 should be read to include any mechanism for storing, relating, organizing and retrieving data. It is also understood that in some contemplated embodiments of the system 100 and methods 200 and 300 the information storage and relationships may be inherent in the programming code, without the use of one or more databases 106.

The system 100 may be a software-driven system 100. For example, the system 100 may be a software-driven subscription based private network hosted on one or more servers functioning as the one or more controllers 102, as described herein. Alternatively, the system 100 may be implemented in any manner such that the user is able to access the risk managed order entry system 100 to execute orders related to one or more tradable instruments via one or more user interfaces 104.

In the example shown in FIG. 1, the system 100 is adapted to provide an order entry system 100 to an end user, such as a trader. Accordingly, the user interface 104 is adapted to provide the end user with an order entry mechanism 110. The order entry mechanism 110 may be embodied in any of numerous forms, but most commonly includes trader activated buy and sell commands used to buy and sell tradable instruments. The order entry mechanism 110 described with reference to FIG. 1 is an order entry mechanism 110 provided through trading software, as will be recognized by one of ordinary skill in the art. The order entry mechanism 110 may include a GUI and be primarily driven by mouse-clicks, touch-screen presses, or other methods, or the order entry mechanism 110 may not include a GUI, and it may be driven by hotkeys, keyboard shortcuts or other methods.

In the example shown in FIG. 1, the order entry mechanism 110 is a buying power limited order entry mechanism 110. In other words, the size and/or volume of orders placed through the order entry mechanism 110 are limited based on established buying power limits. The buying power limits may be expressed as dollar limits, position limits or any other value or volume metric. The buying power limits may be placed and/or enforced at any point between the user and the market (e.g., at the user's software, at the brokerage, at the market, etc.), and are not required to be at the same location as the user interface 104 within system 100.

Transactions executed through trading software typically pass through communication links 109 to a brokerage or other transaction management system (e.g., an in-house management system for an institutional trader) before being sent to the market. Usually the buying power limits constraining a trader's activity are provided by the brokerage or proprietary trading firm or other firm or risk manager. In some systems, the constraints are in place at the brokerage or firm, while in other systems, the constraints are in place within the software trading platform itself.

The system 100 described with reference to FIG. 1 includes a mechanism adapted to adjust one or more conditions related to buying power 108 In one example, a condition related to buying power is the value of the buying power. Accordingly, the system 100 may be adapted to provide variable buying power limited order entry mechanism 110. In such cases, the variable buying power may be expressed as one or more buying power boundaries equal to or less than the buying power limits associated with the trader's account. The buying power boundaries may be, in effect, reduced buying power limits placed on the trader's account to assist in managing the trader's risk. In one of the contemplated embodiments of the system 100 described herein, the buying power boundaries are variable, based on one or more factors and include independent long and short side buying power boundaries, though it is understood that the buying power boundaries may be any calculated limits less than or equal to the buying power limits associated with the trader's account. It is understood that the calculated variable buying power, particularly, but not exclusively, when expressed as buying power boundaries, may or may not automatically limit a user from placing an order that exceeds the calculated variable buying power. For example, in some instances, the calculated variable buying power may be displayed to a user (e.g., trader, risk manager, etc.), who may have the option to enact the calculated buying power as a limit or to disregard the suggested or calculated buying power at that time.

It is further understood that the one or more conditions related to buying power may be conditions other than the value of the buying power. Further examples will be provided herein, but the one or more conditions related to buying power may be, for example, whether a condition related to buying power may be automatically adjusted, whether the adjustment may be limited in magnitude or duration, etc.

Each of the conditions related to buying power may be adjusted independently. For example, if there are separate long and short buying power limits, the value condition related to the short buying power limit may be adjusted without adjusting the value condition related to the long buying power limit.

As described herein, certain embodiments of the system 100 and methods 200 and 300 may be adapted to provide an order entry mechanism 110 limited by variable buying power expressed as buying power boundaries. It is also recognized that the system 100 and methods 200 and 300 are equally applicable to embodiments in which the variable buying power is expressed as buying power limits, e.g., embodiments in which there are not independent buying power limits and buying power boundaries. In other words, it is understood that in some examples of the system 100 and methods 200 and 300 described herein, the variable buying power is the actual buying power limits for the trader. In other examples the buying power boundaries may be suggested only, or may be optionally implemented as actual limitations on the trader's ability to place orders within the system.

In a most basic sense, when adapted to calculate variable buying power limits, the mechanism adapted to adjust one or more conditions related to buying power 108 in the example provided in FIG. 1 is intended to temporarily and dynamically expand a trader's buying power when the trader is most likely to realize a profit and contract the trader's buying power when the trader is most likely to realize a loss (or calculate suggested expansions and contractions). Accordingly, the mechanism adapted to adjust one or more conditions related to buying power 108 may utilize or otherwise be based upon a predictive model, embodied in one or more functions, as described further herein. The magnitude and rate of expansion and contraction of the buying power may be related to the strength of the predictive model's output. For example, when the one or more functions predict that the trader is likely to experience losses with a high level of confidence, the buying power may contract by a large order of magnitude. However, when the one or more functions calculate that the trader is likely to experience losses with a low level of confidence, the buying power may contract by a small order of magnitude. In addition, other conditions related to buying power may be calculated and/or adjusted to accomplish the objective of temporarily and dynamically expanding a trader's buying power when the trader is most likely to realize a profit and contracting the trader's buying power when the trader is most likely to realize a loss.

It is understood that the mechanism adapted to adjust one or more conditions related to buying power 108 may be implemented in a system intended to automatically limit the activity in the trader's account, in a system intended to provide suggested limitations to the user (e.g., trader, risk manager, etc.), or in any other system that may otherwise make use of the adjusted conditions. In an embodiment in which variable buying power is calculated, it is understood that just because buying power is calculated, there is no requirement that the calculated buying power is automatically implemented to restrict the trader's activity. For example, in one contemplated example, the calculated buying power is provided to the user and the user is given the option of accepting or overriding the suggested buying power. In another example, the calculated variable buying power may be displayed to the user as a suggestion for what limits may be most prudent under current conditions.

The output of the mechanism adapted to adjust one or more conditions related to buying power 108 may be used to raise or reduce the buying power limits on both sides of the market or one side of the market only. Accordingly, the mechanism adapted to adjust one or more conditions related to buying power 108 may be used to shift a trader's risk profile between long and short biases. This may be particularly advantageous, for example, in a trending market where the market conditions suggest that the trader should weigh his or her transactions towards one side of the market.

It is intended that in some embodiments of the system 100 described herein, the mechanism adapted to adjust one or more conditions related to buying power 108 may incorporate or be based upon, at least in part, any one or more of an algorithmic system, equation, mathematical model, conceptual model, computer model, data model, statistical model, conditional logic, etc. With the intention of improving the readability of the description provided herein, in many instances, the various types of systems and methods incorporated into or used by the mechanism adapted to adjust one or more conditions related to buying power 108 are generically referred to as functions, which may be based on any number of factors. The term function is not intended to be limiting to any particular embodiment of a mechanism adapted to adjust one or more conditions related to buying power 108. There is no upper limit to the number of factors (whether variable or constant) that may be used in a given function. Further, all of the factors used in a function may have any imaginable relationship with each other, including, for example, multiplicative, additive, logarithmic, exponential, etc. mathematical relationships. The weight of each factor in a function may be minimal or severe, as determined by the mechanism adapted to adjust one or more conditions related to buying power 108 and/or the user inputs. Further, it is understood that any specific functions described herein are provided for illustrative purposes and not in a limiting manner.

For versions of the mechanism adapted to adjust one or more conditions related to buying power 108 that include or are otherwise based on one or more functions, there are numerous examples of factors that may be used as variables and/or constants in the functions. For example, a function may make use of temporal values (e.g., factors based on the day of the week, the time of the day, etc.); performance-based values (e.g., such as the trader's recent profits/losses, etc.); market-based factors (e.g., market volume, whether the market is trending or choppy, etc.); and similar factors. Further, these factors may be supplemented by user-triggered factors (e.g., factors that vary when the input and/or setting is altered by the user.

The factors used in the function may come from user input, may be derived from values stored in the one or more databases 106, may be culled from public or private data sources (e.g., market information, news sources, subscription based sources, etc.), etc. It is contemplated that the factors may be partially or wholly populated by the user, for example, through a user factor entry application presented to the user via the user interface 104. The user interface 104 may enable the user to populate the factors through the use of any functional data input mechanism such as, for example, text boxes, combo boxes, input-type boxes, slider controls, radio buttons, etc. Further, as described above, biometric devices may be used as inputs into the one or more functions. Alternatively, the factors may be derived independent of any user specific input (i.e., the factors may be based on the trader and/or the trader activity, but are not specifically requested of or input by a user). In addition, the factors may use or may reference tables, forms, lists or any other data source or structure as populated by a user, populated by any other person or computer generated. It is further contemplated that defaults and/or suggested methods for function development may be provided and that further a user may create and save functions for future use. In addition, the data may be collected, entered and/or referenced at any time. For example, certain data may be referenced by a given function at specific intervals throughout a given month, while other data may be accessed for a given function's use in real-time.

When used to adjust the value of the buying power limits, the adjusted buying power limits may be expressed in many forms. For example, as a percentage of the trader's buying limits (e.g., a buying power boundary may be presented as thirty percent of the trader's long side buying limit). In another example, the output may be expressed as a boundary independent of the trader's buying power limits (e.g., a buying power boundary may be presented as $10,000 in contracts on the short side or three contracts on the short side). As described above, the output may be automatically integrated and made effective within the system 100 or it may require one or more user actions before the calculated buying power functionally restrains the trader's account.

In addition, the mechanism adapted to adjust one or more conditions related to buying power 108 may adjust conditions in current and/or future time periods. In some examples of the system 100 described herein, conditions of buying power may be adjusted for a given time frame, while not being implicative of future time periods. In other examples, certain factors may trigger an adjusted condition that remains in effect until those factors are revised, until some period of time elapses, until a future event occurs, etc.

It is understood that embodiments of the order entry system 100 may be adapted to continuously calculate and/or implement variable buying power, calculate and/or implement variable buying power at specified intervals (predetermined or triggered intervals), calculate and/or implement variable buying power in response to a user request, etc. For example, the variable buying power may be calculated and/or implemented for an entire day or an entire trading session. In another example, the variable buying power may be calculated and/or implemented for a number of milliseconds, seconds, minutes, hours, days, weeks, months, etc. In a further example, variable buying power may be calculated and/or implemented until a certain event occurs or stops occurring.

It is further considered that it may be advantageous for a user to be able to preview or review the conditions related to buying power and the implemented or suggested adjustments thereto. For example, a user may wish to preview the variable buying power to be calculated and/or implemented or to review the variable buying power that was actually calculated and/or implemented. Accordingly, in some embodiments of the system 100, a user may have access to an output (e.g., chart, table, calendar, etc.) of future modeled conditions related to buying power (e.g., the variable buying power calculated for the upcoming day or week). It is understood that the future modeled conditions related to buying power may include estimates for dynamic factors not yet measured/identified. Accordingly, the future conditions related to buying power may not be accurate, may be estimates and/or may be subject to change. Thus, the preview may not be perfectly indicative of the conditions related to buying power that are to be calculated and/or implemented when the time comes. Similarly, the user may have access to an output of the conditions related to buying power actually calculated and/or implemented after the fact. It is understood that any number of other methods of viewing the current/active calculated conditions related to buying power, previous calculated conditions related to buying power and/or future calculated conditions related to buying power may be made available to a user.

As described herein, there are numerous factors that may be incorporated into a given function used by the mechanism adapted to adjust one or more conditions related to buying power 108. The following examples are illustrative of functions incorporating various factors. For purposes of clarity, the following illustrative examples tend to be towards the simplistic side of the spectrum (or merely describe one sub-function of a larger function), though more complex functions will be understood by one having ordinary skill in the art based on the explanations provided herein.

In one example, a function may be based on or otherwise incorporate a personalized trader risk profile generated through historical analysis of the trader's performance. In such an example, the risk profile may include a table with assigned values for the day of week and the time of day. It may be the case that a particular trader tends to have poor Monday mornings, but tends to do better as the day and week progress. In such an instance, a table of days and times of day may be used as a modifier to any other function calculations. In this example, the trader's risk profile may include a modifier of 0.2 from the opening bell until 10 AM Monday morning, a modifier of 0.4 from 10 AM until noon on Monday, a modifier of 0.6 from noon until 2 PM on Monday afternoon and a modifier of 0.8 from 2 PM until the close of the market on Monday. Accordingly, the calculated buying power may be contracted during each time frame by multiplying the modifier from the risk profile with the results of the remainder of the function or, in a simple case, by multiplying the modifier and the trader's otherwise assigned buying power limits. Depending on the trader's historical performance, the risk profile may be something like a modifier of 0.4 from the opening bell until 10 AM Tuesday morning, a modifier of 0.75 from 10 AM until noon on Tuesday, a modifier of 0.9 from noon until 2 PM on Tuesday afternoon and a modifier of 1.0 from 2 PM until the close of the market on Tuesday. Further, if Wednesday afternoon is historically the trader's best performance period, the modifier may be greater than one. For example, a modifier of 0.6 from the opening bell until 10 AM Wednesday morning, a modifier of 0.9 from 10 AM until noon on Wednesday, a modifier of 1.2 from noon until 2 PM on Wednesday afternoon and a modifier of 1.2 from 2 PM until the close of the market on Wednesday. In examples in which the calculated buying power is expressed as variable buying power boundaries, it is understood that in some embodiments that even if an individual modifier is greater than one, the buying power boundaries may not be larger than the trader's buying power limits. It is further understood that in other examples, the buying power boundaries may be larger than the trader's buying power limits, in which case the trader's buying power limits would restrict the trader's ability to place orders within the system.

In another example, a function may incorporate factors based on predictable calendar events. For example, the following categories of predictable calendar events may be used by the mechanism adapted to adjust one or more conditions related to buying power 108: known economic events, Federal Open Market Committee (FOMC) meetings and speaker events, planned political meetings and events, futures contract rollover periods, option expirations, etc. For example, in preparation for an FOMC event, the mechanism adapted to adjust one or more conditions related to buying power 108 may contract the trader's buying power for thirty minutes prior to the FOMC meeting. Next the mechanism adapted to adjust one or more conditions related to buying power 108 may neutrally impact the trader's buying power at a time corresponding to the release of the FOMC statement. Then, the mechanism adapted to adjust one or more conditions related to buying power 108 may expand the trader's buying power for the five to ninety minutes post-announcement. Finally the mechanism adapted to adjust one or more conditions related to buying power 108 may then slowly reduce the influence of the FMOC statement on the boundary positions by tapering off the influence on the trader's buying power for the remainder of the day.

In another example, a function may incorporate dynamic factors related to performance-based measurements of the trader's open positions. For example, if an open position exhibits a loss, using any preferred accounting method (e.g.: first in, first out; last in, first out; the average of both; etc.), greater than a given constant or variable (e.g., limit input by user, a dynamic factor based on the volatility or range of the tradable instrument, etc.), the mechanism adapted to adjust one or more conditions related to buying power 108 may limit entry into new positions. In one example, a limited buying power value may be recommended for or implemented for a predetermined amount of time, or until the condition of having the loss exceeding the factor is no longer true, or may be immediately reduced and then ramped back up over a predetermined period of time, or may ramp up in response to a function or sub-function, etc. Further, even if a trader's open position exhibits a loss greater than a given factor, the mechanism adapted to adjust one or more conditions related to buying power 108 might not limit positions entirely, but may rather simply tighten the risk profile by reducing the calculated variable buying power, possibly on both sides of the market, or possibly only on the side of the market showing a current loss by the trader.

Similarly, in a further example, the mechanism adapted to adjust one or more conditions related to buying power 108 may make use of real-time analysis of the trader's intraday P & L and trading profile. To the extent that the trader's profile is typically correlated with profitable trading results, the mechanism adapted to adjust one or more conditions related to buying power 108 may provide less restrictive buying power and to the extent that the trader's profile is typically correlated with unprofitable trading results, the mechanism adapted to adjust one or more conditions related to buying power 108 may provide more restrictive buying power. The mechanism adapted to adjust one or more conditions related to buying power 108 may further incorporate user inputs to enable the user to adjust factors affecting the trader's ongoing risk. It is contemplated that the system 100 may store the trader's historical P & L performance data in the one or more databases 106 for use with other future function calculations.

Similarly, in a further example, the mechanism adapted to adjust one or more conditions related to buying power 108 may make use of an analysis of the trader's historic and/or intraday trading profile. As used herein, the term trading profile refers to historic and intraday P & L data and as well many other factors that can be predictors of future performance. For example, P & L on the long side only and/or short side only per historic day analyzed and intraday for current day, the ratio of the average time winning trades were held versus the average time losing trades were held per historic day analyzed and intraday for current day, the average time all trades were held per historic day analyzed and intraday for current day, the average time in between trades per historic day analyzed and intraday for current day, the percent of time any position at all was held during the regular hours of the trader's workday per historic day analyzed and intraday for current day, the average position size as a comparison to the calculated variable buying power that was in place at the time per historic day analyzed and intraday for current day, the percent of time the maximum allowable position size was held in account per historic day analyzed and intraday for current day, the ratio of profitable trades to losing trades made per historic day analyzed and intraday for current day, the ratio of total profits to total losses per historic day analyzed and intraday for current day, the number of trades made per historic day analyzed and intraday for current day (adjusted by time of day for current day), the number of trades made per time period in which there was at least one open position in the trader's account per historic day analyzed and intraday for current day, a comparison of the percent of time the trader held a position on the side of the market that showed predominant performance during the time traded to the percent of time the trader held a position on the side of the market that showed weak performance during the time traded per historic day analyzed and intraday for current day, the ratio of number of trades initiated on the side of the market that showed predominant performance during the time traded to the number of trades initiated on the side of the market that showed weak performance during the time traded per historic day analyzed and intraday for current day, as well as any other derivation of these methods, or any other variable or calculation derived off of factor or factors which involve a trader's own historic and intraday trade history information. A user may analyze these types of factors of the trader's trading activity, and after careful study, determine which of the discussed and other factors are the best predictors for his or her current and future trading success and would be beneficial for inclusion into a function incorporated into or used by the mechanism adapted to adjust one or more conditions related to buying power 108. The user might then create a scoring method on the trading profile information discussed, and might apply this scoring method to each day of historic and intraday trading profile information to create a scored trading profile. The user might likely also study what time period of historic and intraday “trading profile” factors should be applied for use in the function incorporated into or used by the mechanism adapted to adjust one or more conditions related to buying power 108. As an example, the user may determine that historic data going back as far as two weeks is a predictor of current day performance, but is only mildly correlated. To continue with this example, the user might find stronger correlations of data going back only one week, and especially only one or two days.

As a separate but related example, a user may find that the current day's trading profile up until the current time is a valuable predictor of today's end of day performance level. Further, the user may recognize the previous one or more days' trading profiles may also be valuable predictors, whether equal to, not as good as or better than the current day's data. The user may take the scored trading profile for each day going back during the time period expected to be relevantly correlated to the current or future time period to be calculated and apply weightings to multiply each of the scored trading profiles to calculate an aggregated weighted scored trading profile. To the extent that the aggregated weighted scored trading profile is predictive of positive performance, the mechanism adapted to adjust one or more conditions related to buying power 108 may provide less restrictive conditions of buying power and to the extent that the aggregated weighted trading profile is predictive of negative performance, the mechanism adapted to adjust one or more conditions related to buying power 108 may provide more restrictive conditions of buying power.

Note that the scoring and weighting methods discussed are only a few examples of the unlimited number of ways that a user may use historic and intraday P & L and other trading profile information as predictors of current and future trading performance. It is further understood that the system 100 may store the trader's historical and current intraday P & L performance data and other trading profile information in the one or more databases 106 for future use.

Herein we refer to “more restrictive conditions of buying power” or “conditions of buying power may be restricted” or use similar language elsewhere. When we use this language in regards to restrictive conditions of buying power, this may include any of the following but not be limited to: a reduced value condition for one or more buying power limits, a reduced maximum value condition for one or more buying power limits, a longer time frame for which a value or maximum value of buying power may be kept at reduced levels, etc. Further herein we refer to “less restrictive conditions of buying power” or “conditions of buying power may be less restricted” or use similar language elsewhere. When we use this language in regards to less restrictive conditions of buying power, this may include any of the following but not be limited to: an increased value condition for one or more buying power limits, an increased maximum value condition for one or more buying power limits, a shorter time frame for which a value or maximum value of buying power may be kept at reduced levels, etc.

Given the ability of the mechanism adapted to adjust one or more conditions related to buying power 108 to adjust various conditions, we provide herein specific examples of which conditions may be adjusted. However, it is understood that even though in many cases only one condition was referred to, the examples and uses can be extended to other conditions related to buying power as described herein. The purpose of describing only one condition is to improve readability and improve understanding, but is in no way intended to limit scope. In a common example of how we have approached this, we may discuss how the value condition of buying power may be contracted or expanded or calculated and automatically adjusted; however the same examples provided may easily be extendable to whether the value condition is locked or unlocked, or to other conditions related to buying power as adjusted.

In yet another example, the mechanism adapted to adjust one or more conditions related to buying power 108 may be influenced by one or more factors used to analyze the trendiness of the market (i.e., the degree to which the market is trending rather than being choppy). For a trader who historically performs better in trending markets, the mechanism adapted to adjust one or more conditions related to buying power 108 may provide less restrictive conditions of buying power for the trader in a trending market and more restrictive conditions of buying power for the trader in a choppy market. The degree to which the market is choppy or trendy may be directly related to the extent to which the conditions of buying power are made more or less restrictive. Further, the mechanism adapted to adjust one or more conditions related to buying power 108 may be influenced by other market related factors such as volume, volatility, open interest, overbought/oversold indicators, opinion polls, confidence polls, as well as any other market or opinion based measures, or any other factors that may have bearing on what could be a particularly good or poor time to be making trades on either one side or both sides of the market. So for example, the mechanism adapted to adjust one or more conditions related to buying power 108 may restrict the conditions of a trader's buying power as volume in the market contracts, thereby ensuring the trader is only able to put on positions to the extent he will be able to liquidate them easily. Further the mechanism adapted to adjust one or more conditions related to buying power 108 may lessen or remove the restrictions on the conditions of a trader's buying power as volatility in the market contracts; thereby allowing the trader's overall account volatility to remain unchanged. In one example, the mechanism adapted to adjust one or more conditions related to buying power 108 may provide more restrictive conditions of buying power when open interest reduces before a futures rollover period. Market factors are typically most likely to effect bias, i.e., shifting a trader's risk profile more towards the long side or the short side at the expense of the other side. However, other factors can also influence bias. In one example, the mechanism adapted to adjust one or more conditions related to buying power 108 may shift bias by raising long position buying power and reducing short position buying power when a market is oversold. Also note that the strength of impact of each of the factors within the mechanism adapted to adjust one or more conditions related to buying power 108 may be consistent in magnitude or may be of varying magnitude, as will be understood based on the description provided herein.

The mechanism adapted to adjust one or more conditions related to buying power 108 may incorporate user-triggered events, such as, for example, the trader clocking out for breaks, whether the user-triggered events are adapted within a function or not. For example, it is understood that when a trader returns to the system 100 after being away from the market for a water break, lunch break, etc., the mechanism adapted to adjust one or more conditions related to buying power 108 may be adapted to restrict conditions of the trader's buying power to compensate for the market information missed by the absence and may ramp back up to slowly bring the trader back into the market. In such an example, the trader may trigger the mechanism adapted to adjust one or more conditions related to buying power 108 by providing a command indicating the trader has stepped away from the system 100. The trader may then trigger the mechanism adapted to adjust one or more conditions related to buying power 108 by providing a command indicating the trader has returned to the system 100. The impact on the conditions of buying power may be based on the duration the trader was away from the system 100. For example, if the break was short in duration, the conditions of buying power may be minimally restricted. However, if the break was longer in duration, the conditions of buying power may be more significantly restricted. As with any of the enumerated examples, the degree of the mechanism adapted to adjust one or more conditions related to buying power 108 influence on the buying power may be ramped up or down over an appropriate predetermined duration, or the one or more functions incorporated into or used by the mechanism adapted to adjust one or more conditions related to buying power 108 may already incorporate this ramping up or down. Similarly, this example may be extended to describe the effects of stepping away from the system 100 from the end of one trading day to the start of the next, the end of one week to the beginning of the next, or the end of a vacation and the beginning of working again.

It is understood that the user triggers discussed herein may be user triggers, such as inputting a command using a keyboard or a mouse, and may be independent factors or may be an element within a relatively complicated system. In other words, user triggers may be very simple to execute, such as a mouse-click or a hotkey-press, but these user triggers may set off a complex chain of events and/or processes or variable or value assignments. For example, whenever a user triggers a particular command, the value condition of buying power may automatically adjust over the following X hours, Y minutes and/or Z seconds. Accordingly, a trader that has just woken up at 7:00 am might trigger a command to begin adjusting the value condition of buying power. This user trigger may automatically initiate a set of processes to ramp up the user's buying power until 7:45 AM, with minor increases in buying power being made every 15 minutes. Alternatively, a triggered process may be merely one factor accounted for within a function associated with a mechanism adapted to adjust one or more conditions related to buying power 108.

User triggers may also cause conditions of buying power, such as the value condition, of buying power to automatically adjust due to events in the future. In one example, a user may trigger a command such that, if a tradable instrument that the trader is trading makes a new intraday high on high volume, that the trader's buying power should be reduced automatically on the short side and expanded automatically on the long side. This would reflect a trader's mindset that, if the tradable instrument makes a new high with high volume, the move in the tradable instrument will persist and the tradable instrument will continue higher. Additionally, another user trigger, or part of the same process as the currently discussed user trigger, may be provided such that, if the tradable instrument that the trader is trading makes a new intraday high on light volume instead of high volume, that buying power should be automatically reduced on the long side, and automatically expanded on the short side, indicating that the trader may profit the most by taking a short position.

As can be seen, multiple user triggers may be implemented at the same time. Further, multiple user triggers may be implemented across different and/or overlapping time frames and pending different time-based or event-based scenarios in the future. Further, these user triggers may cause a direct process to run which may automatically adjust conditions related to buying power at the current time. They may also cause the mechanism adapted to adjust one or more conditions related to buying power 108 to automatically adjust the conditions of buying power pending a prescribed time to pass or pending any type of event or process in the future. Further, user-triggered processes may also be assigned to have a given expiration. An example of expiration may be seen in the above described example such that if a new high has not been made within ten minutes, that the processes that were set forth pending times or events in the future will expire. There may be an unlimited number of user triggers available or assigned on a given system, and these user triggers may overlap based on the time they are entered, the time in which they persist, and the time or events they are pending as part of their processes.

In another example, a trader may self-trigger a factor, which, depending on the form of the one or more functions implemented, could have the mechanism adapted to adjust one or more conditions related to buying power 108 provide restrictive conditions of buying power when the trader lacks self-confidence. The conditions of buying power may remain in a restrictive position until the trader self-triggers the factor to revert back to its original condition. Similarly, the trader could also trigger an input when he is feeling extremely confident and wants to increase risk. Trader triggered inputs may be determinative, may be factored into one or more functions incorporated into or used by the mechanism adapted to adjust one or more conditions related to buying power 108 or may have any other influence or interaction with the mechanism adapted to adjust one or more conditions related to buying power 108 as will be understood by the context of the disclosure provided herein. Further, the described user trigger may be part of a complex system which automatically adjusts the conditions of buying power. As an example, if the trader lacked confidence and certain user triggers were executed, the mechanism adapted to adjust one or more conditions related to buying power 108 might automatically reduce the value condition of the otherwise calculated buying power to be one half of what it would have been without this user trigger.

As described above, each of the examples of the functions associated with the mechanism adapted to adjust one or more conditions related to buying power 108 may be an independent function or may be a subset of a larger function. Accordingly, any and all of the given examples may be adapted in any combination within the system 100. For a simple example, on a given Monday morning at 8:00 AM the system 100 may incorporate output from a combination of various functions and may calculate a trader's buying power as follows. Because the market has been choppy for the last few weeks and historically the trader performs better in a trending market, a factor of 0.7 is applied to buying power calculation for the duration of the day. Because the trader historically performs worse Monday mornings than later in the day and/or week, a factor of 0.2 is applied to the buying power calculation starting at 8:00 AM, which ramps up to a factor of 1.0 at 10:30 AM.

Based on the example described above, in an embodiment in which calculated variable buying power is expressed as buying power boundaries within the trader's prescribed buying power limits, at 8:00 AM the calculated variable buying power is equal to the trader's assigned buying power limits multiplied by 0.14 (i.e., 0.7 multiplied by 0.2). At 10:30 AM the calculated buying power boundaries are equal to the trader's assigned buying power limits multiplied by 0.7 (0.7 multiplied by 1.0). Further, the buying power boundaries may be influenced based on the dynamic performance based measures of the trader's closed positions. Accordingly, if by 10:30 AM the trader has performed well on the trades made so far that morning, the buying power boundaries might reflect that using a factor of 1.3, making the buying power boundaries equal to the trader's assigned buying power limits multiplied by 0.91 (i.e., 0.7 multiplied by 1.3). Conversely, if by 10:30 AM the trader has performed poorly on the trades made so far that morning, the buying power boundaries might reflect that using a factor of 0.7, making the buying power boundaries equal to the trader's assigned buying power limits multiplied by 0.49 (i.e., 0.7 multiplied by 0.7).

In yet another example of the system 100 both a risk manager and a trader may each be independently using the system 100 via separate user interfaces 104. The risk manager's duty is to manage the department's overall risk profile. The trader's duty is to execute profitable trades within the system 100. Accordingly, a first mechanism adapted to adjust one or more conditions related to buying power 108 may be managed and operated by the risk manager via a first user interface 104. A second mechanism adapted to adjust one or more conditions related to buying power 108 (or another portion or extension of the first mechanism adapted to adjust one or more conditions related to buying power 108) and the order entry system 100 may be managed and operated by the trader via a second interface 104. It is understood that the first and second user interfaces 104 may be provided in separate independent locations, possibly interacting via a network. Additionally, the components and processes related to the first mechanism adapted to adjust one or more conditions related to buying power 108 may be resident in or associated with the risk manager's user interface 104, while the components and processes related to the second mechanism adapted to adjust one or more conditions related to buying power 108 and order entry mechanism 110 may be resident in or associated with the trader's user interface 104.

For example, in a system 100 where the mechanism adapted to adjust one or more conditions related to buying power 108 is managed by a risk manger and the order entry mechanism 110 is managed by one or more traders, the risk manager's main concern may be to make sure that the buying power permitted for each trader is inversely correlated to overall market volatility. Accordingly, the first mechanism adapted to adjust one or more conditions related to buying power 108 may be adapted by the manager to include market volatility as a factor in a related function, whether determinative or merely one factor of a more complex function. Additionally, the trader manages a second mechanism adapted to adjust one or more conditions related to buying power 108 that interacts with the first mechanism adapted to adjust one or more conditions related to buying power 108. It is understood that the risk manager's mechanism adapted to adjust one or more conditions related to buying power 108 may be limiting on the trader's mechanism adapted to adjust one or more conditions related to buying power 108. In other words, the trader's mechanism adapted to adjust one or more conditions related to buying power 108 may not be able to increase the trader's buying power more than allowed by the output of the risk manager's mechanism adapted to adjust one or more conditions related to buying power 108.

As an example of the trader not being able to increase the trader's buying power more than allowed by the output of the risk manager's mechanism adapted to adjust one or more conditions related to buying power 108, the trader may be coming off of a few days of losses and may wish to get back on the right track without risking much money. The trader may believe the best way to ease back into the market is by starting slowly with small positions and ramping up position size as the trader builds confidence and profits. Towards this goal, the trader may build and apply a function based on personal intraday performance, whether determinative or merely one component of a more complex function, incorporated into or used by the trader's mechanism adapted to adjust one or more conditions related to buying power 108. In one example of how this function may be applied, the trader's buying power may be low at the beginning of the day, reducing further if the trader loses money, and increasing if the trader makes money. If the trader's performance is profitable on the first day, then the next day's initial buying power may be higher than the previous day's buying power. Conversely, if the trader's performance is not profitable on the first day, then the next day's initial buying power may be lower than the previous day's buying power. In other examples, conditions of buying power other than the value condition may be adjusted using the function described in this example. In all cases, the trader's buying power will be limited by the buying power limits set by the risk manager, such as, for example, the output of the mechanism adapted to adjust one or more conditions related to buying power 108 managed by the risk manager. The provided example of the risk manager's mechanism adapted to adjust one or more conditions related to buying power 108 interacting with the trader's mechanism adapted to adjust one or more conditions related to buying power 108 is just one example of how multiple mechanisms adapted to adjust one or more conditions related to buying power 108 may interact.

Even though system 100 is described as being capable of increasing and/or decreasing user risk and/or buying power limits, it is contemplated that the main expected use of system 100 will be for decreasing user risk and decreasing buying power limits. Further, even though system 100 allows a certain amount of buying power to be used, this does not serve as a suggestion that users consistently make use of the maximum amount of buying power that is available. Decisions of whether to take risk or place trades should still be based on all of the factors that typically are used to form risk, trade, and allocation decisions in the markets. Some of these factors have to do with general market conditions, the amount of profit versus loss potential, the probabilities of such outcomes, user experience in the markets, as well as many other factors.

Turning now to FIG. 2, a method 200 is provided for controlling risk in a user controlled order entry system 100, such as the system described with respect to FIG. 1. It is understood that the method 200 shown in FIG. 2 is merely one example of a method 200 used to implement a system 100 such as the one shown in FIG. 1.

As shown in FIG. 2, the method 200 is a method of controlling risk in a user controlled order entry system 100. As shown, the method 200 includes a first step 210 of providing one or more conditions related to buying power. As further shown in FIG. 2, the method 200 includes a second step 220 of automatically adjusting the one or more conditions related to buying power. Further shown is an optional third step 230 of automatically exiting currently held positions outside of the presently applied buying power limits.

Turning now to FIG. 3, a method 300 is provided for adapting risk in a user controlled buying power limit constrained order entry system 100, such as the system described with respect to FIG. 1. It is understood that the method 300 shown in FIG. 3 is merely one example of a method 300 used to implement a system 100 such as the one shown in FIG. 1.

As shown in FIG. 3, the method 300 is a method of adapting risk in a user controlled buying power limit constrained order entry system 100. As shown, the method 300 includes a first step 310 of changing the value of the buying power limits. As further shown in FIG. 3, the method 300 includes a second step 320 of automatically adjusting a condition related to one or more currently open orders or currently held positions in response to the changed value of the buying power limits.

It is further understood that the features provided by a mechanism adapted to adjust one or more conditions related to buying power 108 may be utilized in conjunction with a position adjusting mechanism 112 to adjust positions or cancel or adjust open orders that fall outside of the calculated variable buying power limits. In some examples, the position adjusting mechanism 112 may automatically liquidate the open positions or cancel or adjust open orders in response to calculated variable buying power limits. In other examples, the position adjusting mechanism 112 may liquidate the open positions or cancel or adjust open orders only in response to user input, such as, for example, a user accepting a suggestion to close the open positions or cancel or adjust open orders in excess of the presently calculated variable buying power limits. In both examples, the position adjusting mechanism 112 provides automated decision making (whether determinative, optional, suggestive, etc.) related to the adjustment of open positions or open orders in a user-directed, risk managed, order entry system 100.

The term order entry system 100 as used herein is a system through which users may enter orders, as well as perform other functions associated with order entry and order management in general, such as canceling orders, changing orders, making changes to positions held in the account such as liquidating positions, etc. Given that most of the contents herein are related to order entry and conditions of buying power limits which mostly affect order entry, we will continue to refer to the system 100 as an order entry system 100 for clarity. A user-directed order entry system 100 requires that one or more of the order management functions are triggered by user action.

The position adjusting mechanism 112 may be adapted to automatically adjust a condition related to one or more currently open orders or currently held positions in response to a change in the buying power limit. For example, position adjusting mechanism 112 may perform a number of functions in response to changed buying power limits, including, for example: automatically liquidating presently held positions that exceed the changed buying power limits; automatically canceling presently open orders that if added to the existing position, would be over the buying power limits; and automatically adjust the size of presently open orders that exceed the changed buying power limits to not exceed the changed buying power limits.

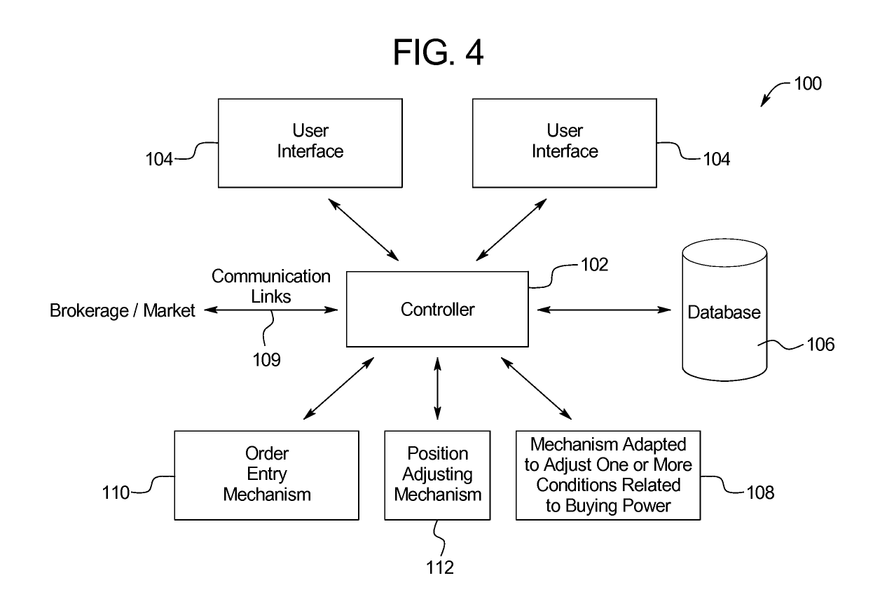

FIG. 4 illustrates an example of an embodiment of a risk managed order entry system 100 in which a position adjusting mechanism 112 is adapted to interact with the mechanism adapted to adjust one or more conditions related to buying power 108 and the order entry mechanism 110 via the controller 102. In one example of a system 100 incorporating the position adjusting mechanism 112, the position adjusting mechanism 112 responds automatically to automatically liquidate presently held positions in response to adjustments of one or more conditions related to buying power caused by the mechanism adapted to adjust one or more conditions related to buying power 108.

While illustrated as three distinct elements for ease and clarity of description herein, it is understood that the mechanism adapted to adjust one or more conditions related to buying power 108, the order entry mechanism 110 and the position adjusting mechanism 112 may be provided as independent elements, interactive elements, a single unified element, or any combination thereof.

For example, in a system in which a trader is limited by the variable buying power calculated by the mechanism adapted to adjust one or more conditions related to buying power 108, a trader may have opened positions presently valued at $12,000 under the condition in which the mechanism adapted to adjust one or more conditions related to buying power 108 had provided calculated buying power limits of $15,000. Then, while those positions remain open, the mechanism adapted to adjust one or more conditions related to buying power 108 may recalculate buying power limits of $10,000 via the use of a function which includes changed factors (e.g., the overall market becomes “overbought”, a technical term implying there is more risk in holding long positions). As a result of the changed buying power limits, the position adjusting mechanism 112 may automatically initiate the liquidation of the positions in excess of the presently calculated buying power limits.

In another example, in response to conditions in which a trader's open positions exceed the presently calculated variable buying power, the position adjusting mechanism 112 may prompt a user (e.g., trader, risk manager, etc.) with the option to close the positions in excess of the presently calculated variable buying power. For example, the position adjusting mechanism 112 may prompt a user to authorize the liquidation of the positions in excess of the presently calculated variable buying power. Note that the liquidation may be represented by sell orders (if a long position were held) or by buy or buy to cover orders (if a short position were held).

It should also be noted that the methodology for which the automatic closing of open positions may occur may be with any order type. It is contemplated that most users would use market orders for this purpose. However, liquidating a position might also be set up to cover discretely on the best bid or offer (BBO) using an iceberg order. Of course, any other order types may be used as well.

In addition, it is understood that in embodiments that incorporate a position adjusting mechanism 112, the mechanism adapted to adjust one or more conditions related to buying power 108 may provide distinct or independent calculations for buying power, buying power limits, buying power boundaries, etc. as they relate to opening new positions as compared to closing existing positions. For example, the mechanism adapted to adjust one or more conditions related to buying power 108 may calculate variable buying power such that the trader may open new positions up to $20,000 and independently, or interrelatedly, calculate variable buying power such that existing open positions exceeding $25,000 should be closed, automatically or in response to user action.

The mechanism adapted to adjust one or more conditions related to buying power 108 may be dependent upon or related to market related factors, such as, for example, the open interest of a given futures contract (a type of tradable instrument) and an overbought/oversold market indicator for that futures contract. Additionally, the mechanism adapted to adjust one or more conditions related to buying power 108 may be dependent upon or related to performance related factors, such as, for example, the user's trading profile. Analyzing and modeling the appropriate factors at the appropriate granularity are important to optimal performance of the mechanism adapted to adjust one or more conditions related to buying power 108. For example, consider these two scenarios. In the first scenario, a trader has a flat P & L ($0) on the day, but was able to maintain a good trading profile all day, i.e., the types of behavior that was executed during the day are usually associated with profitable trading days. The trader may have not made money because the market went against the trader's most frequent choice of market direction. In the second scenario, a trader also has a flat P & L ($0) on the day, but for different reasons. While the trader picked market direction correctly, the trader had poor timing in executing trades all day long, thereby resulting in a poor trading profile. Although the two scenarios and sets of factors led to the same flat P & L, there may be advantages to analyzing and modeling the data at a more granular level.

In the example above in which a trader was usually picking the wrong side of the market, but usually had great timing and a positive trading profile, there may be an advantage to increasing the trader's risk on the “right” side of the market by 60% and automatically decrease the trader's risk on the “wrong” side of the market by 40%, representing an overall increased in risk of 10%. In the opposite example, in which a trader was usually picking the right side of the market, but had terrible timing, there may be an advantage to decreasing the overall risk by 40%, again skewing it towards the “right” side of the market. As shown, when the factors are analyzed and modeled at the appropriate level of detail, the system 100 may be more appropriately tailored to positively influence trader performance.

In the two examples provided above, it may be beneficial to trader performance to notify the user of the adjustments to the calculated buying power and suggested responsive actions to be taken. For example, in the scenario in which the trader is consistently picking the wrong side of the market it may be beneficial for the system 100 to provide the user with a message (e.g., a pop-up message or similar audio/visual alert) encouraging the user to reconsider the side of the market from which to trade. Similarly, in the scenario in which the trader is consistently picking the right side of the market, it may be beneficial for the system 100 to provide the user with a message encouraging the user to hold the positions on the “right” side of the market, but reduce the trading frequency for the remainder of the day.

It is contemplated that there may be a plurality of buying power limits associated with a given user account. For example, two sets of buying power limits may be provided for the long side of the market and two sets of buying power limits may be provided for the short side of the market. One set for each side may be considered “hard buying power limits” and one set for each side may be considered “soft buying power limits.” The different limits may be referenced with different names, for example, the soft buying power limits may be referred to as buying power boundaries rather than limits. Of course this is merely one example, but the hard buying power limits may be automatically adjusted on a daily basis, while the soft buying power limits may be automatically adjusted on an intraday basis, thereby being more flexible. In this example, each of the buying power limits (or each of the sets of buying power limits) may be independently calculable and adjustable. In addition, the upper risk limit for the (soft) buying power boundaries may be capped at the level of the (hard) buying power limits. Of course, it is expected to be understood that the reference to descriptions such as hard and soft, and such as limits and boundaries, are intended to increase readability and understanding and are merely examples of manners in which the systems and methods may be applied.

The automatic adjustment of one or more conditions related to buying power described herein may impact and/or adjust functionality within the system 100. In one example, when the market is overbought the user may be automatically prohibited from executing market orders on the long side completely, even though the user may still be permitted to place limit orders on the long side. In another example, the user may be automatically prohibited from executing market orders on both sides of the market, due to a negative trading profile, or due to a low liquidity environment, i.e., when the market is so thin with volume that market orders would surely cause unnecessary losses. It is understood that any of the system 100 functionality may be automatically adjusted in response to adapting or evolving factors. Simple examples include the automatic adjustment and/or adaptation of user permissions for all order types, cancellation of existing orders, changes to existing orders, etc.

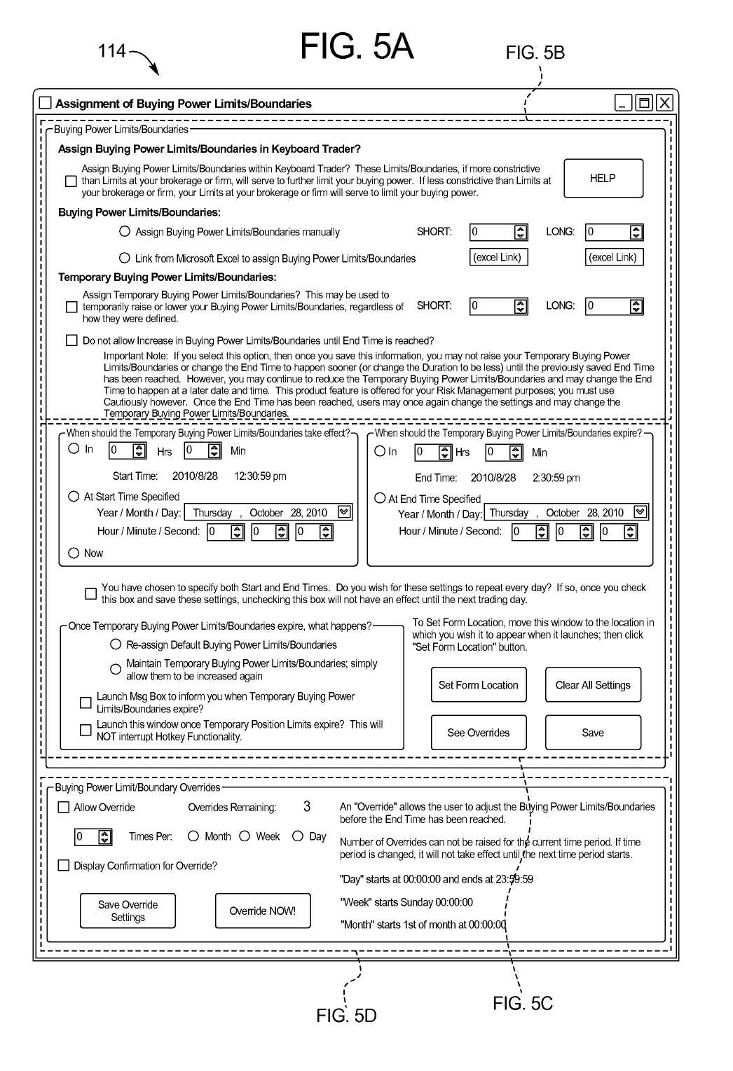

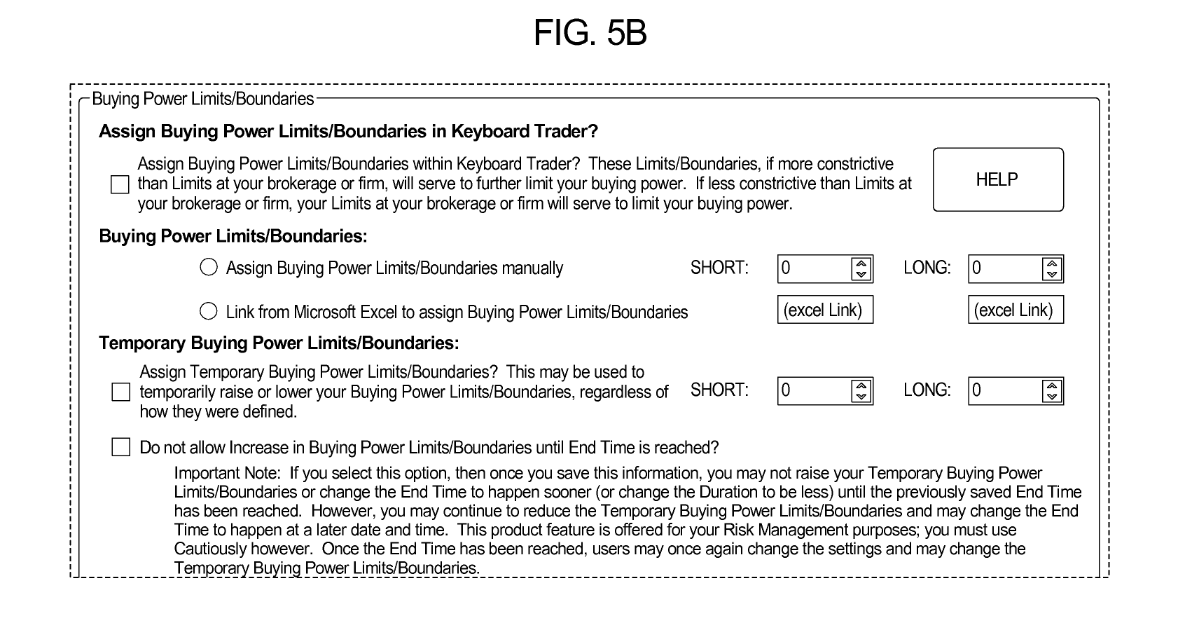

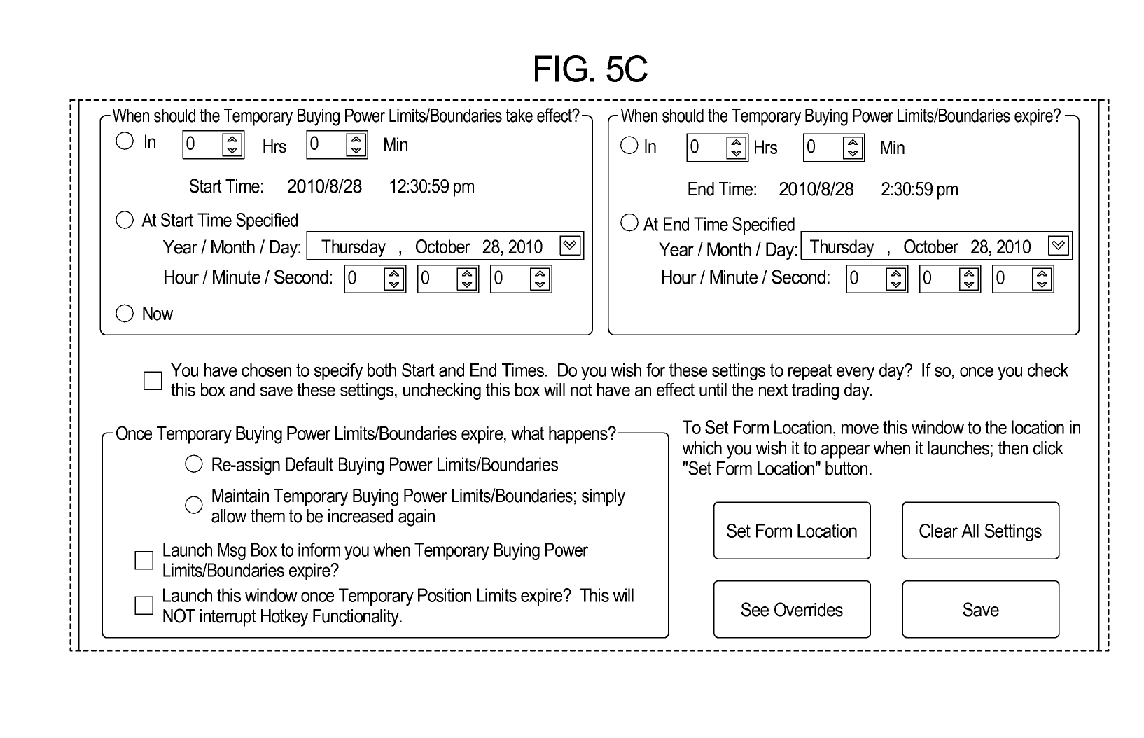

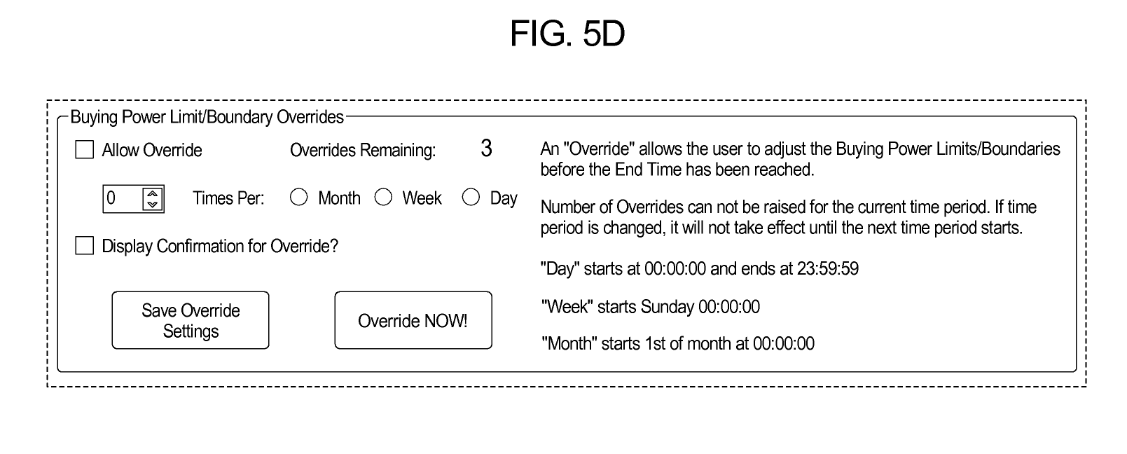

FIG. 5A illustrates a screen shot for an example of a buying power limits assignment interface 114, which may be adapted for use within the mechanism adapted to adjust one or more conditions related to buying power 108. FIGS. 5B-5D show portions of the buying power limits assignment interface 114 in greater detail. FIGS. 5A-5D will be referred to herein collectively as FIG. 5. The buying power limits assignment interface 114 shown in FIG. 5 includes a plurality of inputs and selections related to buying power limits and through which the user may personalize the implementation of the system 100.

As shown in the example provided in FIG. 5, a buying power limits assignment interface 114 may include functionality for: (1) selecting whether the system 100 will be used to provide buying power limits; (2) selecting whether the buying power limits are provided manually within the power limits assignment interface 114 or with reference to an external source (in this example, the external source may be a related spreadsheet reference); (3) selecting whether to assign temporary buying power limits, the time to start and end the temporary limits and whether, once assigned, the temporary limits may be changed before the specified end time; (4) selecting whether the settings repeat daily; (5) selecting what happens when the temporary limits expire; and (6) selecting whether user overrides of buying power limits are allowed and setting rules related to overrides (limiting number of overrides, limiting frequency of overrides, etc.) FIG. 5 is merely one contemplated example in which a user of the described system 100 may automatically adjust conditions related to buying power.

In the example provided, a user may configure the one or more conditions related to buying power to automatically adjust. For example, when a user configures the system 100 with respect to the time temporary buying power limits take effect, or when the temporary buying power limits expire (both options shown in FIG. 5), the user is able to specify a time in the future at which conditions related to buying power will automatically adjust.

In another example provided, FIG. 5 illustrates how a user may set up a temporary buying power limit between, for example, 3:00 PM as a start time and 7:00 AM as an end time. The user may further select that the temporary buying power limits set for that time period will repeat daily. Accordingly, the user's default buying power limits may apply in the period from 7:00 AM to 3:00 PM daily, while the more restrictive temporary buying power limits will apply between 3:00 PM and 7:00 AM daily. Through this mechanism, the user may automatically adjust the value of buying power to higher levels while the market is active during the daytime, and automatically adjust the value of their buying power to lower levels while the market is less active during the evening and early morning. Even though this example demonstrates the assignment of the temporary limits to be more restrictive and the default limits to be more liberal, it is understood that the temporary limits may be more liberal.

It is understood that while the example above is simple, a user may benefit and the system 100 may be adapted such that a plurality of daily repeating or non-repeating time frames may be configured and that the automatic adjustment of buying power limits may occur a great number of times per day.

In the example shown in FIG. 5, there are two options provided for how to resolve the value of the user's buying power limits when the temporary buying power limits expire. In one example, the user may select that the temporary buying power limits are to be automatically assigned a new value. Alternatively, the user may select that the temporary buying power limits are to maintain their prior value, but allow them to be adjusted. In both cases, a condition related to buying power is automatically adjusted when the temporary buying power limits expire. In the first instance, the automatic assignment of a new buying power limit value is an automatic adjustment of a condition related to buying power. In this case, it is an automatic adjustment of the value of the buying power limits. Further, it may also be the simultaneous automatic adjustment of the condition of whether the buying power limits may be adjusted. In this example, it would make sense that the condition for whether the buying power limits may be adjusted after the expiration of the temporary buying power limits may change from false to true. In the second instance, the allowance for the buying power limits to be adjusted after the expiration of the temporary buying power limits is also an automatic adjustment of a condition related to buying power. In this case, the value condition of buying power limits is not automatically adjusted; however, the condition for whether the buying power limits may be adjusted, specifically in this case whether the buying power limits may be increased, may change from false to true.

As shown, the automatic adjustment of a condition related to buying power may be the value of the buying power limits or it may be another condition, such as, for example, whether the value is able to be adjusted at that time. It is understood that there are numerous conditions related to buying power that may be automatically adjusted using the system 100 provided herein, including, but not limited to, whether the buying power limits are locked or unlocked, whether buying power limits may be raised or not, whether the buying power limits may be lowered or not, whether the maximum or minimum value permitted for the buying power limits is locked or unlocked, whether the maximum or minimum value permitted for the buying power limits may be raised or not, whether the maximum or minimum value permitted for the buying power limits may be lowered or not, whether the buying power limits data is visible on a given form or screen, etc. Further the automatic adjustment of a condition related to buying power may be the automatic adjustment of a derivative of a condition related to buying power, such as, for example, the duration or persistence of other conditions.

The override commands illustrated in FIG. 5 are an example of additional user functionality that may be provided for users to maintain greater control over the buying power limits. It is understood that in certain embodiments, the manual overrides may be adapted to override the user imposed buying power limits at the trader level, but may not be used to override the buying power limits assigned at the brokerage or other risk manager level. The override functionality is useful when the buying power limits may be imposed from a plurality of sources, particularly in instances in which one or more imposed buying power limits are self-imposed, restrictive limits below the user's hard limits provided by the brokerage or other risk manager.

While FIG. 5 illustrates an example in which the user is providing the temporary buying power limits directly, it is understood that the examples provided herein are applicable to instances in which the buying power limits are generated, calculated, assigned or otherwise provided either indirectly by the user or from another source.

Because the system 100 provided herein allows the buying power limits to be assigned at the trader-user level at a value more restrictive than the limits assigned by the brokerage or risk manager, these “local” buying power limits may be referred to herein as buying power boundaries to denote the more flexible nature of the more restrictive trader-user level limits. Whether referred to herein as adjustable buying power limits or adjustable buying power boundaries, the principles and examples provided herein may apply as will be understood by one or ordinary skill in the art.

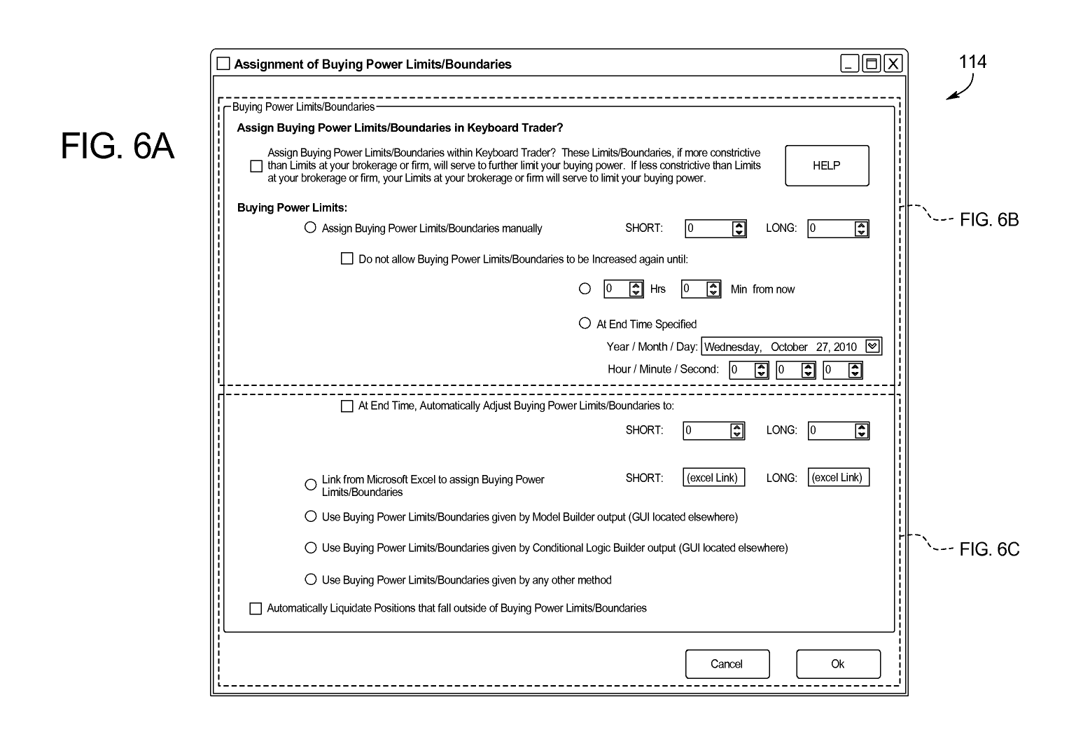

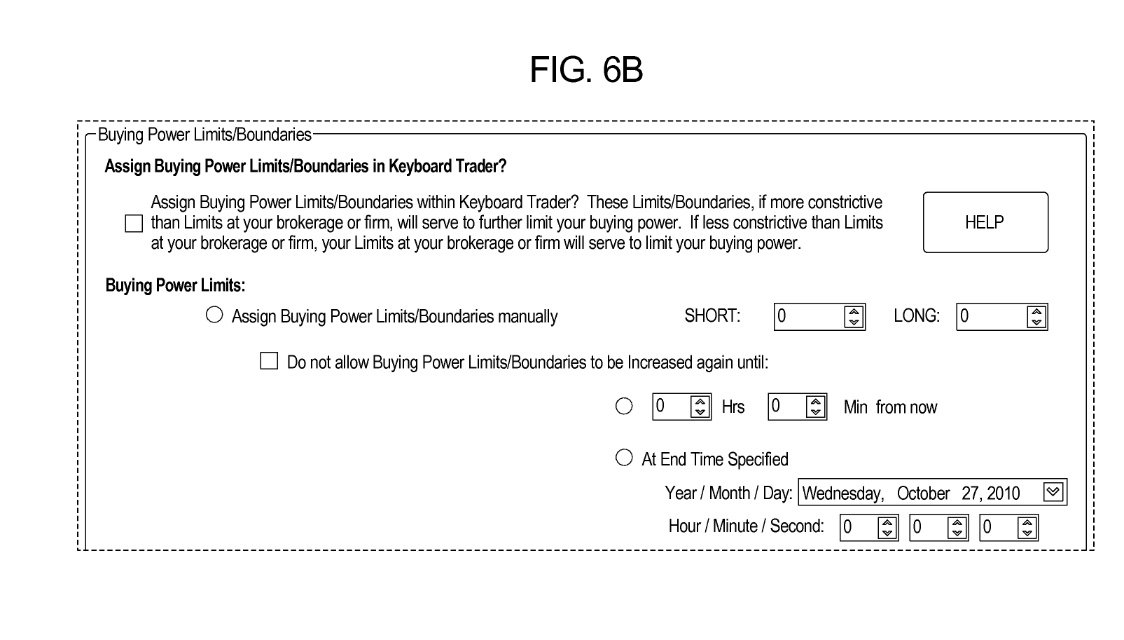

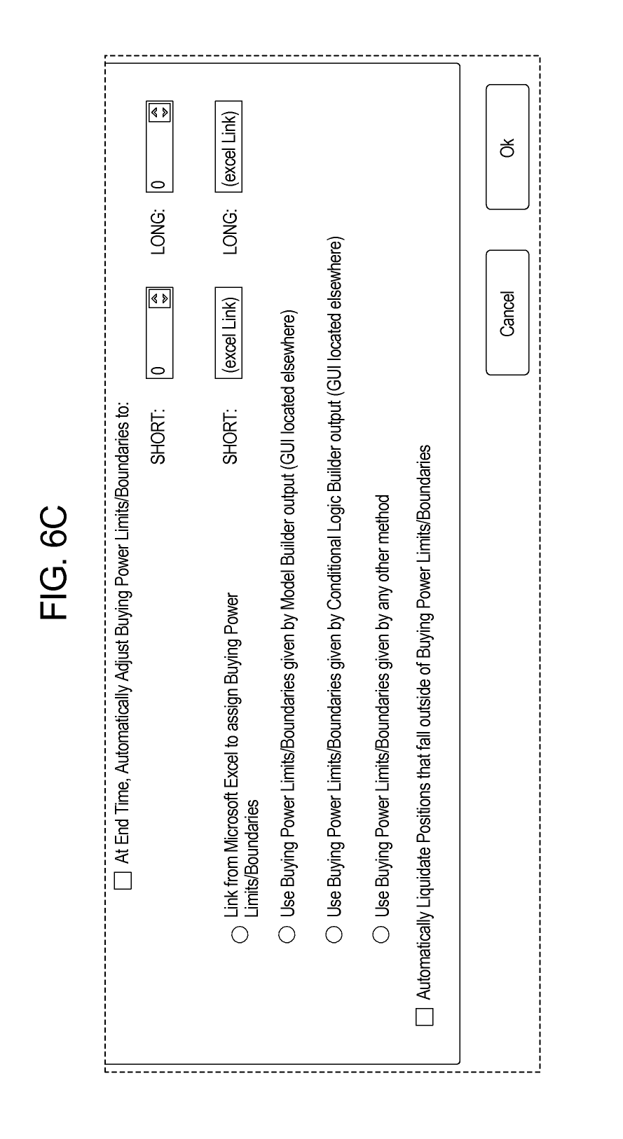

Turning now to FIG. 6A another example of a buying power limits assignment interface 114 is shown. FIGS. 6B-6C show portions of the buying power limits assignment interface 114 shown in FIG. 6A in greater detail. FIGS. 6A-6C will be referred to herein collectively as FIG. 6. The buying power limits assignment interface 114 shown in FIG. 6 includes a plurality of inputs and selections related to buying power limits and through which the user may personalize the implementation of the system 100.

As shown in the example provided in FIG. 6, a buying power limits assignment interface 114 may include functionality for: (1) selecting whether the system 100 will impose buying power limits; (2) manual assignment of a plurality of buying power limit values (including long and short limits); (3) whether the manually assigned buying power limits are temporarily locked and, if so, for how long; (4) selecting data sources for providing values of buying power limits or other conditions related to buying power limits; and (5) selecting whether to automatically liquidate positions that fall outside of the buying power limits. Even though for simplicity it is not shown in greater detail, if there are more buying power limits assignable than is shown in this example, there may be further settings assignable as well, such as the times at which each buying power limit in a longer list may be implemented, or such as the times at which the value condition or maximum value condition of other buying power limits may be unlocked or adjustable.

The examples of data sources for providing values of buying power limits, or adjusting other conditions related to buying power limits, shown in FIG. 6 include referencing data from an associated spreadsheet application. For example, as the value of associated data in a spreadsheet application adapted to calculate adjustable buying power limits changes, the system 100 may impose the calculated adjustable buying power limits as the user's buying power limits. In another example, a condition related to buying power in the system 100 may be controlled by the value of associated spreadsheet data. For example, the associated data in the spreadsheet may fluctuate between the values of zero and one such that when the value is zero the associated condition related to buying power is locked and when the value is one the associated condition related to buying power is unlocked.

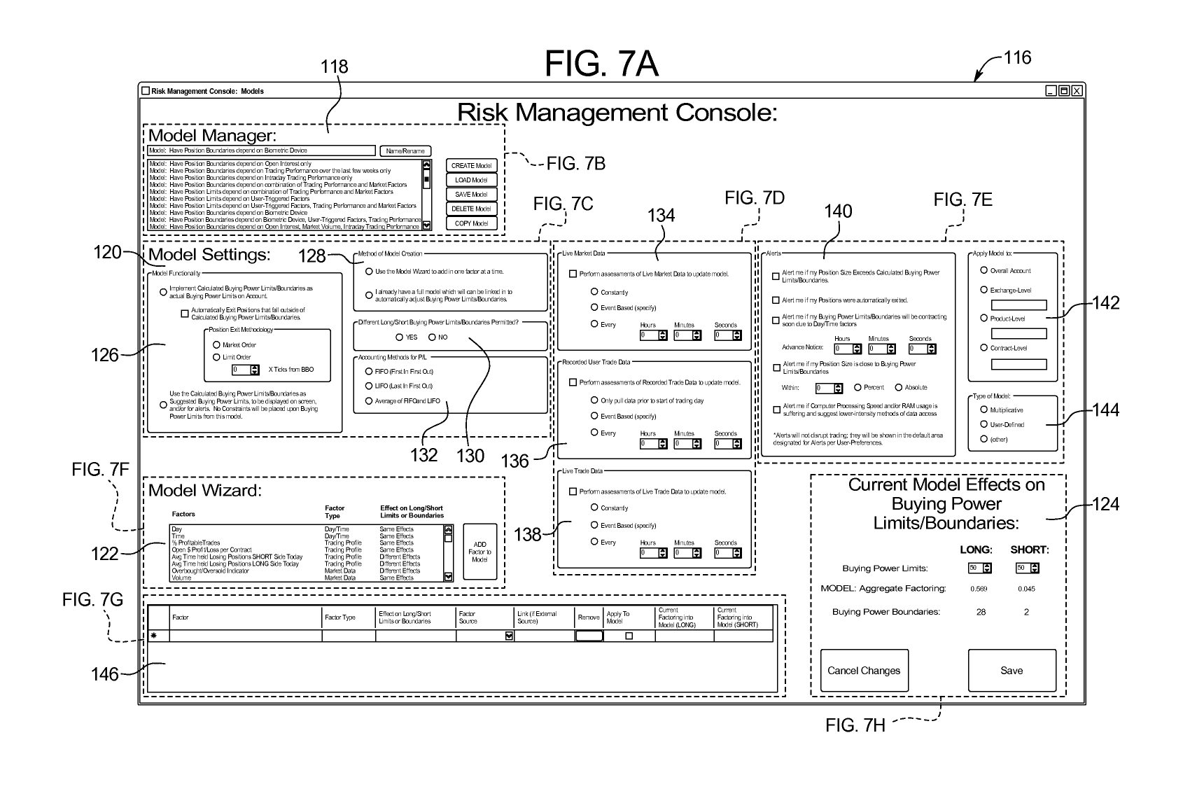

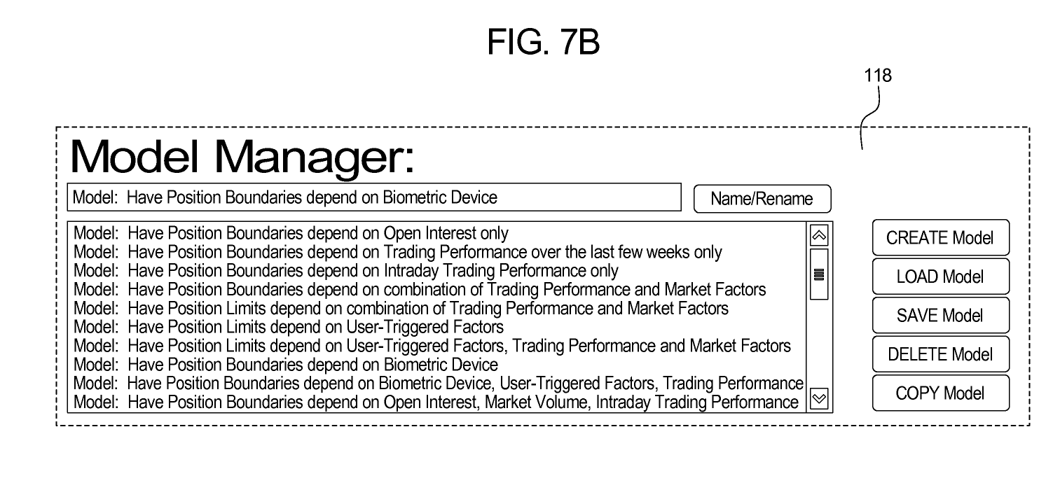

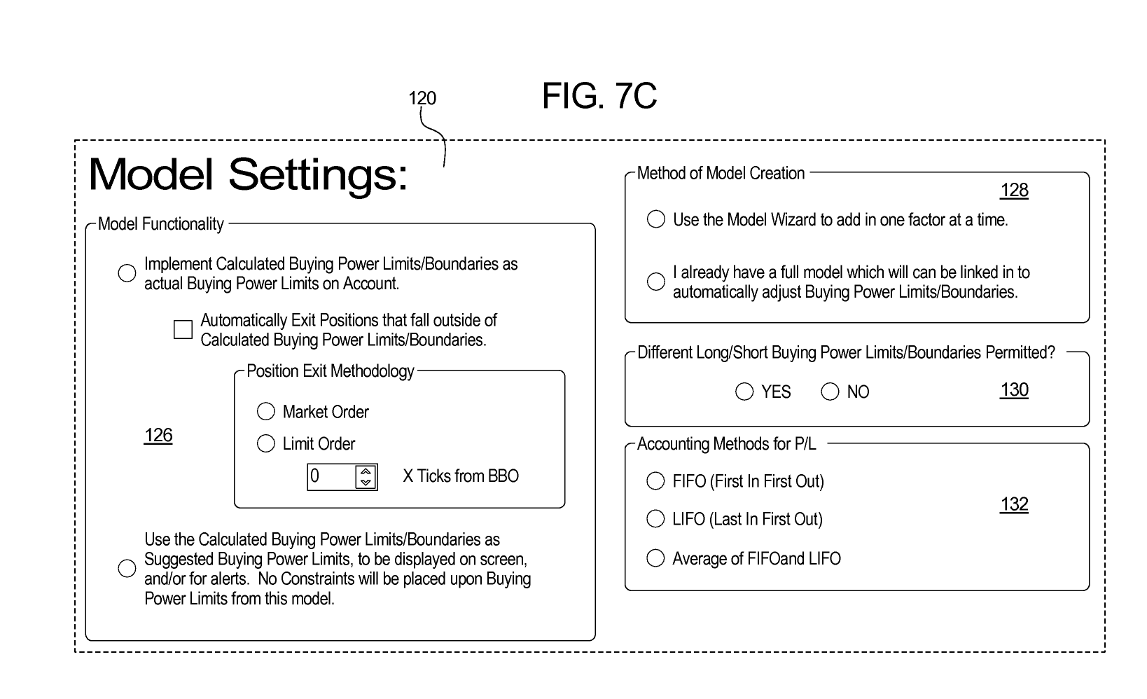

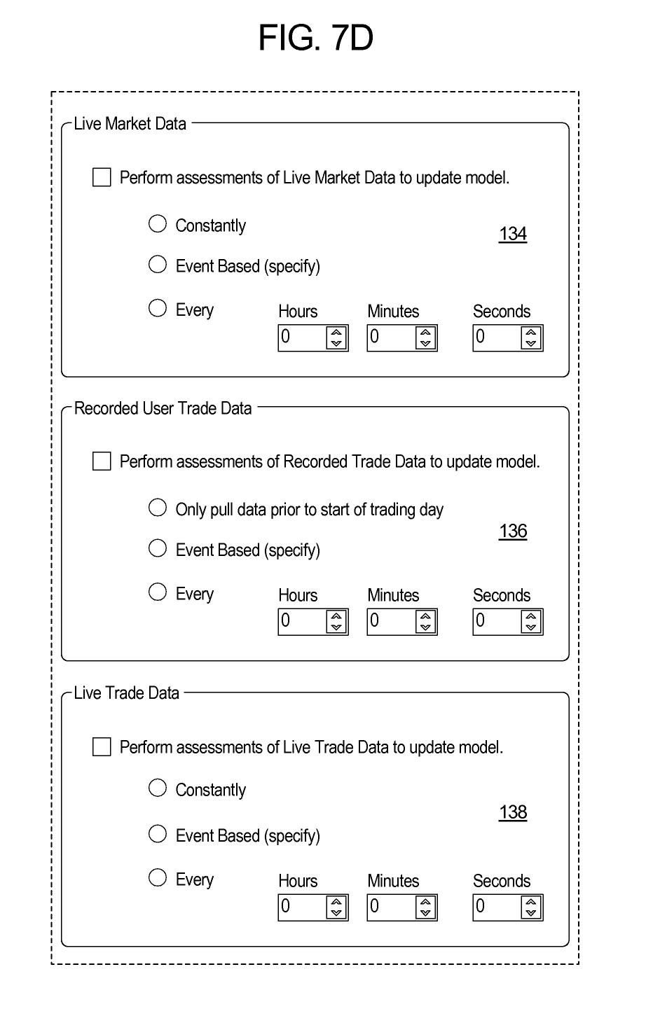

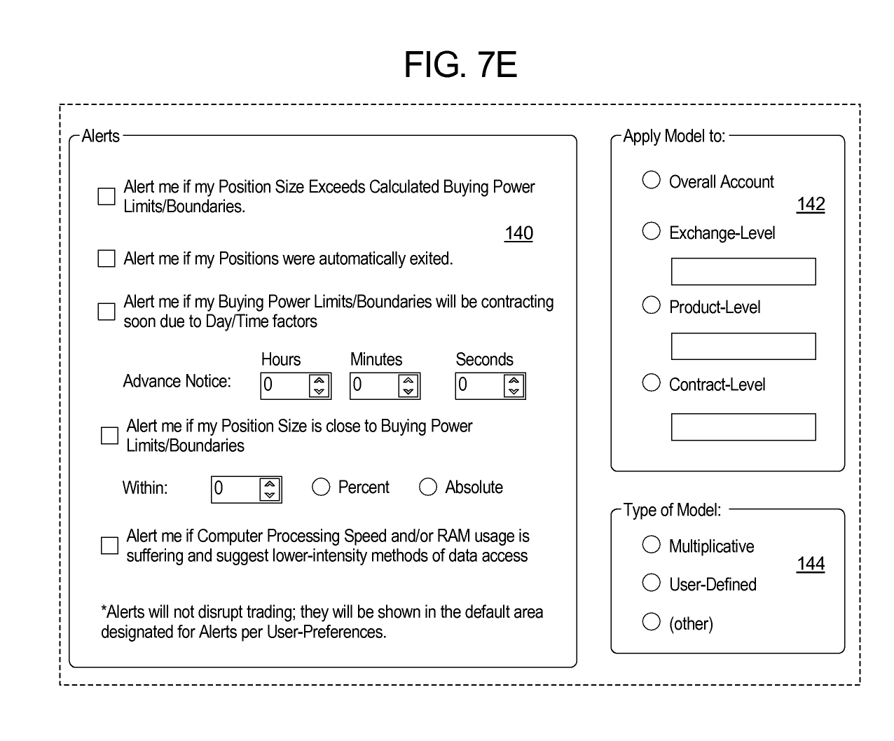

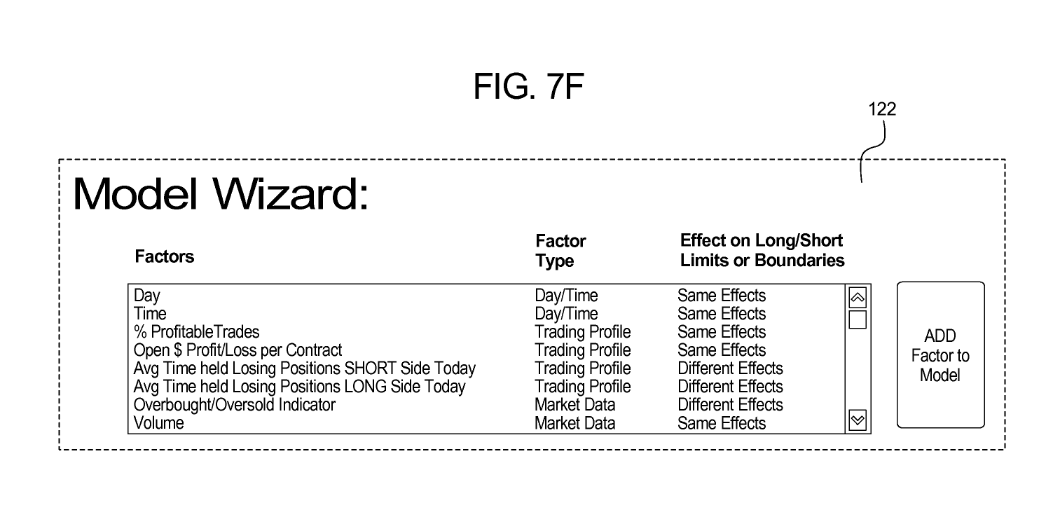

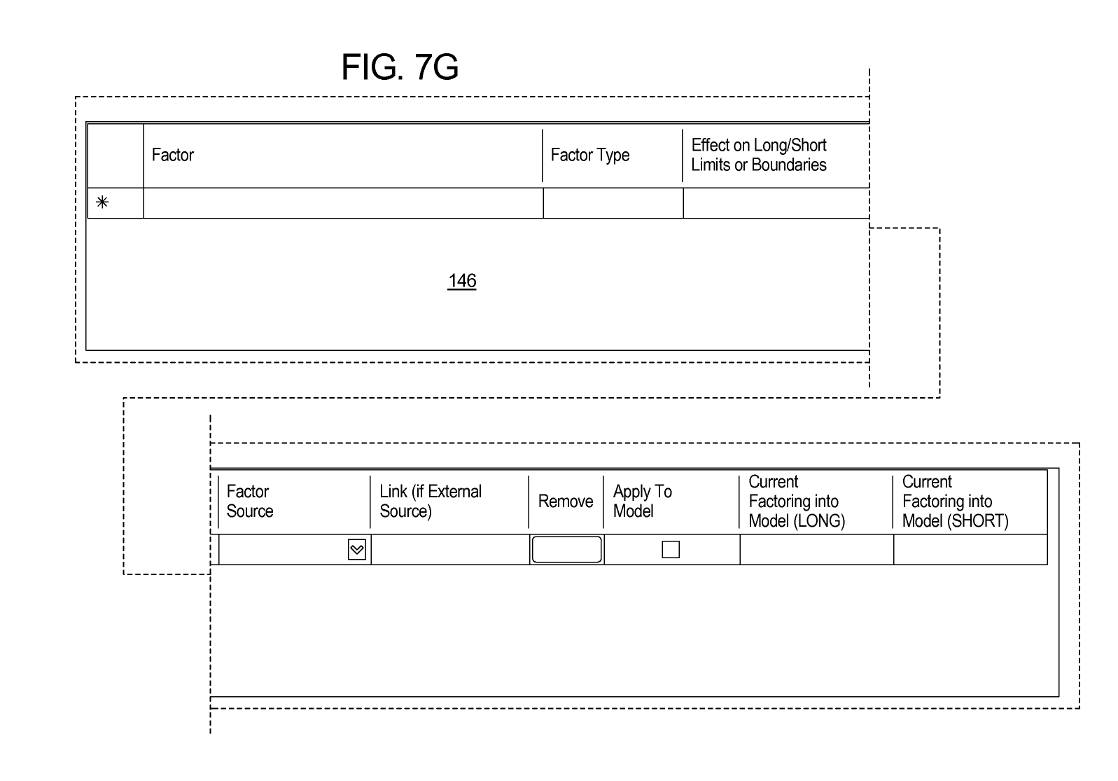

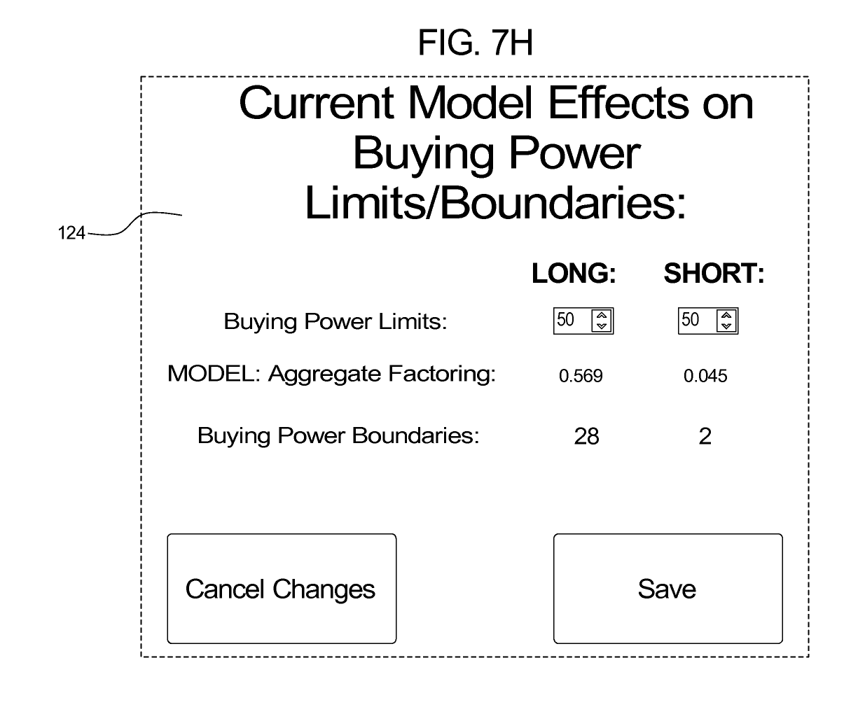

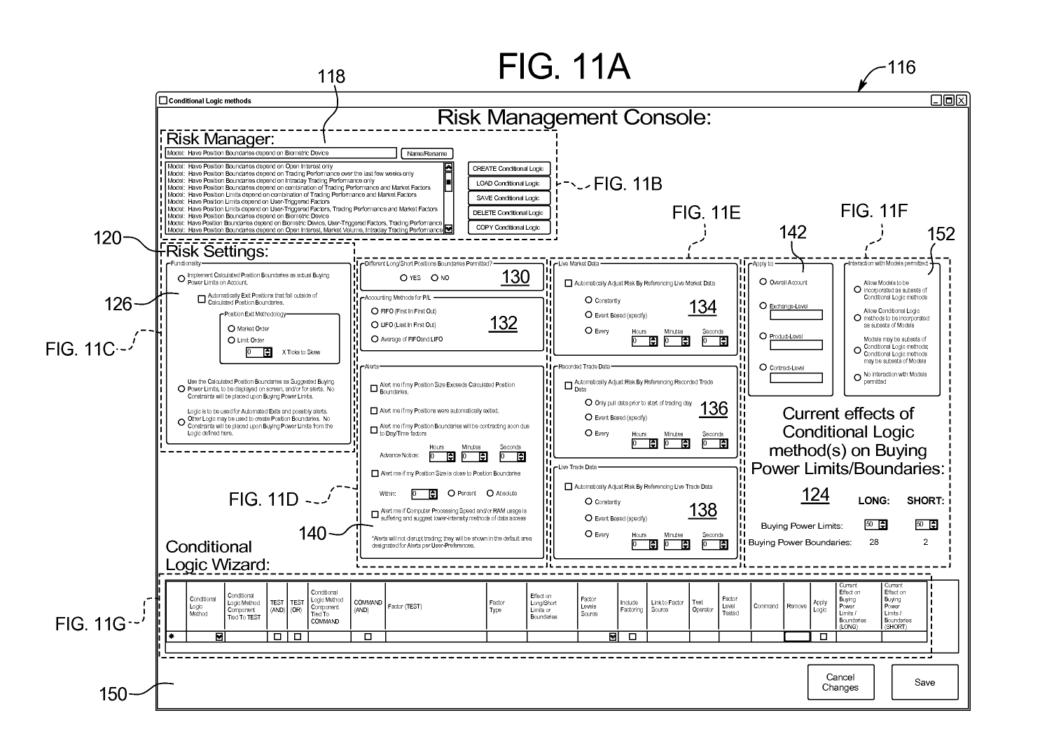

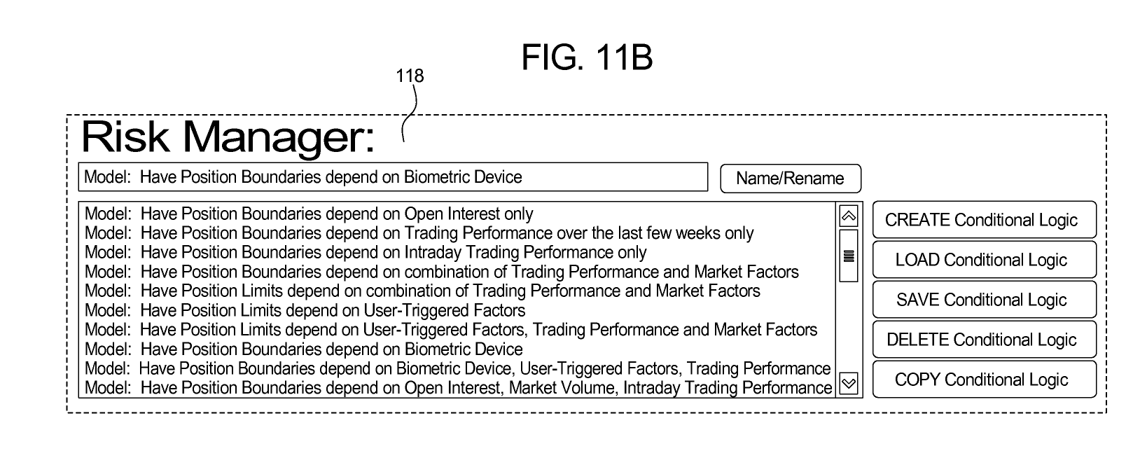

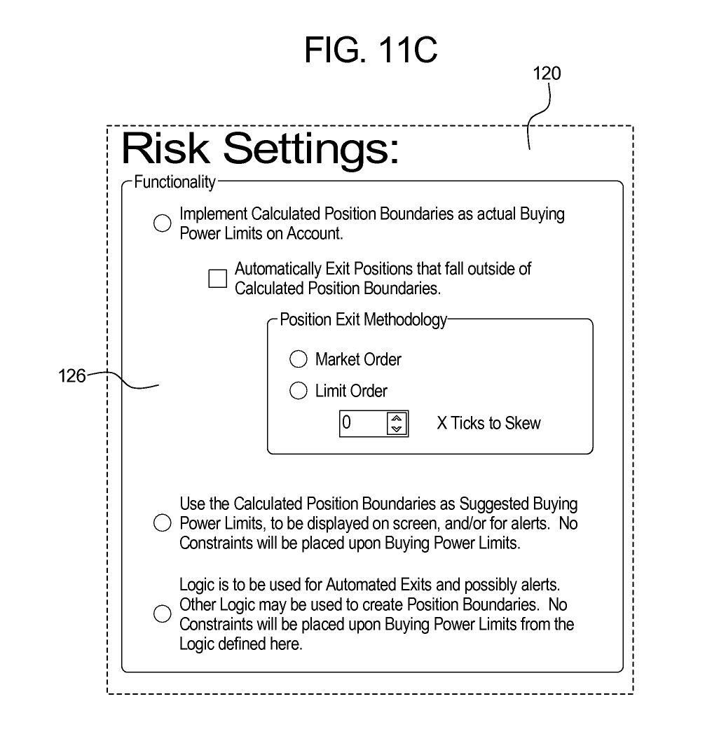

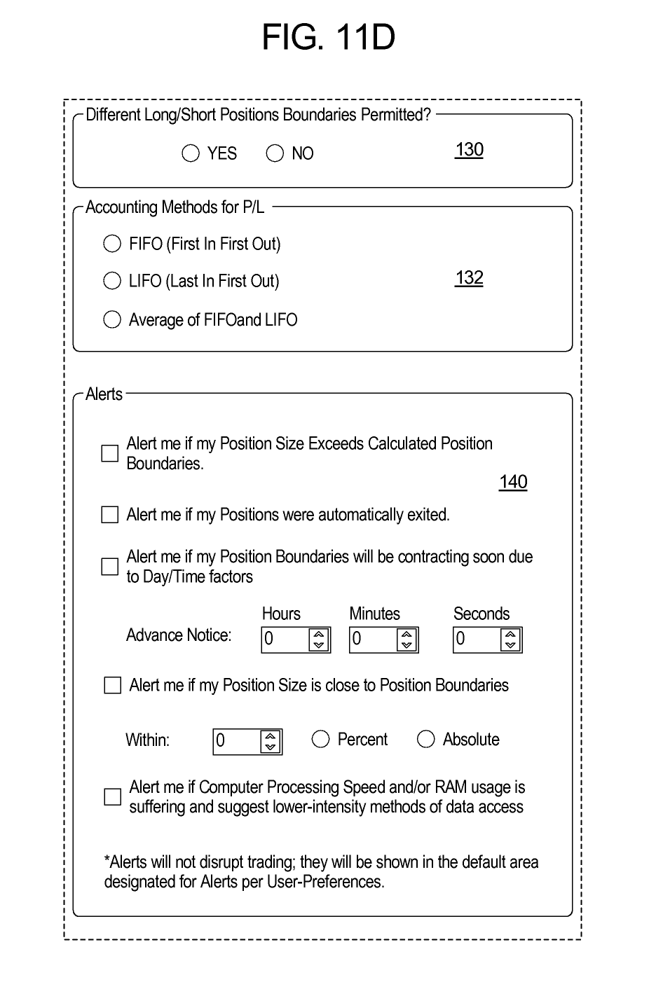

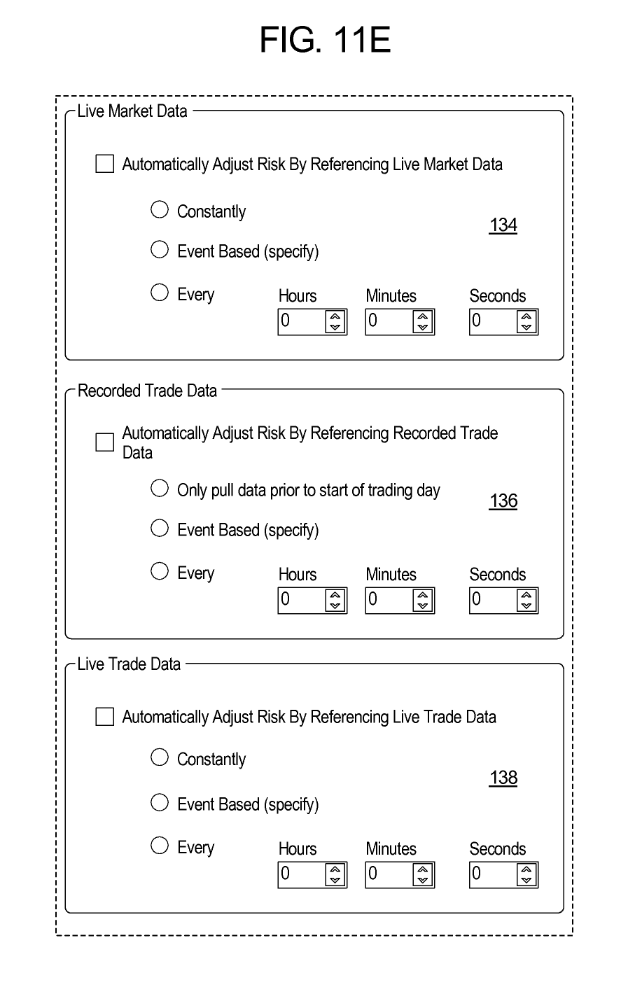

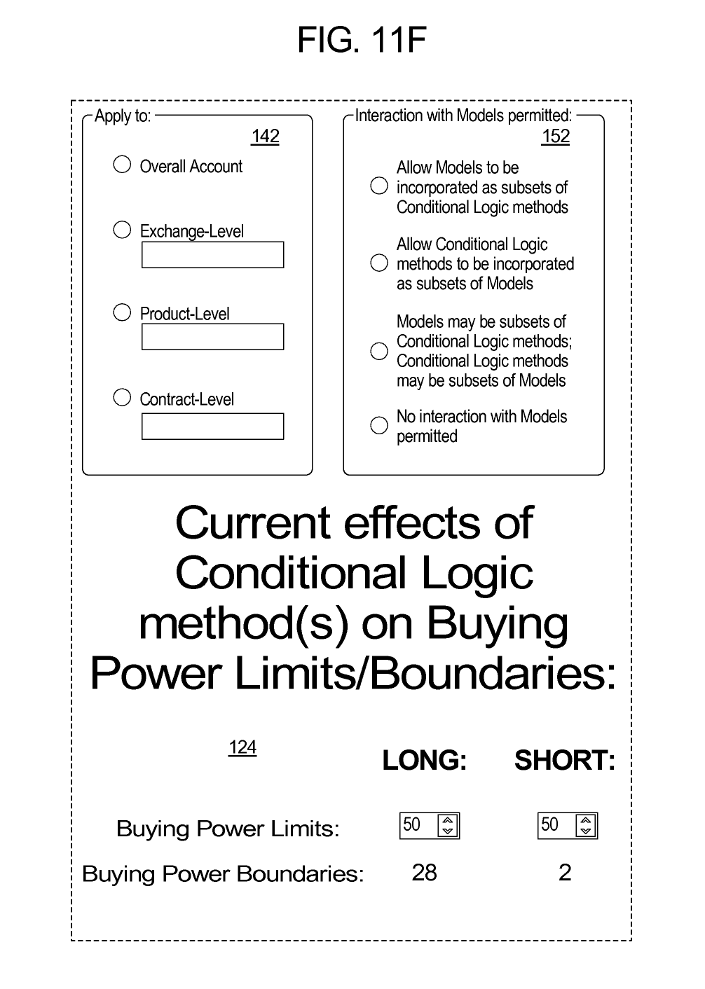

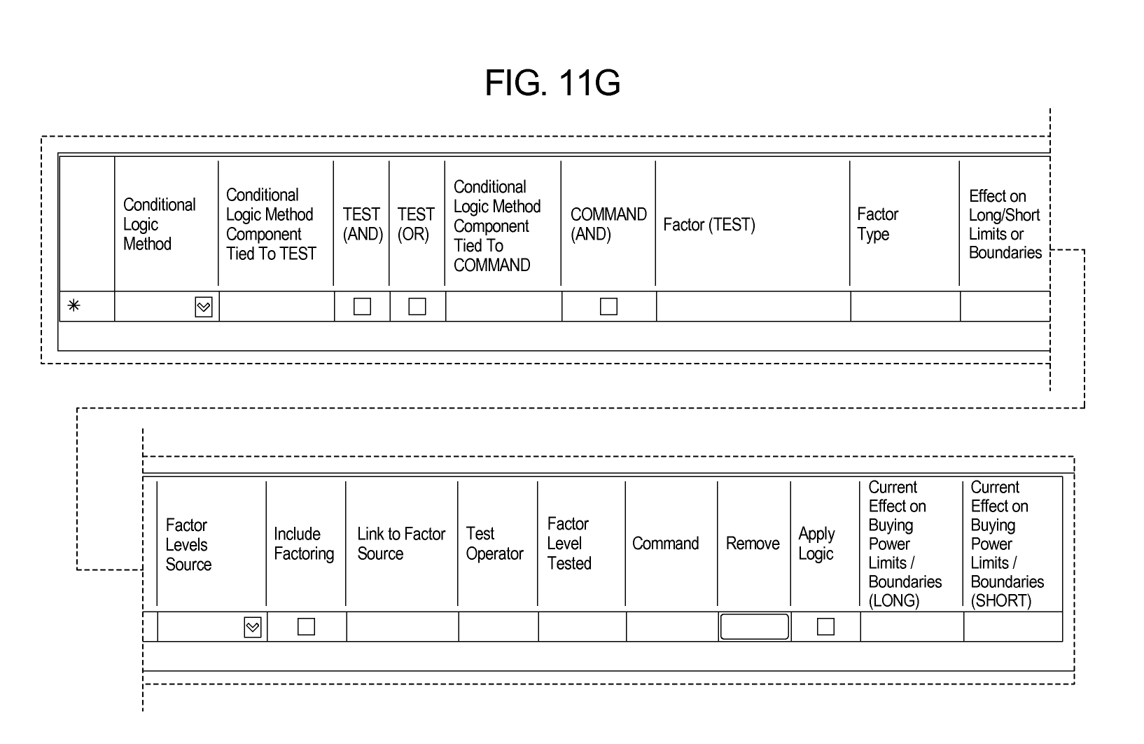

Other examples of data sources for providing values of buying power limits (or other conditions related to buying power limits) shown in FIG. 6 are the output of one or more associated risk management applications 116 (e.g., FIGS. 7 and 11). Similar to the example of the associated spreadsheet impacting a condition related to buying power, the data referenced in or output from the associated risk management applications 116 may be adapted to automatically adjust one or more conditions related to buying power. Examples of the associated risk management applications 116 are provided in greater detail herein.

It is understood that in other examples of a buying power limits assignment interface 114 any combination of one or more references and functions (manual inputs, associated spreadsheets, models, conditional logic, etc.) may be used for the automatic adjustment of conditions related to buying power and that the buying power limits assignment interface 114 may provide functionality for selecting the combination of references and functions to implement. Further, the buying power limits assignment interface 114, in full or in part, may be combined with other elements of the system 100 instead of being separate.

As further shown in FIG. 6, the system 100 provides a user with the option to automatically liquidate positions that fall outside of the presently imposed buying power limits. Because the system 100 allows for the value of the buying power limits to automatically adjust, there may be instances in which the user is holding positions that were previously within the user's buying power limits, but are no longer due to an automatic contraction of the buying power limits. Accordingly, it may be beneficial to automatically liquidate those positions that fall outside of the presently imposed buying power limits. Such liquidation may occur in any manner as will be understood by one of ordinary skill in the art (market orders, limit orders, etc.) and additional conditions (such as type of orders to be placed for liquidation) may be selected by the user's input to the system 100.

FIG. 7A illustrates an example of a risk management application 116 that may be adapted for use with the mechanism adapted to adjust one or more conditions related to buying power 108. FIGS. 7B-7H show portions of the risk management application 116 shown in FIG. 7A in greater detail. FIGS. 7A-7H will be referred to herein collectively as FIG. 7. In the example shown in FIG. 7, the risk management application 116 may be adapted to output a present (or future) value for the buying power limits to be used, for example, in connection with the mechanism adapted to adjust one or more conditions related to buying power 108 in the system 100. However, it is understood that the risk management application 116 may alternatively be adapted to output data used to automatically adjust one or more other conditions related to buying power. It is further understood that the output of the risk management application 116 may be used to set buying power limits, temporary buying power limits, buying power boundaries, or any other conditions related to buying power. It is understood that the risk management application 116 shown in FIG. 7 is merely one illustrative example of a risk management application 116 and of how functions may be formed, used, and implemented. Other options may exist in other contemplated examples.

The risk management application 116 shown in FIG. 7 is adapted to implement and manage a function incorporated into or used by the mechanism adapted to adjust one or more conditions related to buying power 108, wherein the function is provided in the form of a mathematical model and, accordingly, includes a model manager 118, a model settings manager 120, a model wizard 122 and a model results display 124, each of which is described herein.

The model manager 118 provides the functionality to create, store and otherwise manage one or more models in certain embodiments of the system 100. In the example shown, the model manager 118 allows users to create, load, save, delete and copy models. However, it is understood that in alternate embodiments of the model manager 118, a greater or lesser amount of models and/or model functionality may be provided.

The model settings manager 120 shown in FIG. 7 allows users to specify various methodologies for how the models and associated functionality will operate. Note that as shown in FIG. 7, the settings shown in the model settings manager 120 may be applied at the model level. However, in other scenarios, such settings may also be applied across a group of models or across all models created by the user. What follows is an outline and description of the various parts of the model settings manager 120.

The model functionality section 126 of the model settings manager 120 shown in FIG. 7 allows a user to assign whether: (1) to implement the calculated buying power limits in the user account (i.e., automatically adjust the value condition of buying power limits) and, if so, whether to automatically exit positions that fall outside of calculated buying power limits; or (2) to use the buying power limits as displayed or suggested buying power limits only but not to be used to implement actual constraints or limits on buying power.

The method of model creation section 128 of the model settings manager 120 shown in FIG. 7 enables the user to select the method for creating the model. In the example shown, the user may select either to create the model one factor at a time or to import the model from another source.

The different long/short position limits/boundaries section 130 of the model settings manager 120 shown in FIG. 7 enables the user to set the allowance for different long and short position limits or boundaries.

The accounting methods for profit/loss section 132 of the model settings manager 120 shown in FIG. 7 enables the user to select between different accounting methods that are offered. These accounting methods may be used for assessing a trader's performance in relation to profit and loss factors. For example, a trader may hold a current position which shows an open loss of $500 using the FIFO method, but which shows an open loss of $800 using the LIFO method. Offering an accounting method choice to users here will allow any models built to be more robust. In the example shown, offering the “Average of FIFO and LIFO” option may add even more value.

The live market data section 134 of the model settings manager 120 shown in FIG. 7 provides the user extra control over how the functions operate. Keeping the system 100 RAM and CPU usage under control may be of particular concern to traders. Even though live market data (such as new price or volume information) may constantly change, traders may not want their functions to recalculate factors related to market data on every new price tick. The checkbox is given to allow users to turn on or off the assessments of live market data. Via the options below the checkbox, users are able to weigh the importance of frequently updating functions versus better overall computer performance. In one example, a user may find that function calculation is of utmost importance, and therefore may choose to constantly perform assessments of the market data factor components of overall functions every time the associated live market data itself has a new update. This may also, in turn, automatically update conditions of buying power limits at a faster pace. In another example, a user may find that CPU performance is more important than constantly updating market data factor assessment within the function. Therefore, the user may choose to only perform market data factor assessment at specified intervals, such as, for example, every x minutes. It is contemplated that user preference for which option to choose in live market data section 134 may be largely dependent on how integrated the function is within a user's trading style. As further shown in FIG. 7, the live market data section 134 may include an event based option as well, which is used in this embodiment to offer an example that other possibilities of methods for when to assess market data may exist, such as event-based methods.

The recorded user trade data section 136 of the model settings manager 120 shown in FIG. 7 is similar to the live market data section 134 discussed above. A checkbox is given to allow users to turn on or off the assessments of recorded user trade data. Via the options below the checkbox in the recorded user trade data section 136, there are multiple options for the user to choose when the system will assess recorded user trade data. User trade data is intended to include a trader's historic trade data information (i.e., how many trades a trader made the prior minute, hour, day, week or month, how many of these trades were profitable, etc.) This may be used as part of a user's trading profile as discussed earlier. Note that as this data may likely be contained within an outside data source, such as a CSV file, it is expected that many users would like to access the data less frequently when compared to the live market data. However, users may also wish to constantly perform assessments of this recorded user trade data as well, even though that option is not shown in the example shown in FIG. 7. Constant performance assessments might be particularly useful when some or all of the recorded user trade data is stored in the software application itself. The options shown in this example are: only pull data prior to start of trading day; event based (specify); or every X hours, Y minutes, and Z seconds. User may again choose one of these options as may be appropriate based on their own unique situation. Or, in other scenarios or examples, other options not shown in FIG. 7 could also be made available to users.

The live trade data section 138 of the model settings manager 120 shown in FIG. 7 is very similar to the live market data section 134 and the recorded trade data section 136 discussed above. Live trade data may refer to, for example, current position data, current profit and loss data, current open profit and loss data, and similar factors having to do with the current state of the user account, the user position state, the user profit and loss state, etc. Similarly to live market data section, a checkbox is given to allow users to turn on or off the assessments of live trade data. Via the options below the checkbox, the live trade data may be accessed constantly, may be accessed based on events, may be accessed every X hours, Y minutes, and Z seconds, or may be accessed using other methods not shown in example shown in FIG. 7.

An alert section 140 is provided in the model settings manager 120 shown in FIG. 7 for automating system messages and alerts to the user. In the example shown, there are several self-explanatory alerts provided for selection, including: (1) position size exceeds calculated buying power limits; (2) positions have been automatically liquidated; (3) buying power limits are scheduled to change soon (allowing for the selection of how far in advance of the change the change the alert will be provided); (4) position size approaches buying power limits (allowing for the selection of threshold for triggering the alert); and (5) system performance alerts (e.g., the state of CPU and/or RAM performance). However, it is contemplated that there are limitless examples of alerts that may be provided. For example, an alert may be provided such that the user is notified when the current position size is a given number of contracts or shares or a given percent different from the average of the long and short side buying power limits. For example, if the long buying power limit is 50 contracts and the short buying power limit is 10 contracts, this could be interpreted as a signal that the user should really be focused on entering into long positions, not short positions. Accordingly, if the user has a short position of 8 contracts (28 contracts away from the average of the short and long buying power limits), that user might be aided by an alert that the current position might carry extra risk than possibly perceived by the user. It might just take an alert to get the user on the right track again.

In addition to providing the visual and/or audible alert to the user, the form in which the alert is given when presented to the user may include functionality for triggering preset or predetermined commands or functions. For example, rather than automatically liquidating a position, if currently held positions exceed the user's buying power limits, an alert may be provided so that the user may optionally trigger a liquidation of the positions outside of the buying power limits according to predetermined rules. In another example, an alert may be provided such that if the presently calculated or selected order size is within a given range of the buying power limits, the user may be presented with functionality for reducing the order size by a predetermined amount. Accordingly, as one or more conditions related to buying power or other conditions within the system 100 adjust the user may be alerted and provided with functionality to execute predetermined actions for resolving or taking advantage of the present conditions.

As discussed in further detail herein, buying power limits may exist and be applied at the user account level, at the exchange level, at the level of the tradable instrument, etc. The model settings manager 120 shown in FIG. 7 includes a buying power limits level selection section 142 through which a user may select the level at which to apply the selected or calculated buying power limits.

As further shown in FIG. 7, the model settings manager 120 includes a type of model section 144 through which the user can select a type of function, specifically the type of model to implement. As has been discussed at length herein, functions that are built may be of any conceivable type. One of the examples provided in FIG. 7 is a multiplicative model through which user defined factors are used to model the desired one or more conditions related to buying power. Further, a user-defined model may include functions such as addition, subtraction, multiplication, division, natural log, exponential, logarithmic, as well as any other functions to relate the various factors. Functions may range from simplistic to exceptionally complex and there may involve any number of factors and relationships. The functions employed may include complex behavioral models, market analysis models, etc.

As further shown in FIG. 7, a model building application 146 is included. Factors may be added to the model building application 146 using the model wizard 122. In FIG. 7 the model building application 146 provides some detail about each factor that has been included within the function, such as the factor type, the effect on long/short buying power limits/boundaries, etc., but gives little indication for how the factors will relate to each other. If the type of model selected for use in type of model section 144 is a multiplicative model, then it should be understood that a model building application 146 will be restricted in terms of its functionality for how the factors will relate to each other; i.e. the factors will simply be multiplied by one another in the model.

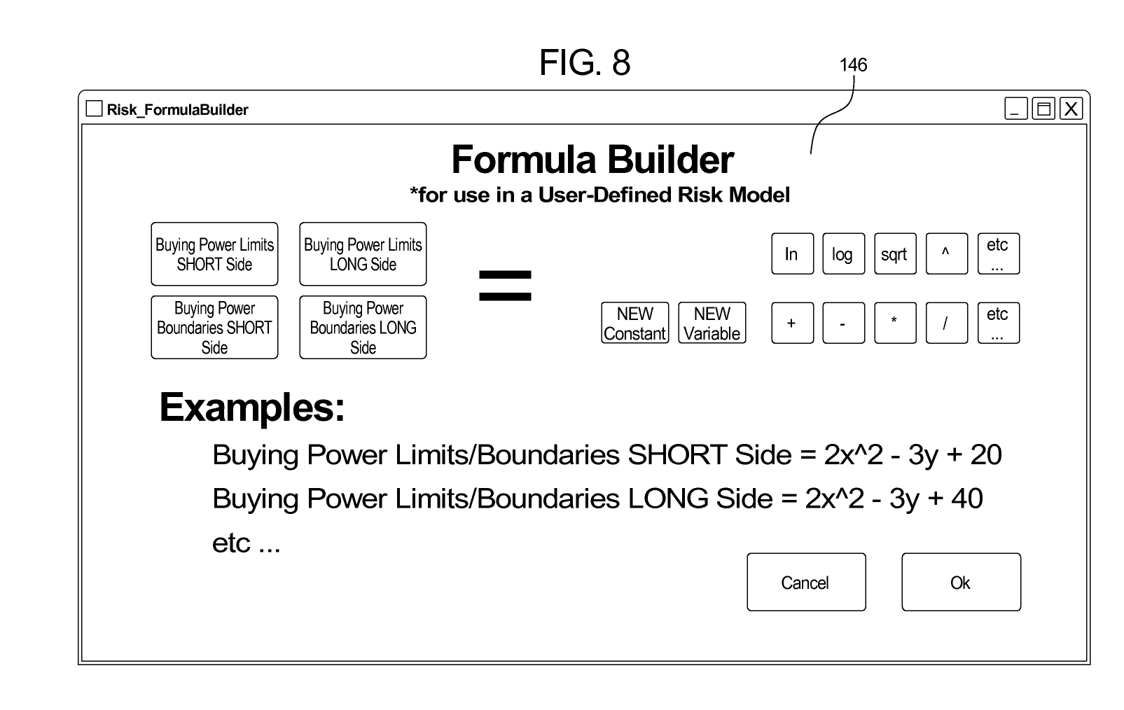

In instances in which the system 100 supports the development and use of user-defined functions, the risk management application 116 may include, for example, a more complex model building application 146 applied for use with user-defined functions. A more complex model building application may allow the user to configure the relationship between the factors contained in the model. Rather than include all of the information that was previously displayed in model wizard 122 and model building application 146 on FIG. 7, FIG. 8 only shows how the user may relate the factors of a model to one another. As shown, the model building application 146 may provide the user with the tools to create a function to be used within the system 100. The factors shown in the example formulas provided in FIG. 8 may be market related factors, performance related factors, etc. and the formula may stand alone as a function or may be incorporated as a sub-function as part of a larger function. In one example, the factor “x” as shown in FIG. 8 may be a market related factor. Even though it is not shown in FIG. 8, it is expected to be understood that somehow the user is further enabled to control which factor is which, such as for example, that the factor “x” is a specific market-related factor.

The model building application 146 may be provided within the same interface as the remainder of the risk management application 116 as shown in FIG. 7 or it may be provided in a separate interface as shown in FIG. 8. Similarly, it is important to note that any and all aspects of the risk management application 116 and other functions described in relation to the system 100 may be provided in independent interfaces, sections, screens, etc. or may be combined in any conceivable number of interfaces, sections, screens, etc. with any combination of functions provided in each. It is understood that the functionality discussed with regards to models in FIG. 7 may generally be usable with all types of functions, not just models, even though exceptions exist, such as type of model section 144.

In the example shown in FIG. 8, the model building application 146 includes functionality for creating and implementing a function in the form of a model. As shown, the model building application 146 provides the user a number of mathematical operators that may be added to the function to be developed. Further, the model building application 146 provides the user capabilities to add an unlimited number of factors to the function. The user may further specify which factor is which, such as the factor “y” is a trader performance factor, wherein it is the open profit or loss in the user account. The model building application 146 may include, for example, commands for selecting and/or information displaying the presently selected values for: the factors to use in the function, the factor type, whether the factor has the same or different effects on long and short limits, the source for the factor data, removing factors, applying factors to the function, current effects on the long and short sides of the function, etc.

In the example shown in FIG. 7, a user may create a function using various factors. In this example, factors are listed along side the associated factor types and their effect on long/short limits or boundaries in the selection box shown. The data may come from an internal or external data source. A user may add factors to their function by clicking the “ADD Factor to Model” button using the model wizard 122. After clicking that button, factors will populate the section below. As can be seen, the first three columns of information come directly from the columns above them. In this example, columns of data to the right of these first three columns are intended to be editable. The next column shown is “Factor Source”. This is intended to represent the ways in which factors may be accessed for use with the function. Possible methods which may be selected in this column are default skewing, smart skewing, data table (internal), data table (external), other external link, or other. Other selection methods may be available. Default skewing is intended to represent a default methodology or suggested methodology by the platform. Smart skewing is intended to represent a way in which the system may smartly adapt to provide improved methods over default skewing methods. In one example, a smart skewing method may, at first after a user starts to use the system, be almost identical to default skewing methods. However, as time goes on and as data is collected regarding a user's trading habits and trading profile, smart skewing methods may automatically adapt in order to maximize profit and minimize loss. The word “skewing” used here is intended to represent that the methods used will skew the value condition of buying power. However, as is expected to be understood, each factor may interact with each other and the automatic adjustment of the conditions of buying power may be performed based on all of the factors taken together as opposed to having individual skew affects. Other factor sources may be an internal or external table, or may be a link to data in another piece of software or data file, or possibly internal information.

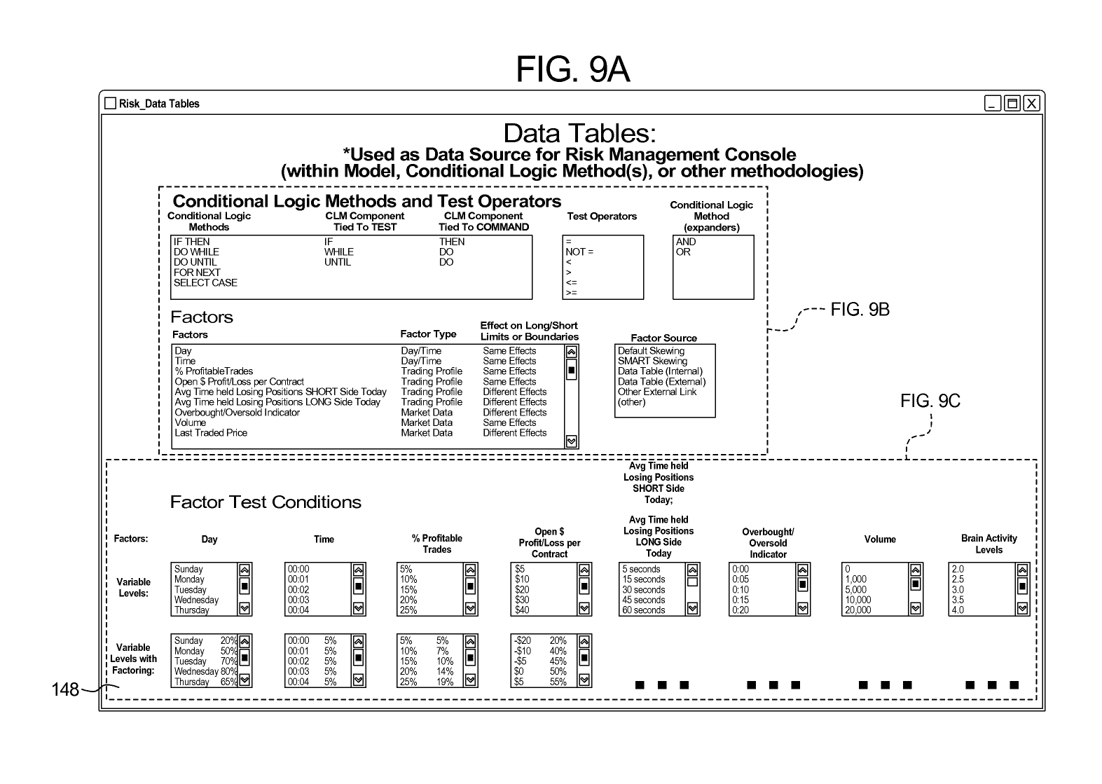

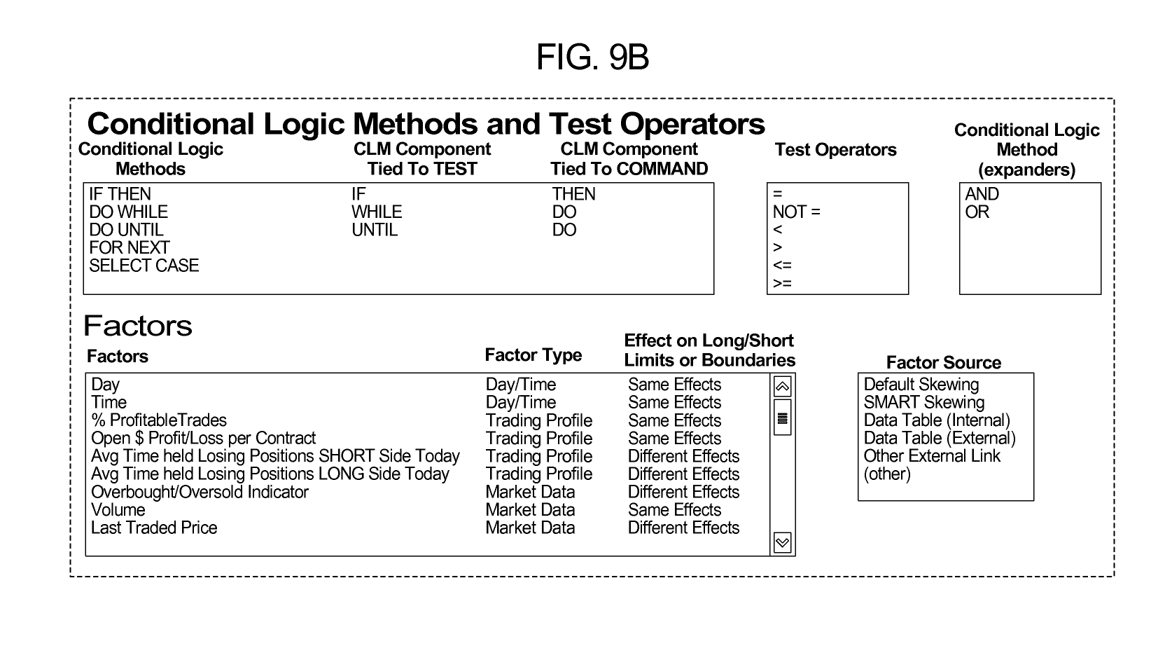

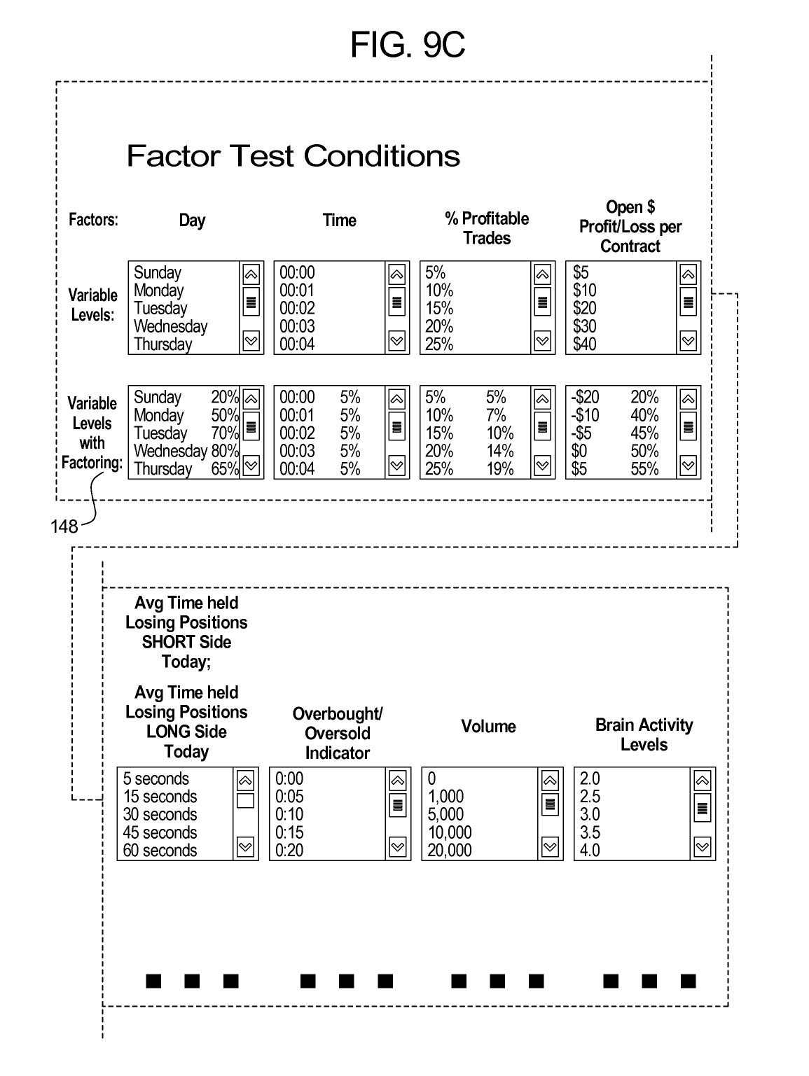

Examples of data tables are shown in FIG. 9A. FIGS. 9B-9C show portions of FIG. 9A in greater detail. FIGS. 9A-9C will be referred to herein collectively as FIG. 9. As shown in FIG. 9, the Variable Levels with Factoring section 148 provides the factors to use in the function when certain variable conditions are met. Note that this example is simplified for user readability and understanding. It is expected to be understood that the functionality shown in FIG. 9 is just an example and that other more complicated functions may be implemented. Another only slightly more complicated example may include, for example, combining the day of week and time of day factors to have a combined factoring method applied. So for example, if the day of the week is Wednesday, and the time of day is 2:04 PM, the factor may be 75%. If the day of the week is Thursday, and the time of day is 2:04 PM, the factor may be 65%. However, it is understood that other examples may be many orders of magnitude more complicated. Skipping back to the model building application 146 shown in FIG. 7, the last two columns of information may show the current factoring effects of each factor on the model. In the model building application 146 shown in FIG. 7, there are separate outputs for the model to supply buying power limits for the long side of the market and the short side of the market, whether suggested or directly implemented. In other examples, there may be only one output which is applied to both sides of the market, or there may be even more than two outputs.

FIG. 7 also illustrates a model results display 124. In the example shown, the model results display 148 displays the effects of the function. In FIG. 7 this section is shown as “Current Model Effects on Position Limits/Boundaries”. As has been described throughout this disclosure and as is shown in the model functionality section 126 of model settings manager 120, the model output may be used to automatically adjust one or more conditions related to buying power limits (or buying power boundaries). For example, even if not implemented as buying power limits, the model output may automatically adjust a currently suggested buying power value to be displayed to a user—yet another possible condition related to buying power limits.

In the example of the model results display 124 shown in FIG. 7, buying power limits for the long and short sides, the aggregate factoring and the resulting buying power boundaries are each displayed. In this example shown, the user presently has buying power limits on the account of 50 long and 50 short contracts. It is assumed for this example that these buying power limits are hard limits that were assigned by a brokerage firm or by a risk manager. In this example, the function developed and implemented in the risk management application 116 results in aggregate factoring values of 0.569 long and 0.045 short. Accordingly, the provided buying power boundaries are equal to the buying power limits multiplied by the aggregate factoring resulting in buying power boundaries of 28 for the long side and two for the short side of the market.

Although shown as part of FIG. 7 in a single screen shot, the model settings manager 120 may be provided in a software wizard (i.e., a user interface that presents a user with a sequence of dialog boxes that lead the user through a series of well-defined steps). The software wizard may walk a user through the function settings in a manner such that the user is able to select between beginner/simple tasks and more expert/advanced features. It is understood that software wizard functionality may be provided for any of the software elements of the system 100 described herein. In another example, an entire risk management application 116 may be setup as a wizard.

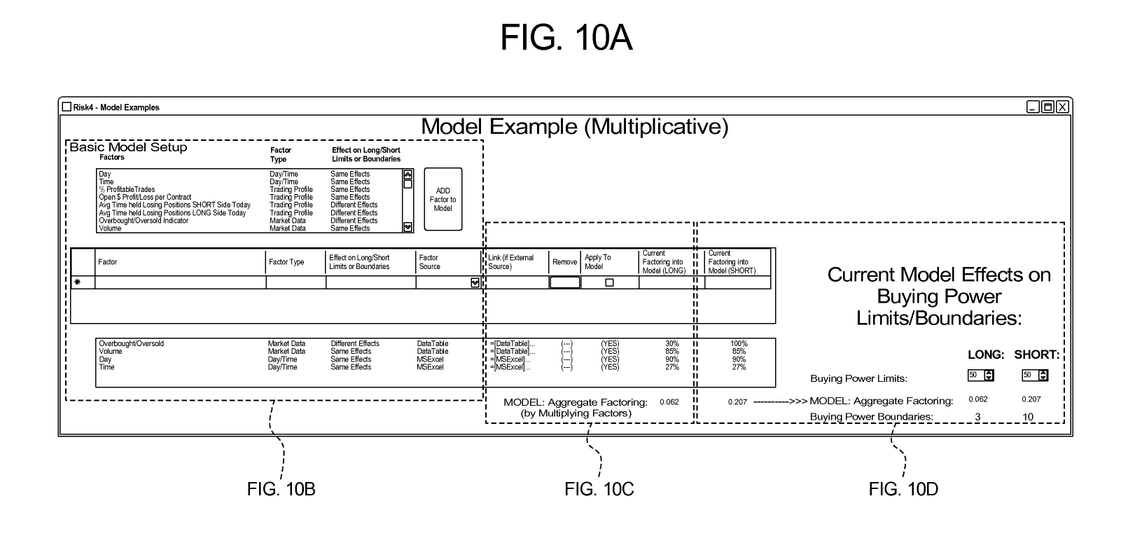

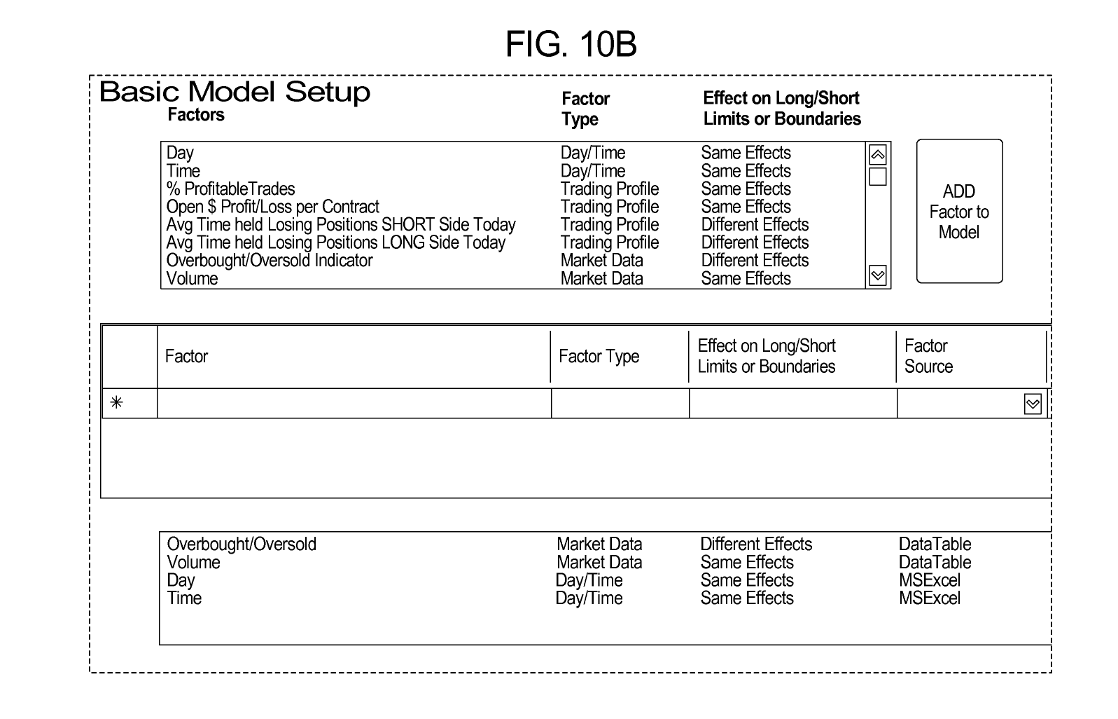

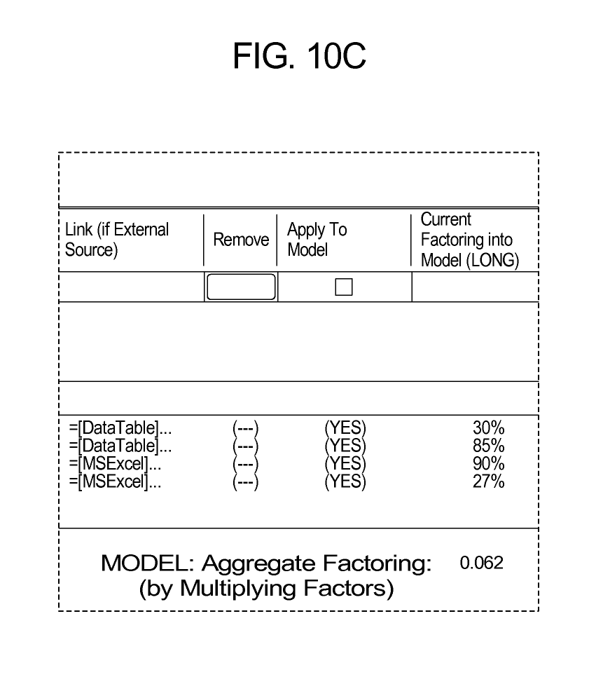

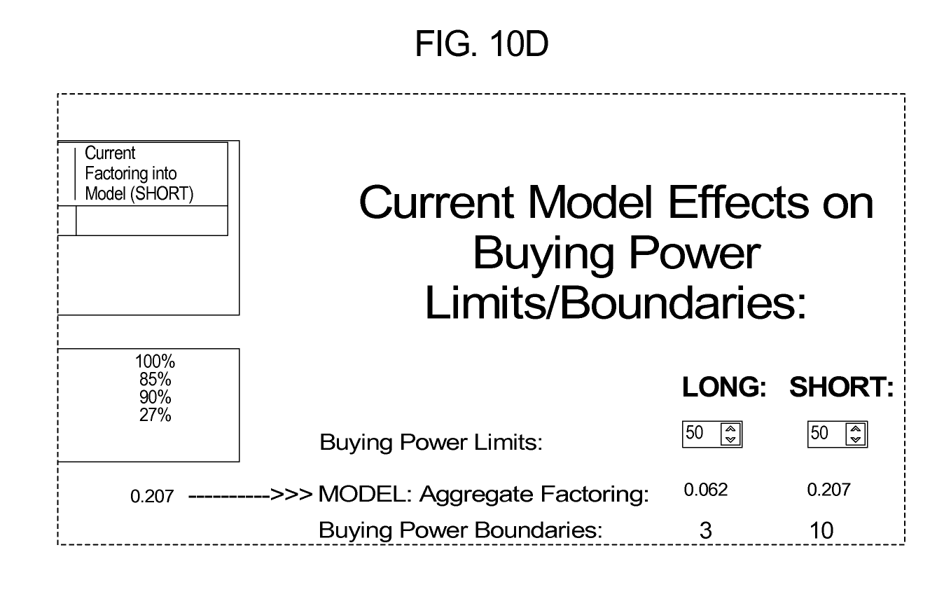

Turning now to FIG. 10A, an example of a function embodied in a multiplicative model adapted to automatically adjust the value condition of buying power limits is shown. FIGS. 10B-10D show portions of the multiplicative model shown in FIG. 10A in greater detail. FIGS. 10A-10D will be referred to herein collectively as FIG. 10. The multiplicative model shown in FIG. 10 may be provided, for example, in a risk management application 116 as described above with respect to FIGS. 7-9. In the example shown in FIG. 10, four factors have been selected and populate the factor list. The last two columns of the table illustrate the current effect of the factors onto the function, which is used to automatically adjust the value condition of the buying power limits. In this example, it can be seen that the user starts with buying power limits of 50, possibly assigned by a brokerage, risk manager or other party, or possibly based on the user's account value, possibly manually set by the user in another way, or possibly even set by another function. In this example, the function multiplies the buying power limits by the aggregate factoring provided the factors. The output of the function is another set of buying power limits, expressed here as buying power boundaries. The resultant set of buying power boundaries, which may automatically adjust in real-time, may be automatically applied and used as actual buying power constraints on the user system. Accordingly, as the function changes, the value condition of buying power may automatically change as well.

As an example of how the function output may automatically adjust in real-time, consider the first factor provided in the function illustrated in FIG. 10, the factor named “Overbought/Oversold.” As shown, the current effect for this factor is different for the short and long sides of the market. It is expected that as the market data used to support the “Overbought/Oversold” factor is updated in real-time, the related factor updates as well. Similarly, the “Volume” factor may also be updated in real-time (or near real-time) to provide automatic adjustment of the function, which may lead to automatic adjustment of a condition related to buying power. Of course, the factors “Day” and “Time” may also be updated in real-time, though their effect on the function's output may change less frequently. For example, even when updated in real-time it is likely the “Day” factor will not change more than once a day.

It should be noted that even though our discussion of models concentrated on model output being able to automatically adjust the value of buying power limits, model output may also automatically adjust other conditions of buying power. This is expected to be understood given the other discussion contained herein.

Turning now to FIG. 11A another example of a risk management application 116. FIGS. 11B-11G show portions of the risk management application 116 shown in FIG. 11A in greater detail. FIGS. 11A-11G will be referred to herein collectively as FIG. 11. Similar to the example shown in FIG. 7, the risk management application 116 may be used to develop methods through which a user may automatically adjust conditions related to buying power. One difference between the risk management application 116 shown in FIG. 7 and the risk management application 116 shown in FIG. 11 is the method utilized to generate the factors to apply to the buying power limits. In the example shown in FIG. 11, the method utilized is through the application of conditional logic. An example of a conditional logic method is an IF-THEN statement commonly used in software programs. Other examples of conditional logic include IF, IF-THEN-ELSE, DO-WHILE, IF(X AND Y)-THEN, IF(X OR Y)-THEN, and others methods. As used herein, the term Conditional Logic or Conditional Logic Methods will refer to a system or method wherein one or more conditions is tested, independently or in combination, and as a result of the one or more tests, zero, one or more result conditions or commands may be implemented as a result. By our definition, all of the above-listed example methods of conditional logic are included; further, there are other computer methods also to be considered part of our term for Condition Logic used herein, such as Case and Switch Statements (e.g. SELECT CASE or simply CASE), Pattern Matching, ARITHMETIC IF statements such as in Fortran, and IFF statements such as in Visual Basic. It is understood that there is a nearly limitless number of conditional logic statements of varying complexity that may be implemented.

Conditional logic methods may be useful in automatically adjusting one or more conditions related to buying power limits. A simple example is provided. IF a given market becomes “oversold,” THEN a condition of buying power limits may be automatically adjusted. One example of a condition that may automatically adjust would be the value condition. As an example, IF the market becomes “oversold”, THEN the value condition of the short side buying power limit may be automatically adjusted downward to zero. It should be noted that even though in this example we only consider one test condition which is a simple “IF-THEN” conditional logic method, and even though we only control the value condition of the buying power limits (long and short separately), it is easy to envision ways in which a system that offers methods of conditional logic in order to automatically adjust buying power may become much more complex. In a more complex system, one or more conditions for one or more buying power limits may be automatically adjustable, possibly at the same time, using one or more conditional logic test conditions and output methods to control that behavior. Additional examples of more complex methods are provided herein.

The major difference between the examples shown in FIG. 7 and FIG. 11 is that the model building application 146 shown in FIG. 7 has been replaced by a conditional logic building application 150 in FIG. 11. As described with respect to FIG. 7, the model building application 146 allows users to create different types of functions, such as multiplicative models, user-defined models or other models, as well as allows for the factors contained in those functions to interact with each other. The model building application 146 further allows the functions to be applied to automatically adjust one or more conditions relating to buying power limits. The conditional logic building application 150 in FIG. 11 may allow each of these functions as well. While provided as separate examples, it is understood that the risk management application 116 may provide the user with the ability to create functions that depend on combinations of the functions provided by the model building application 146 and the conditional logic building application 150. For example, a more complex function may include elements controlled by conditional logic functions that interact with multiplicative factors. The systems and methods described here should be understood primarily for their functionality, whereas GUI design is extremely flexible.

One of the ways in which FIG. 11 differs from FIG. 7 is in the Risk Settings section labeled “Interaction with Models permitted” 152. This section 152 is included to convey that one or more independent models may be used in conjunction with one or more methods of conditional logic. As described herein, models may be sub-components of conditional logic and conditional logic may be used as sub-components of models. In one example in which a conditional logic function is used as a sub-component within a function embodied in a model, consider a situation where a model may contain eleven factors, ten variables and one constant. One of those variables may either be a one or a zero. Whether or not that variable is a one or a zero may be based on conditional logic. In another example, where a model is a subcomponent of a conditional logic method, a test condition being applied as part of the Conditional Logic is an IF-THEN statement. If the IF-THEN test is true, then one model is applied. If the IF-THEN test is false, another model may be applied. Accordingly, as described herein, functions may be driven by models and/or conditional logic and users may use both types of functions in the same process, may combine these types of functions together, may encompass one type of function within another type of function, or use multiple versions of each type of function, i.e., multiple models, multiple conditional logic configurations, etc.

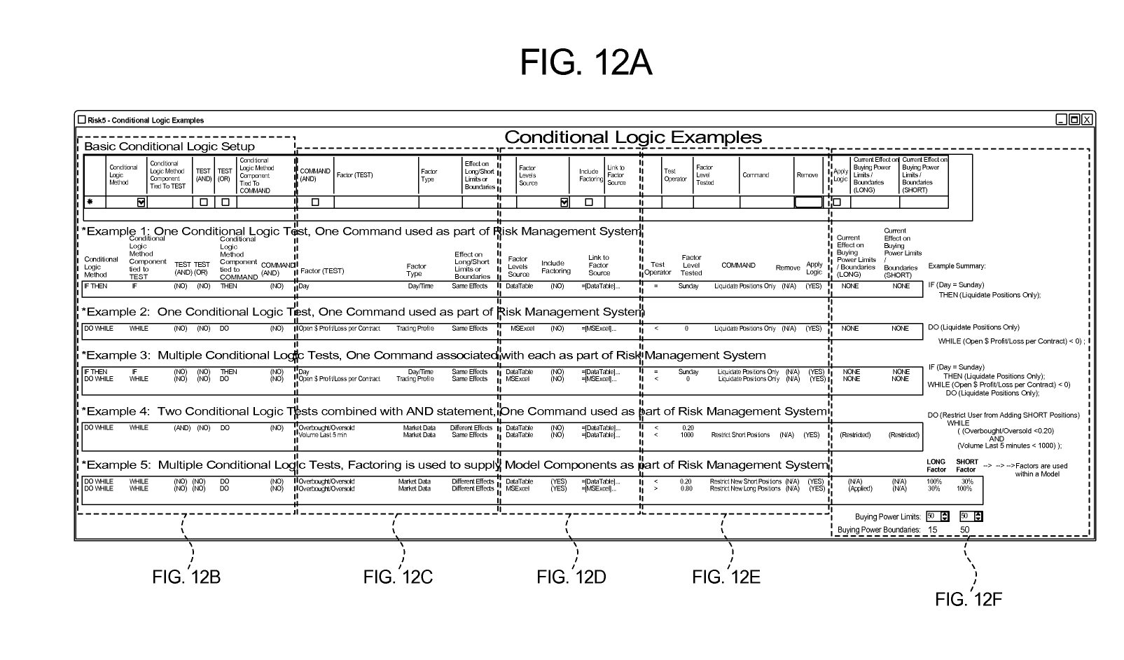

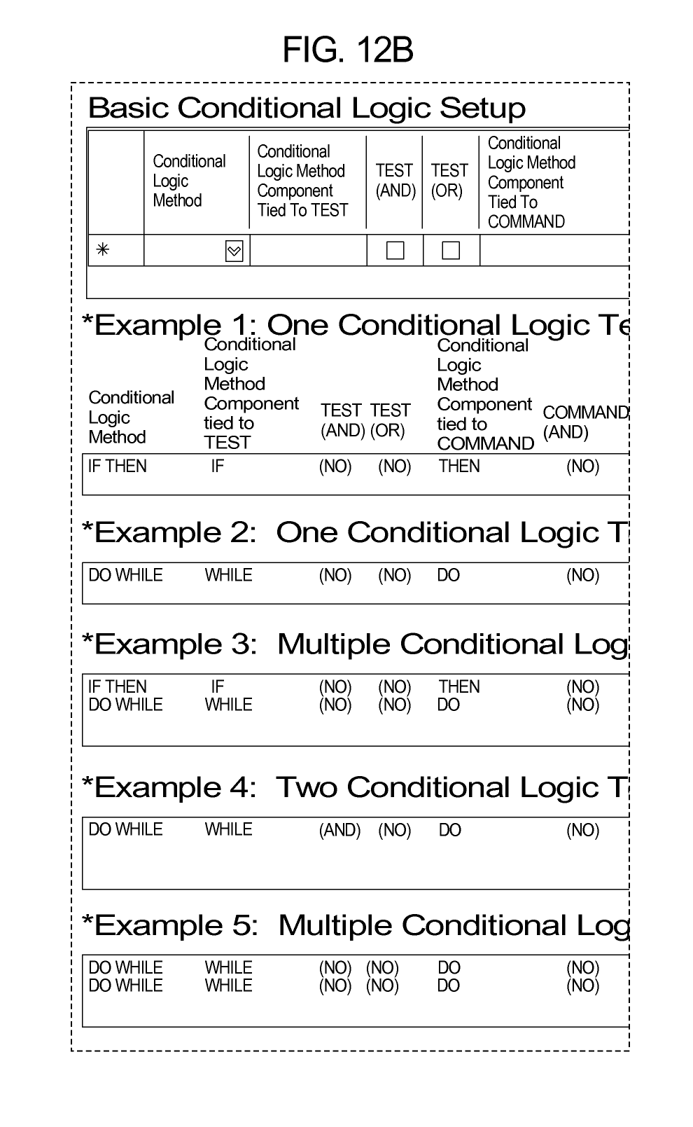

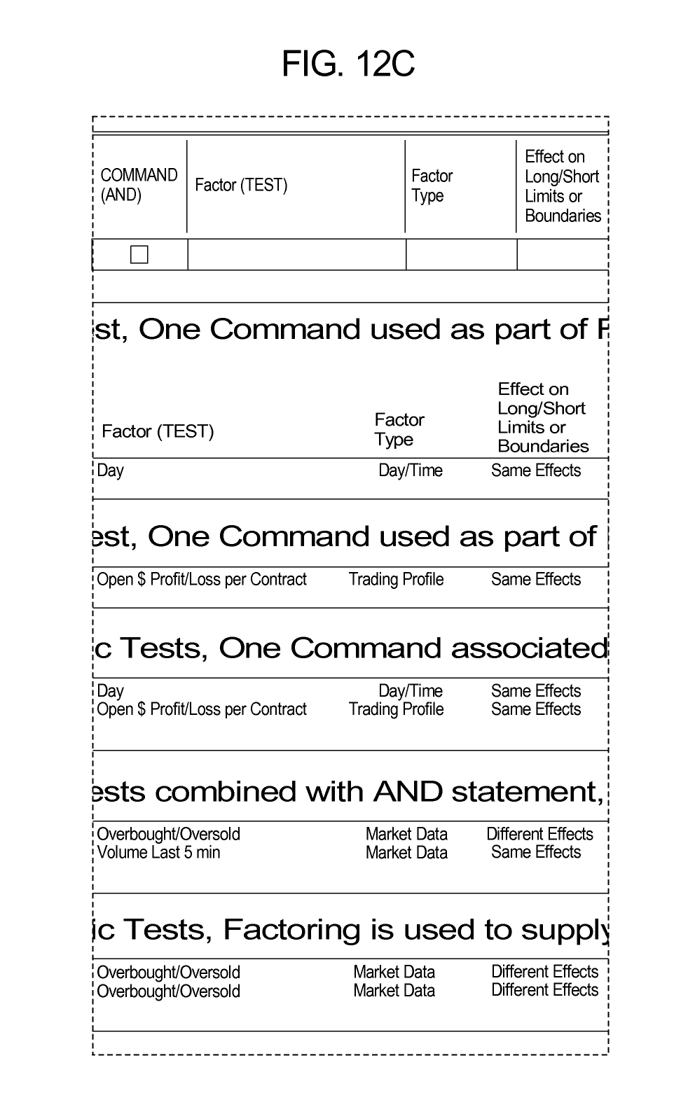

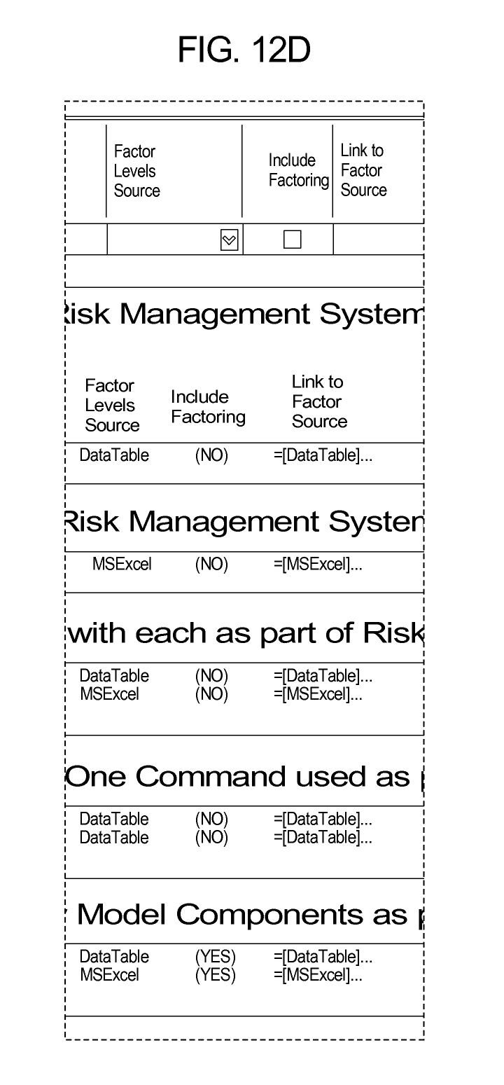

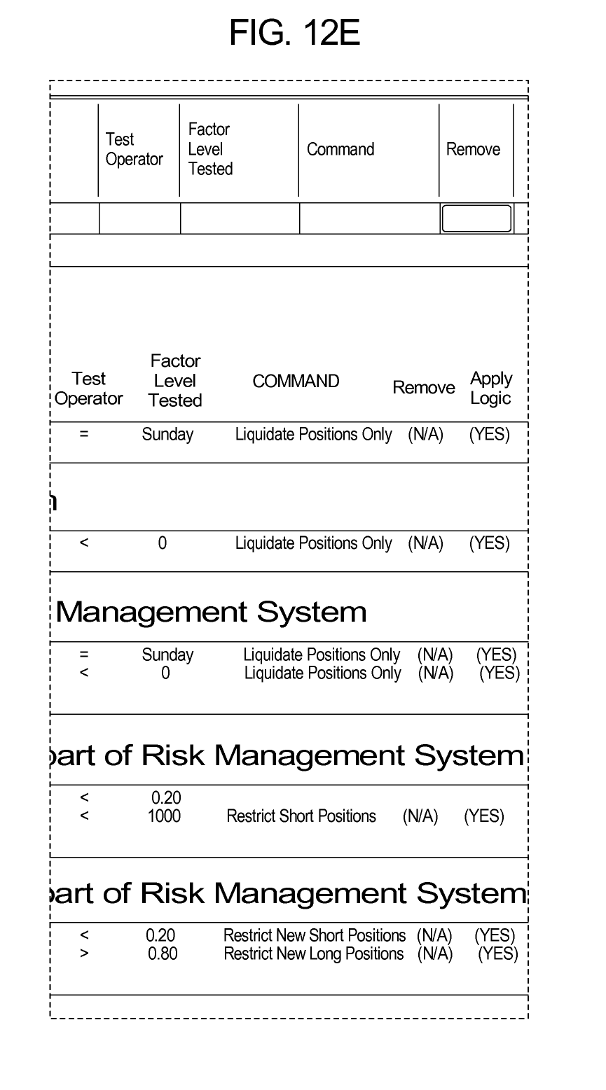

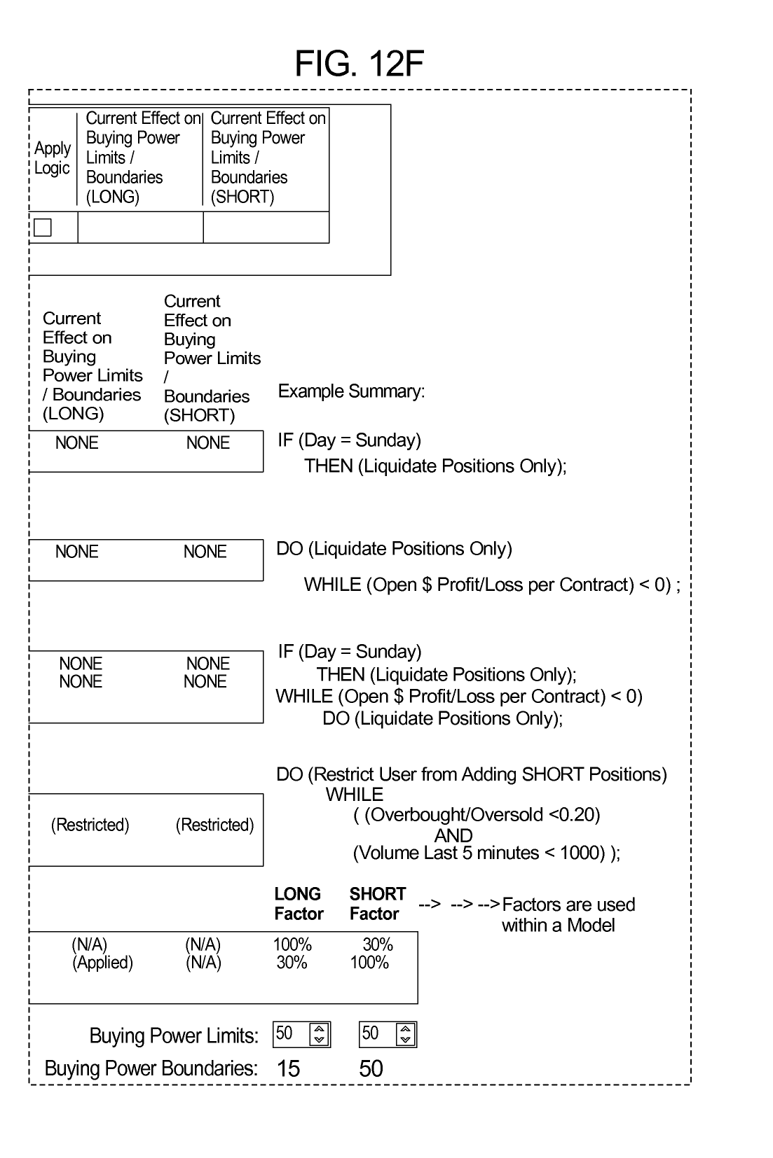

FIG. 12A illustrates an example of an implementation of a conditional logic building application 150. FIGS. 12B-12F show portions of the conditional logic building application 150 shown in FIG. 12A in greater detail. FIGS. 12A-12F will be referred to herein collectively as FIG. 12. The conditional logic building application 150 may be incorporated into the risk management application 116 shown in FIG. 11, whether provided within one screen, accessed through a plurality of screens or provided in a software wizard. As shown in FIG. 11, a user may configure one or more conditional logic methods via an interface such as the one shown in the example in 11G. Each function may incorporate one or more conditional logic tests, each test may incorporate any conditional logic qualifier (e.g., AND, OR, IF-THEN, etc.) and the resulting condition may provide instructions for automatically adjusting a condition related to buying power. For example, the resulting condition may be an instruction for automatically adjusting a condition related to buying power (e.g., unlock buying power limits), may be a factor to apply within a multiplicative formula (e.g., reduce long side buying power limits by one-half) or may provide any other imaginable instruction for automatically adjusting a condition related to buying power or to be incorporated into a process for automatically adjusting a condition related to buying power.

Additionally, it is understood that the examples provided herein are merely examples of calculations that may be used to accomplish the advantages of the systems 100 and methods 200 and 300. Moreover, while many of the examples provided herein illustrate the use of functions, including models and conditional logic, to adjust the value condition of buying power, it is understood that these functions (and others) may be implemented to calculate and/or adjust other conditions related to buying power.

As illustrative examples, but not intended to be an exhaustive list, the following are conditions of buying power limits which may be modified as the resultant output condition of conditional logic tests: a “value condition” of buying power limits, a “locked condition” of buying power limits, the “ability to raise condition” of buying power limits, the “ability to lower condition” of buying power limits, a “minimum condition” of buying power limits, a “maximum condition” of buying power limits, a “time” or persistence measure for how long another condition may exist or not exist for, etc. These conditions could be considered to be modified as the resultant output of conditional logic tests directly, or, may be modified via command or instructions which happen as a result of conditional logic tests. The exact method applied should be considered one of semantics, and of no consequence, given the same end result is reached. Accordingly, the resultant output of a conditional logic test may automatically set and lock a condition related to buying power for a given period of time (e.g., the short side buying power limits are locked at 20 contracts for the next 10 minutes until the). In another example, the resultant output of a conditional logic test may be to unlock a currently implemented condition at some predetermined time in the future.

The example of the conditional logic building application 150 shown in FIG. 12 includes a section summarizing the functions built therein.

In the first example shown in FIG. 12, a single conditional logic test is used to test whether the day (of the week) is Sunday, and the one resultant output command is to only allow the user to liquidate positions (i.e., liquidate positions only). In this example, if the test condition is true (i.e., it is Sunday), then the user's buying power will be automatically adjusted such that the user may liquidate positions only. In other words, on Sunday, the system 100 will disallow any new orders that would increase the size of any current position (i.e., the user has no additional buying power). The term “liquidate positions only” is an industry term; essentially it means the user's buying power for initiating new positions is set to zero. As an alternate example, the resultant output command may not only reduce buying power to zero, but may also, depending on other functions active within the system 100, result in the automatic liquidation of all positions as those positions would then fall outside of the presently implemented buying power limits.

In the second example shown, a DO-WHILE command is used such that the resultant conditions may exist as long as a certain test condition remains true. In this example, as long as the user factor “Open $ Profit/Loss per contract” is less than zero, the user is not able to add new positions and is only able to liquidate positions. It is inferred here in this example that if the DO-WHILE test condition is false, then the user is able to open new positions.

The third example is a combination of the first two examples to illustrate how more complex conditional logic functions may be implemented.

The fourth example provided in FIG. 12 is an example of how conditional logic tests may be nested. In the example shown, the command portion (or “DO” portion) of the DO-WHILE statement is only executed if both of the test conditions within the WHILE portion of the test condition are true. So in this example, if both of these conditions are true: Overbought/Oversold indicator is less than 0.20; and Volume over the last five minutes is less than 1000, then the following command or method is implemented: “restrict user from adding short positions.”

Although the conditional logic examples shown in FIG. 12 are configured to trigger a resultant command when the test conditions are true, it is understood that the conditional logic methods may be set up to trigger resultant commands when the test results are false. It is also understood that the conditional logic methods may be set up to trigger a first resultant command when the test condition is true and a second resultant command when the test condition is false. Further, it is understood that the conditional logic methods may be set up to trigger a resultant command when a first test condition is true and a second test condition is false.

In the fifth example provided in FIG. 12, a conditional logic method is applied to trigger a factor to be applied to reduce buying power limits. In the example shown, when given market data conditions are met (e.g., when the market is either overbought or oversold), a multiplicative factor is provided, which may be to reduce either the short or long side buying power limits. Based on the simple example shown, it can easily be understood that the conditional logic methods may be associated in combination to create more complex functions to be used to automatically adjust one or more conditions related to buying power.

The sixth column of data shown in the “Basic Conditional Logic Setup” section of FIG. 12, named “Command (AND)”, is intended to represent ways in which users may tie multiple conditional logic tests to only one output condition. If in an example, a user selected “AND”, then they could test multiple factors simultaneously, such as market related factors and trader performance factors, with only one or more than one output condition. This functionality can be seen as an example of a conditional logic method of the form IF (X AND Y).

In some contemplated examples, factoring may always be applied as a result of conditional logic tests. In one example, if a conditional logic method used is SELECT CASE, then based on which case is true, one of a plurality of factors may be automatically selected and applied to automatically adjust one or more conditions of buying power limits, such as the value condition which may be the most appropriate in this example.

In some examples there may be multiple conditions associated with each buying power limit which are automatically adjustable as a result of one or more functions. In one contemplated example, the following conditions of buying power limits may all be adjustable simultaneously based on the same one or more conditional logic tests, with each condition being represented by a column of data in a risk management application 116 such as the one shown in FIG. 11: a “value condition” of buying power limits, a “locked condition” of buying power limits, an “ability to raise condition” of buying power limits, an “ability to lower condition” of buying power limits, a “minimum condition” of buying power limits, and a “maximum condition” of buying power limits.

Further, a “time” or persistence measure for how long another condition may exist or not exist for, or other derivatives of conditions of buying power limits, may exist as well. As such, there exists a huge number of possible conditions of buying power limits which may be automatically adjustable; however all conditions are not shown by example for purposes of simplicity. In one example, if the current state of the value condition, or any other condition, of buying power limits is that it is unlocked, an output command or condition of a conditional method might lock the condition for 10 minutes, at which point it will become unlocked again. Even though time, or persistence of conditions of buying power limits, is discussed here in the context of conditional logic, the same applicability shall also exist within the context of any type of function. Many other derivatives aside from time may exist as well.

As further shown in FIG. 12, there are numerous data sources that may be used to support the risk management application 116 and conditional logic building application 150. For example, data may be provided from live feeds, data tables, spreadsheets, timers, clocks, calendars, user triggers, system 100 conditions, etc.

As shown, the risk management application 116 may be adapted to automatically adjust one or more conditions related to buying power and/or be used to automatically exit or liquidate positions that fall outside of the adjusted buying power limits.

Having discussed the risk management application 116 with respect to FIGS. 7 and 11, another example is provided to illustrate how functions of the examples of risk management applications 116 provided may be adapted for use in a risk management application 116. In this example, a conditional logic test is applied such that IF a tradable instrument, such as the S & P 500 futures, makes a new high on heavy volume, THEN the maximum value of the long buying power limits will be set to 50 contracts and locked and the maximum value of the short buying power limits will be set to zero and locked. Although the maximum value of the long buying power limits is now restricted to 50 contracts, the actual value of the long buying power limits may fluctuate between zero and 50 contracts. Accordingly, other factors and functions may be applied such that the implemented long buying power limits may currently be, for example, 30 contracts (e.g., due to the time of day, the long buying power limits may be set to 60% of their present maximum value). Further, functions may be applied such that as a repeating daily occurrence, the buying power limits are automatically reduced to zero at 2:30 PM daily, allowing the user to liquidate positions only, and the buying power limits are allowed to return to a non-zero value at 8:00 AM daily, allowing the user to resume normal trading functions.

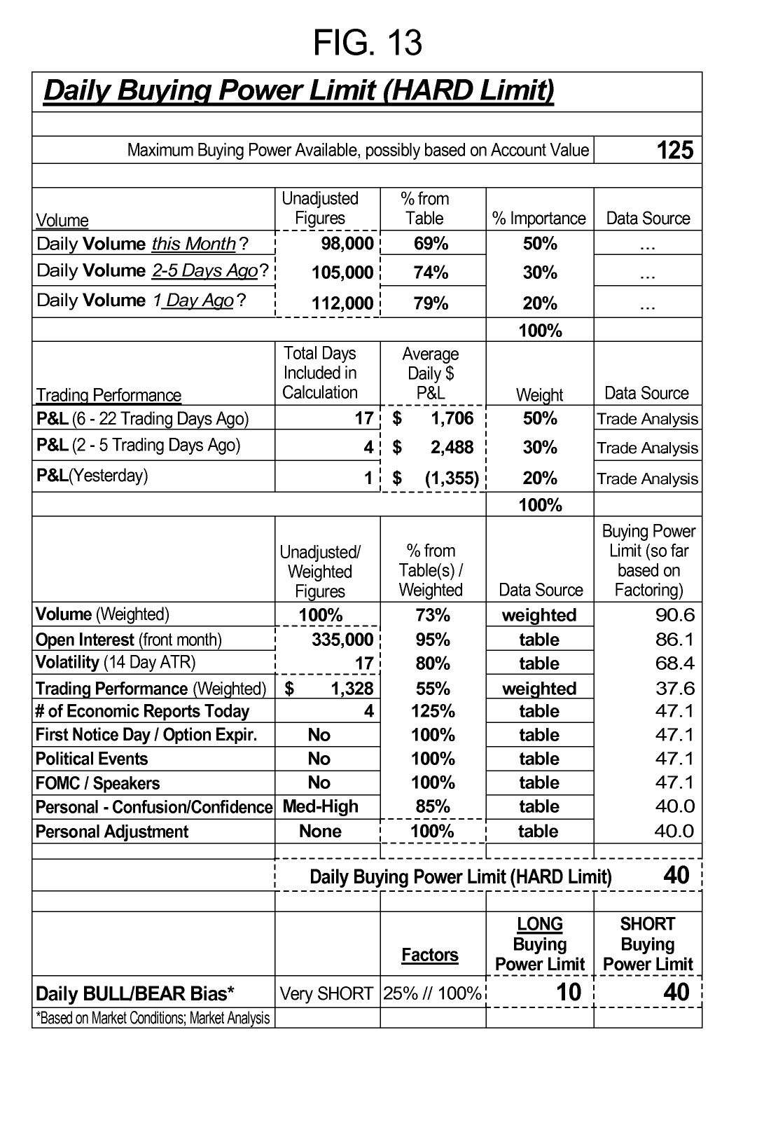

Turning now to FIG. 13 a complex group of functions is provided for calculating the value of buying power limits on the long and short sides. As shown, the buying power limits calculation includes factors based on, inter alia, the number of economic reports that day, whether that day is a First Notice Day or Option Expiration day, whether there are relevant political events that day, whether there are any relevant FOMC or speakers that day, a personal confusion/confidence indicator and a personal adjustment supplied by the user. For some of these factors, a conditional logic test may be applied (e.g., IF FOMC/Speakers=“No”, THEN % from Table(s) to use as a factor may equal “100%”. IF FOMC/Speakers=“Yes”, THEN % from Table(s) to use as a factor may equal “50%”). As further shown, market data (e.g., market volume data) and trading performance (e.g., the user's P & L) may further factor into the buying power limits calculation. As with the other examples provided herein, the calculated value may be used to automatically adjust a condition related to buying power and/or may be used to automatically execute orders based on the relationship between the buying power limits and the presently held positions. For example, the calculated buying power limits may be applied to the account and positions presently held that are outside of the applied buying power limits may be automatically liquidated.

In the example provided in FIG. 13, the buying power limits are referred to as HARD limits. It is understood that this example is merely illustrative and that it as easily could be applied to SOFT limits (may be referred to herein as buying power boundaries) or any other conditions related to buying power. Further, for illustrative purposes, it is assumed that the conditions tested in the functions provided in FIG. 13 are tested once daily such that the calculation remains static throughout the course of the day. However, it is understood that many of the conditions shown could be configured to be variable in real-time (or another interval) such that the calculated limits would be variable throughout the day as the conditions changed.

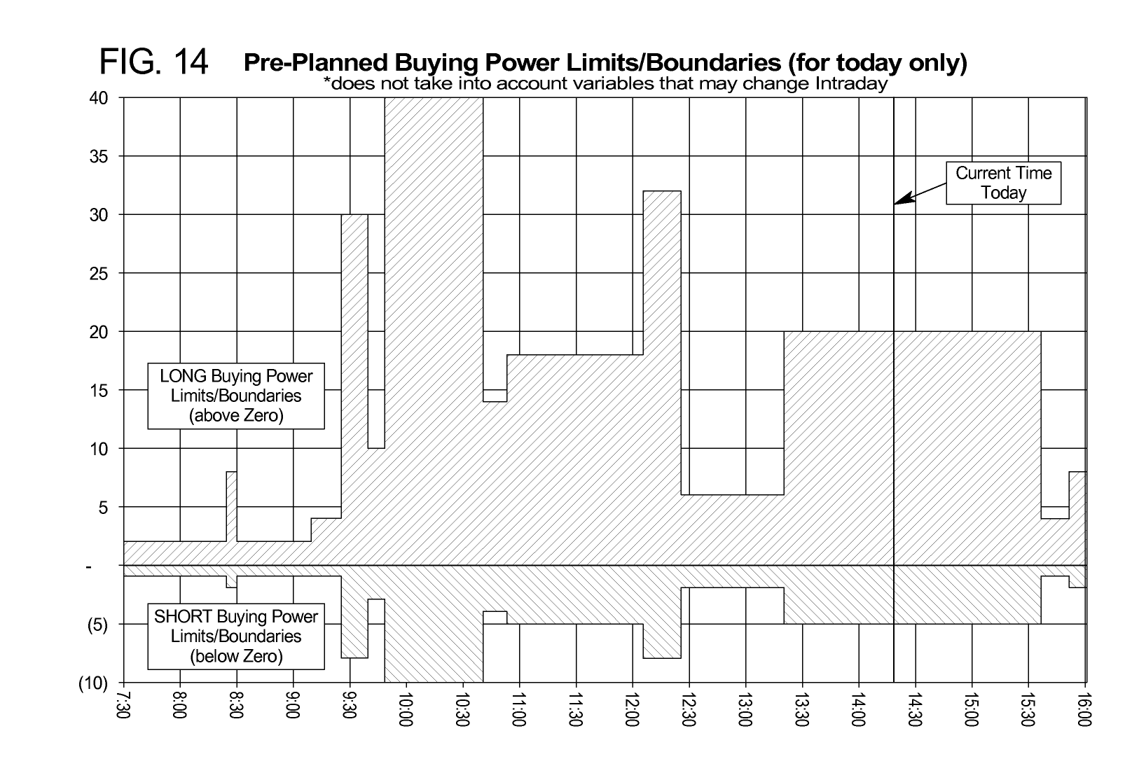

Referring now to FIG. 14, a chart is provided that displays projected buying power limits (or buying power boundaries) as they are expected to be during the time period displayed. The example shown is an intraday plot of the long side and short side buying power limits. The values shown above the zero line are the long side buying power limits and the values shown below the zero line are the short side buying power limits.

The day represented in FIG. 14, may also be the day to which the buying power limits provided in FIG. 13 are applied. Accordingly, it can be seen that in FIG. 14, the maximum long side value of the buying power limits is 40 contracts (the value calculated in FIG. 13) and the maximum short side value of the buying power limits is 10 contracts (again, the value calculated in FIG. 13). The plot illustrated in FIG. 14 may be created by multiplying the static daily limits provided from the function shown in FIG. 13, by intraday variable factors. A plot, such as the one shown in FIG. 14 may be generated and viewed prior to the trading day such that a user can understand how the buying power limits are expected to vary throughout the day. Accordingly, the effects of certain unpredictable intraday factors may not be shown in such a preview. For example, intraday trader performance factors, real-time market data factors, biometric device factors, and other factors are unpredictable in advance, and in real-time they may adjust buying power limits as given by the plot in FIG. 14. A plot such at the one shown in FIG. 14 may be generated and viewed after the trading day such that all applied factors are accounted for in the plot. Accordingly, the actual calculated and/or implemented values of buying power limits may be viewed by the trader to assess how performance in context of the buying power limits.

It is important to note that although often described as automatically adjusting a condition related to buying power, and more specifically in the examples, the value condition of buying power limits, the output of the risk management application 116 or other elements or functions within the system 100 may provide to the user information that may be used to make manual adjustments. For example, the information provided may be a suggested change to the value condition of the buying power limits, in which case, the suggested value provided to the user is a condition related to buying power.

It is envisioned that in certain embodiments of the system 100 described herein, the system 100 may be implemented to provide conditions related to buying power to be adjusted and that the user may then manually choose whether or not to implement the adjustments. It is further understood that in other embodiments the decision whether to automatically implement the adjustments may be toggled on and off.

In one example of the systems 100 provided herein, functions created using a model building application 146 or a conditional logic building application 150 may be used independently of the remaining portions of the systems 100 described herein. In addition, the function building mechanisms (e.g., the model building application 146 and the conditional logic building application 150) may be provided as stand-alone systems rather than incorporated into an order entry system 100.

Although typically described herein with reference to automatic adjustment of one or more conditions related to buying power, it is understood that many of the features and functions of the system 100 described herein may be applied manually. For example, it is contemplated that in certain versions of the system 100 it may be advantageous for a user to manually input separate short side and long side buying power limits. In one example, the user manually adjusts the Long Buying Power to be $100,000, while manually adjusting the Short Buying Power to be $25,000. In another example, where Buying Power is expressed as Buying Power Boundaries, the user manually adjusts the Long Buying Power Boundaries to be $0, while manually adjusting the Short Buying Power Boundaries to be $50,000. In another example where Buying Power is expressed as Position Limits, the user manually adjusts the Short Position Limits to be 50 contracts and the Long Position Limits to be 100 contracts. Further, it is understood that versions of the system 100 may include only the manual adjustment of one or more conditions related to buying power (such as the manual adjustment of independent long and short buying power limits), other versions of the system 100 may include only the automatic adjustment of one or more conditions related to buying power (such as the automatic adjustment of independent long and short buying power limits), and still other versions of the system 100 may include both manual and automatic adjustment of one or more conditions related to buying power.

It may be advantageous to manually input either the buying power limits or buying power boundaries, and automatically adjust the other (buying power limits or buying power boundaries). In some examples, the system 100 may automatically control the value of the HARD buying power limits, while concurrently the user manually controls a separate set of SOFT buying power limits. Or in other examples, the system 100 may automatically control the value of the SOFT buying power limits, while concurrently the user manually controls a separate set of HARD buying power limits. This may be appropriate in a scenario where a brokerage informs the user they are being permitted to have position limits for the next month of 10 contracts, barring any disasters. As such, the user may manually enter figures the value of 10 for the HARD buying power limits, and then allows for the system 100 to automatically adjust the SOFT buying power boundaries within the HARD limits.

It is contemplated that embodiments of the system 100 described herein may provide independent buying power limits and conditions related to buying power limits for operations related to presently held positions compared to operations to open new positions. It may be beneficial to maintain larger buying power limits related to open positions, but more narrowly restrictive buying power limits with respect to operations related to opening new positions. For example, in an embodiment of the system 100 in which open positions are automatically liquidated in response to a contraction in buying power limits, the automatic liquidation may be based on a first set of buying power limits that are larger (i.e., less restrictive) than a second set of buying power limits that apply to opening new positions.

Further, although the examples provided herein typically refer to participation of a brokerage, some embodiments of the order entry system may not include a brokerage and the buying power limitations may be provided by the user, the user interface, the exchange or elsewhere. Such a scenario could reflect an environment in which a trader or firm sends orders directly to an exchange. In such a system, the trader or firm may still have a relationship with a brokerage, and as part of this relationship it may be agreed upon that the trader or firm will not exceed certain position limits or other buying power limits as agreed upon together or as assigned by the brokerage. However, in this scenario the brokerage does not stand in between the trader or firm and the exchange when it comes to order routing. Such a scenario is typical where speed and stability are crucial. In this type of situation where a trader or firm sends orders directly to an exchange, or in other contemplated scenarios where a trader or firm sends orders that may go elsewhere before reaching an exchange but without the brokerage as part of the order routing process, buying power limits may still be implemented. This can happen in various ways. However, the most obvious way is an example in which the trader or firm has position limits or buying power limits entered or saved or in memory on the computer. However, other methods are also possible and are included as possible scenarios of part of the discussed invention. In all such scenarios which don't include a brokerage in the order routing process, we may still have a buying power limited order entry system. Further, it should be noted that even though in the discussed example, a relationship and an arrangement may exist between the trader or firm and brokerage, there are other scenarios which may exist in which the trader or firm has no relationship at all with a brokerage, or a relationship outside of the current context, but yet the trader or firm is still using a buying power limited order entry system.

As shown, in use, the system 100 and method 200 and 300 described herein may be used to provide risk managed order entry. As described above, aspects of the system 100 are controlled by one or more controllers 102. As further described above, the one or more controllers 102 may run a variety of application programs, may access and store data, including accessing and storing data in associated databases 106, and may enable one or more interactions via the one or more user interfaces 104. Typically, the one or more controllers 102 are implemented by one or more programmable data processing devices. The hardware elements operating systems and programming languages of such devices are conventional in nature, and it is presumed that those skilled in the art are adequately familiar therewith.

For example, the one or more controllers 102 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories may include a main memory, such as a dynamic random access memory (DRAM) and cache, as well as a read only memory, such as a PROM, an EPROM, a FLASH-EPROM, or the like. The system may also include mass storage devices such as various disk drives, tape drives, etc. In operation, the main memory may store at least portions of instructions for execution by the CPU and data for processing in accord with the executed instructions.

The one or more controllers 102 may also include one or more input/output interfaces for communications with one or more processing systems. Although not shown, one or more such interfaces may enable communications via a network, e.g., to enable sending and receiving instructions electronically. The physical communication links may be wired or wireless.

The one or more controllers 102 may further include appropriate input/output ports for interconnection with one or more output displays (e.g., monitors, printers, etc.) and one or more input mechanisms (e.g., keyboard, mouse, voice, touch, bioelectric devices, magnetic reader, RFID reader, barcode reader, etc.) serving as one or more user interfaces 104 for the controller 102. For example, the one or more controllers 102 may include a graphics subsystem to drive the output display. The links of the peripherals to the system may be wired connections or use wireless communications.

Although summarized above as a PC-type implementation, those skilled in the art will recognize that the one or more controllers 102 also encompasses systems such as host computers, servers, workstations, network terminals, and the like. In fact, the use of the term controller 102 is intended to represent a broad category of components that are well known in the art.

Hence aspects of the system 100 and the methods 200 and 300 discussed herein encompass hardware and software for controlling the relevant functions. Software may take the form of code or executable instructions for causing a controller 102 or other programmable equipment to perform the relevant steps, where the code or instructions are carried by or otherwise embodied in a medium readable by the controller 102 or other machine. Instructions or code for implementing such operations may be in the form of computer instruction in any form (e.g., source code, object code, interpreted code, etc.) stored in or carried by any readable medium.

As used herein, terms such as computer or machine “readable medium” refer to any medium that participates in providing instructions to a processor for execution. Such a medium may take many forms, including but not limited to, tangible storage media. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. An order entry system for tradable instruments comprising:
a buying power limit constrained order entry mechanism including a user interface through which a user may place orders using an input mechanism, wherein the orders placed by the user may be constrained by a buying power limit, wherein the buying power limit is adapted to automatically adjust from a first non-zero value of the buying power limit to a second non-zero value of the buying power limit based on one or more factors, wherein the one or more factors include at least one factor other than a value of the buying power limit and an amount of the buying power limit being used.

2. (canceled)

3. The system of claim 1 wherein the buying power limit includes separate long side and short side values.

4.-6. (canceled)

7. The system of claim 1 wherein the one or more factors include a factor related to day and time.

8. The system of claim 1 wherein the one or more factors include a factor related to market data.

9. The system of claim 1 wherein the one or more factors include a factor related to user performance.

10. The system of claim 1 wherein the one or more factors include a manually applied user input.

11.-12. (canceled)

13. The system of claim 1 further including a risk management application adapted to provide functionality to implement conditions for the automatic adjustment of the buying power limit.

14. The system of claim 1 wherein the order entry mechanism further includes one or more conditions related to the buying power limit, wherein the one or more conditions related to the buying power limit are adapted to be manually adjusted.

15.-20. (canceled)

21. The system of claim 1 wherein the automatic adjustment of the buying power limit from the first non-zero value of the buying power limit to the second non-zero value of the buying power limit may be manually overridden.

22. A non-transitory computer readable medium including computer-executable instructions for controlling risk in an order entry system for tradable instruments, the computer-executable instructions causing the system to perform the steps of:
providing a first non-zero value of a buying power limit that may constrain orders that are placed through the order entry system; and
automatically adjusting the first non-zero value of the buying power limit to a second non-zero value of the buying power limit that may constrain orders that are placed through the order entry system based on one or more factors, wherein the one or more factors include at least one factor other than a value of the buying power limit and an amount of the buying power limit being used.

23. The computer readable medium of claim 22 wherein the buying power limit includes separate long side and short side values.

24. The computer readable medium of claim 22 wherein the computer-executable instructions further cause the system to perform the step of automatically implementing the second non-zero value of the buying power limit.

25. The computer readable medium of claim 22 wherein the computer-executable instructions further cause the system to perform the step of requiring a manual input to implement the second non-zero value of the buying power limit.

26. The computer readable medium of claim 22 wherein the one or more factors include a factor related to day and time.

27. The computer readable medium of claim 22 wherein the one or more factors include a factor related to market data.

28. The computer readable medium of claim 22 wherein the one or more factors include a factor related to user performance.

29. The computer readable medium of claim 22 wherein the one or more factors include a manually applied user input.

30. The computer readable medium of claim 22 wherein the computer-executable instructions further cause the system to perform the step of providing a risk management application adapted to provide functionality to implement conditions for the automatic adjustment of the buying power limit.

31. The computer readable medium of claim 22 wherein the computer-executable instructions further cause the system to perform the step of providing one or more conditions related to the buying power limit, wherein the one or more conditions related to the buying power limit are adapted to be manually adjusted.

32. The computer readable medium of claim 22 wherein the order entry system is user-directed.
